(19) United States
(12) Patent Application Publication
(10) Pub. No.: US 2024/0048248 A1
(43) Pub. Date: Feb. 8, 2024

(54) APPARATUS AND METHODS TO FACILITATE SECURE SIGNAL TRANSMISSION

(71) Applicant: The United States of America, as represented by the Secretary of the Navy, Crane, IN (US)

(72) Inventor: Matthew M. Sheehan, Washington, DC (US)

(73) Assignee: The United States of America, as represented by the Secretary of the Navy, Arlington, VA (US)

(21) Appl. No.: 18/216,457

(22) Filed: Jun. 29, 2023

Related U.S. Application Data
(60) Provisional application No. 63/357,228, filed on Jun. 30, 2022.

(51) Int. Cl. H04B 10/85; H04B 10/112; H04B 10/50

(52) U.S. Cl. CPC H04B 10/85; H04B 10/112; H04B 10/501

(57) ABSTRACT

Provided are apparatus and methods for transmission of a signal in a safe and secure fashion. Embodiments include apparatus and methods that surround a signal beam(s) of interest with outer beams/signals to protect the inner signal. The outer beams construct a conduit like tunnel through which the signal beam(s) travels inside of for transmission to a receiving device. These outer beams further offer safety and security to the signal beam(s) of interest by cutting the signal source if these outer beams are broken. The outer beams can also modify the atmosphere around the signal beam(s) to an ideal, predetermined atmosphere to maximize signal propagation and minimize signal noise and loss.

### CROSS-REFERENCE TO RELATED APPLICATIONS

This application claims the benefit of and priority to U.S. Provisional Application Ser. No. 63/357,228 filed on Jun. 30, 2022, the disclosure of which is expressly incorporated herein by reference.

### STATEMENT REGARDING FEDERALLY SPONSORED RESEARCH OR DEVELOPMENT

The invention described herein was made in the performance of official duties by employees of the Department of the Navy and may be manufactured, used and licensed by or for the United States Government for any governmental purpose without payment of any royalties thereon. This invention (Navy Case 2110971.7502) is assigned to the United States Government and is available for licensing for commercial purposes. Licensing and technical inquiries may be directed to the Technology Transfer Office, Naval Surface Warfare Center Port Hueneme Division, email: Alan.w.jaeger@navy.mil or phone (805) 205-0638.

### FIELD

The field of invention relates generally to the field of communications security, communications assurance, communications safety, communication system self-protection, network security, energy transmission security, energy transmission assurance, energy transmission safety, and energy transmission system self-protection. More specifically, it pertains to information and energy transmission where the beam, link, or signal being transmitted has the need to be: protected from malicious forms of cyber, electromagnetic, network, and physical attack techniques; received with high-confidence of minimal-to-zero external influence or interference; and/or aware of external influence or interference resulting in proactive action to ensure the protection of the transmission system and safety of the external object.

Wired and wireless beams, links, and signals transmitted within or across the following domains are of relevance: far-space, near-space, exo-atmospheric, endo-atmospheric, terrestrial-ground, terrestrial-sea surface, subterranean, sub-sea surface, and seabed. Within the optical spectrum (300 GHz-300 EHz) for lasers, the following bands are of relevance: Far Infrared (FIR), Mid Infrared (MIR), Near Infrared (NIR), Visible, Near Ultraviolet (NUV), Extreme Ultraviolet (EUV), Soft X-rays (SX), Hard X-rays (HX), and Gamma rays (γ). Within the radio spectrum (0 Hz-300 GHz) for masers, the following bands are of relevance: Ultra High Frequency (UHF), Super High Frequency (SHF), and Extremely High Frequency (EHF).

### BACKGROUND

Presently known methods of transmitting data over the air or within a conduit typically employ single or multiple links or beams. These links or beams, referred to as signal(s)-of-interest, have historically functioned as the main carrier signal for the data, environmental indicators for signal degradation, and redundant signal transmission options; like that of low voltage differential signaling and radio frequency failsafe redundant links paired with optical frequency links.

For signals-of-interest taking advantage of coherence (i.e., a property of electromagnetic waves dependent of their frequency and waveform in physics) for transmission, the beam/link is often left accessible to the external environment. Whether the beam/link is in outside air making use of free space transmission and/or optics, wireless radio frequency, or is within an internal conduit, like that of a fiber optic cable which can be bent to access the signal, methods to detect, isolate, and respond to such accesses are limited, especially in cases such as “man-in-the-middle,” denial-of-service, spoofing, and injection attacks.

For signals-of-interest transmitting vast amounts of energy, like that of wireless power transfer via directed energy, few transmission systems employ safety mechanisms to ensure the hazardous beam/link/signal is operating as intended across its entire transmission path. Safety mechanisms typically only exist in limited numbers along the transmission path and only flag a system error if the system itself is in danger of damage, not the external object interacting with the system causing the damage. An example is high voltage transmission lines where the system typically only has a few circuit breakers along the line path and only seeks to reactively protect the power grid from harm, not proactively protect the system by changing the system's operating state or the object which tripped the system's error flag.

### SUMMARY

The present invention relates to an apparatus and methods for signals-of-interest (such as data and power) to be transmitted via free space optics and wireless radio frequencies or within a conduit in a safe and secure fashion. Embodiments include a device capable of numerous configurations that surrounds the signal(s)-of-interest with outer signal(s)-of-protection of varying wavelengths. These outer signal(s)-of-protection construct a conduit tunnel through which the signal(s)-of-interest travels inside of for transmission to a receiving device. These outer signal(s)-of-protection offer safety and security to the signal(s)-of-interest by cutting the signal source if these outer signal(s)-of-protection are broken. The outer signal(s)-of-protection can also modify the atmosphere around the signal(s)-of-interest to an ideal, predetermined atmosphere to maximize signal propagation and minimize signal noise and loss. The inner signal(s)-of-interest has additional characteristics to facilitate robust secure transmission such as low voltage differential signaling and the ability to vary beam wavelength, polarization, spot shape, intensity, and the like. Additionally these characteristics can be applied to secure transmission of signals within tethered communication channels or other physical transmission media.

According to further aspects, the present disclosure provides an apparatus for network security for transmitted signals. The apparatus includes at least a first transmitter configured to transmit at least one first signal containing information or a signal of interest to be transmitted and at least one second signal that at least partially surrounds the first signal and is configured to protect the at least one first signal.

In yet further aspects, the present disclosure provides an apparatus for network security and power transfer for transmitted signals. The apparatus includes at least a first transmit/receive node configured to transmit at least one portion of a first signal containing first information or power in coordination with one or more other first signal transmitters also transmitting respective portions of the first signal containing the first information or power information, and at least one portion of a second signal configured to surround the at least one portion of the first signal and protect the at least one portion of the first signal. Additionally, the apparatus includes at least a second transmit/receive node configured to receive the at least one portion of a first signal and the at least one portion of the second signal.

According to still further aspects, the present disclosure provides a method including transmitting at least a first signal of interest from a first node to a second node. Additionally, the method includes transmitting at least a second protection signal concurrent with the first signal and configured to at least partially surround the first signal of interest in space for protecting the at least one first signal of interest. In still yet further aspects, the method includes detecting when the second protection signal is interfered with or obstructed, and then ceasing or modifying transmission of the first signal of interest when the second protection signal is interfered with or obstructed.

Additional features and advantages of the present invention will become apparent to those skilled in the art upon consideration of the following detailed description of the illustrative embodiments exemplifying the best mode of carrying out the invention as presently perceived.

### BRIEF DESCRIPTION OF THE DRAWINGS

The detailed description particularly refers to the accompanying figures in which:

FIG. 1 illustrates an example of a system layout for an apparatus transmitting a unidirectional signal -of-interest within a unidirectional shielding signal(s)-of-protection according to certain aspects of the present disclosure.

FIG. 2 illustrates an example of a system layout for an apparatus transmitting a unidirectional signal-of-interest within two opposite unidirectional shielding signal(s)-of-protection according to certain aspects of the present disclosure.

FIG. 3 illustrates an example of a system layout for an apparatus transmitting a bidirectional signal-of-interest within the unidirectional shielding signal(s)-of-protection according to certain aspects of the present disclosure.

FIG. 4 illustrates an example of a system layout for an apparatus transmitting a bidirectional signal-of-interest within two opposite unidirectional shielding signal(s)-of-protection according to certain aspects of the present disclosure.

FIG. 5 illustrates a system diagram of major functions of an apparatus including critical subsystems according to certain aspects of the present disclosure.

FIG. 6 illustrates, at a high level, the three different configurations of the apparatus (transmit-only, receive-only, and transmit-receive) and each of their interfaces with external system inputs and outputs; like that of signal/power-of-interest sources and destination connections and potential signal/power backup links according to certain aspects of the present disclosure.

FIG. 7 illustrates, at a lower level, the functional block diagram of a transmitting node configuration showing the internal data/information/control flows and various functional subsystem interactions when operating according to certain aspects of the present disclosure.

FIG. 8 illustrates, at a lower level, the functional block diagram of a receiving node configuration showing the internal data/information/control flows and various functional subsystem interactions when operating according to certain aspects of the present disclosure.

FIG. 9 illustrates, at a further lower level, the internal data/information/control flows and various functional subsystem interactions of a Power Source/Destination Protection and Conditioner subsystem according to certain aspects of the present disclosure.

FIG. 10 illustrates, at a further lower level, the internal data/information/control flows and various functional subsystem interactions of a Signal Source/Destination Protection and Conditioner subsystem according to certain aspects of the present disclosure.

FIG. 11 illustrates, at a further lower level, the internal data/information/control flows and various functional subsystem interactions of a Cooling and Thermal Management subsystem according to certain aspects of the present disclosure.

FIG. 12 illustrates, at a further lower level, the internal data/information/control flows and various functional subsystem interactions of a Coherent Source Power Rectifier subsystem according to certain aspects of the present disclosure.

FIG. 13 illustrates, at a further lower level, the internal data/information/control flows and various functional subsystem interactions of a Coherent Source subsystem according to certain aspects of the present disclosure.

FIG. 14 illustrates, at a further lower level, the internal data/information/control flows and various functional subsystem interactions of a Signal Encoder subsystem according to certain aspects of the present disclosure.

FIG. 15 illustrates, at a further lower level, the internal data/information/control flows and various functional subsystem interactions of a Channel Encoder subsystem according to certain aspects of the present disclosure.

FIG. 16 illustrates, at a further lower level, the internal data/information/control flows and various functional subsystem interactions of a Modulator subsystem highlighting the subsystems interaction with its: executable instruction set ROM, BIT ROM to ensure its executable instruction set is being performed correctly, updateable executable instruction set EEPROM, and the EEPROM BIT to ensure its updated executable instruction set is being performed correctly for configurations of the apparatus which contain the capability to transmit according to certain aspects of the present disclosure.

FIG. 17 illustrates, at a further lower level, the internal data/information/control flows and various functional subsystem interactions of a Transmit Protection and Conditioner subsystem according to certain aspects of the present disclosure.

FIG. 18 illustrates, at a further lower level, the internal data/information/control flows and various functional subsystem interactions of a Beam Train Director subsystem according to certain aspects of the present disclosure.

FIG. 19 illustrates, at a further lower level, the internal data/information/control flows and various functional subsystem interactions of a Housing subsystem according to certain aspects of the present disclosure.

FIG. 20 illustrates, at a further lower level, the internal data/information/control flows and various functional subsystem interactions of a Housing subsystem according to certain aspects of the present disclosure.

FIG. 21 illustrates, at a further lower level, the internal data/information/control flows and various functional subsystem interactions of a Beam Train Director subsystem according to certain aspects of the present disclosure.

FIG. 22 illustrates, at a further lower level, the internal data/information/control flows and various functional subsystem interactions of a Receiver Protection and Conditioner subsystem according to certain aspects of the present disclosure.

FIG. 23 illustrates, at a further lower level, the internal data/information/control flows and various functional subsystem interactions of a Matching and Rectifier Network subsystem according to certain aspects of the present disclosure.

FIG. 24 illustrates, at a further lower level, the internal data/information/control flows and various functional subsystem interactions of a Blocking Diode Network subsystem according to certain aspects of the present disclosure.

FIG. 25 illustrates, at a further lower level, the internal data/information/control flows and various functional subsystem interactions of a Demodulator subsystem according to certain aspects of the present disclosure.

FIG. 26 illustrates, at a further lower level, the internal data/information/control flows and various functional subsystem interactions of a Channel Decoder subsystem according to certain aspects of the present disclosure.

FIG. 27 illustrates, at a further lower level, the internal data/information/control flows and various functional subsystem interactions of a Signal Decoder subsystem according to certain aspects of the present disclosure.

FIG. 28 illustrates the flexibility of a transmit-only and receive-only configurations in terms of one-to-one, one-to-many, many-to-one, and many-to-many connections between each of a as well their ability to likewise interface with input sources, output destinations, and backup links according to certain aspects of the present disclosure.

FIG. 29 illustrates the flexibility of a transmit-receive configurations in terms of one-to-one, one-to-many, many-to-one, and many-to-many connections between each of a as well their ability to likewise interface with input sources, output destinations, and backup links according to certain aspects of the present disclosure.

FIG. 30 illustrates the flexibility of a transmit-only and receive-only configurations in terms of single aperture transmit to single aperture receive depicting a capability of handling multiple different signal steams at once according to certain aspects of the present disclosure.

FIG. 31 illustrates the flexibility of a transmit-only and receive-only configurations in terms of: single aperture transmit to multiple aperture receive, multiple aperture transmit to single aperture receive, and multiple aperture transmit to multiple aperture receive depicting a capability of handling multiple different signal steams at once according to certain aspects of the present disclosure.

FIG. 32 illustrates the flexibility of a transmit-receive configurations in terms of: single aperture transmit to single aperture receive single aperture transmit to multiple aperture receive, multiple aperture transmit to single aperture receive, and multiple aperture transmit to multiple aperture receive depicting a capability of handling multiple different signal steams at once according to certain aspects of the present disclosure.

FIG. 33 illustrates, in an orthographic-front (head-on) view, a basic layout for a transmit-only (left-side of FIG. 33) and receive-only (right-side of FIG. 33) aperture layouts to protect a unidirectional signal-of-interest within a single-layer, unidirectional homogenous single-signal, continuous shielding beam effectively creating a tunnel of protection and safety for the unidirectional signal-of-interest across an open space or within a conduit to a receiving node without communication feedback to the transmitting node according to certain aspects of the present disclosure.

FIG. 34 illustrates, in an orthographic-front (head-on) view, a basic layout for a transmit-only (left-side of FIG. 34) and receive-only (right-side of FIG. 34) aperture layouts to protect a unidirectional signal-of-interest within a multi-layer, unidirectional homogenous multi-signals, continuous shielding beam effectively creating a tunnel of protection and safety for the unidirectional signal-of-interest across an open space or within a conduit to a receiving node without communication feedback to the transmitting node according to certain aspects of the present disclosure.

FIG. 35 illustrates, in an orthographic-front (head-on) view, a basic layout for a transmit-only (left-side of FIG. 35) and receive-only (right-side of FIG. 35) aperture layouts to protect a unidirectional signal-of-interest within a single-layer, unidirectional homogenous single-signal, individual shielding beams effectively creating a tunnel of protection and safety for the unidirectional signal-of-interest across an open space or within a conduit to a receiving node without communication feedback to the transmitting node according to certain aspects of the present disclosure.

FIG. 36 illustrates, in an orthographic-front (head-on) view, a basic layout for a transmit-only (left-side of FIG. 36) and receive-only (right-side of FIG. 36) aperture layouts to protect a unidirectional signal-of-interest within a single-layer, unidirectional heterogeneous multi-signals, individual shielding beams effectively creating a tunnel of protection and safety for the unidirectional signal-of-interest across an open space or within a conduit to a receiving node without communication feedback to the transmitting node according to certain aspects of the present disclosure.

FIG. 37 illustrates, in an orthographic-front (head-on) view, a basic layout for a transmit-only (left-side of FIG. 37) and receive-only (right-side of FIG. 37) aperture layouts to protect a unidirectional signal-of-interest within a multi-layer, unidirectional homogenous multi-signals, individual shielding beams effectively creating a tunnel of protection and safety for the unidirectional signal-of-interest across an open space or within a conduit to a receiving node without communication feedback to the transmitting node according to certain aspects of the present disclosure.

FIG. 38 illustrates, in an orthographic-front (head-on) view, a basic layout for a transmit-only (left-side of FIG. 38) and receive-only (right-side of FIG. 38) aperture layouts to protect a unidirectional signal-of-interest within a multi-layer, unidirectional heterogeneous multi-signals, individual shielding beams effectively creating a tunnel of protection and safety for the unidirectional signal-of-interest across an open space or within a conduit to a receiving node without communication feedback to the transmitting node according to certain aspects of the present disclosure.

FIG. 39 illustrates, in an orthographic-front (head-on) view, a basic layout for a transmit-only (left-side of FIG. 39) and receive-only (right-side of FIG. 39) aperture layouts to protect a unidirectional signal-of-interest within a multi-layer, unidirectional homogenous multi-signals, continuous and individual shielding beams effectively creating a tunnel of protection and safety for the unidirectional signal-of-interest across an open space or within a conduit to a receiving node without communication feedback to the transmitting node according to certain aspects of the present disclosure.

FIG. 40 illustrates, in an orthographic-front (head-on) view, a basic layout for a transmit-only (left-side of FIG. 40) and receive-only (right-side of FIG. 40) aperture layouts to protect a unidirectional signal-of-interest within a multi-layer, unidirectional homogenous multi-signals, individual and continuous shielding beams effectively creating a tunnel of protection and safety for the unidirectional signal-of-interest across an open space or within a conduit to a receiving node without communication feedback to the transmitting node according to certain aspects of the present disclosure.

FIG. 41 illustrates, in an orthographic-front (head-on) view, a basic layout for a transmit-only (left-side of FIG. 41) and receive-only (right-side of FIG. 41) aperture layouts to protect a unidirectional signal-of-interest within a multi-layer, opposite unidirectional homogenous multi-signals, continuous shielding beams effectively creating a tunnel of protection and safety for the unidirectional signal-of-interest across an open space or within a conduit to a receiving node with communication feedback to the transmitting node according to certain aspects of the present disclosure.

FIG. 42 illustrates, in an orthographic-front (head-on) view, a basic layout for a transmit-only (left-side of FIG. 42) and receive-only (right-side of FIG. 42) aperture layouts to protect a unidirectional signal-of-interest within a single-layer, opposite unidirectional heterogeneous multi-signals, individual shielding beams effectively creating a tunnel of protection and safety for the unidirectional signal-of-interest across an open space or within a conduit to a receiving node with communication feedback to the transmitting node according to certain aspects of the present disclosure.

FIG. 43 illustrates, in an orthographic-front (head-on) view, a basic layout for a transmit-only (left-side of FIG. 43) and receive-only (right-side of FIG. 43) aperture layouts to protect a unidirectional signal-of-interest within a multi-layer, opposite unidirectional homogeneous multi-signals, individual shielding beams effectively creating a tunnel of protection and safety for the unidirectional signal-of-interest across an open space or within a conduit to a receiving node with communication feedback to the transmitting node according to certain aspects of the present disclosure.

FIG. 44 illustrates, in an orthographic-front (head-on) view, a basic layout for a transmit-only (left-side of FIG. 44) and receive-only (right-side of FIG. 44) aperture layouts to protect a unidirectional signal-of-interest within a multi-layer, opposite unidirectional heterogeneous multi-signals, individual shielding beams effectively creating a tunnel of protection and safety for the unidirectional signal-of-interest across an open space or within a conduit to a receiving node with communication feedback to the transmitting node according to certain aspects of the present disclosure.

FIG. 45 illustrates, in an orthographic-front (head-on) view, a basic layout for a transmit-only (left-side of FIG. 45) and receive-only (right-side of FIG. 45) aperture layouts to protect a unidirectional signal-of-interest within a multi-layer, opposite unidirectional homogeneous multi-signals, continuous and individual shielding beams effectively creating a tunnel of protection and safety for the unidirectional signal-of-interest across an open space or within a conduit to a receiving node with communication feedback to the transmitting node according to certain aspects of the present disclosure.

FIG. 46 illustrates, in an orthographic-front (head-on) view, a basic layout for a transmit-only (left-side of FIG. 46) and receive-only (right-side of FIG. 46) aperture layouts to protect a unidirectional signal-of-interest within a multi-layer, opposite unidirectional homogeneous multi-signals, individual and continuous shielding beams effectively creating a tunnel of protection and safety for the unidirectional signal-of-interest across an open space or within a conduit to a receiving node with communication feedback to the transmitting node according to certain aspects of the present disclosure.

FIG. 47 illustrates, in an orthographic-front (head-on) view, a basic layout for a transmit-only (left-side of FIG. 47) and receive-only (right-side of FIG. 47) aperture layouts to protect a bidirectional signal-of-interest within a single-layer, unidirectional homogeneous single-signal, continuous shielding beam effectively creating a tunnel of protection and safety for the bidirectional signal-of-interest across an open space or within a conduit to a receiving node without communication feedback to the transmitting node according to certain aspects of the present disclosure.

FIG. 48 illustrates, in an orthographic-front (head-on) view, a basic layout for a transmit-only (left-side of FIG. 48) and receive-only (right-side of FIG. 48) aperture layouts to protect a bidirectional signal-of-interest within a multi-layer, unidirectional homogeneous multi-signal, continuous shielding beams effectively creating a tunnel of protection and safety for the bidirectional signal-of-interest across an open space or within a conduit to a receiving node without communication feedback to the transmitting node according to certain aspects of the present disclosure.

FIG. 49 illustrates, in an orthographic-front (head-on) view, a basic layout for a transmit-only (left-side of FIG. 49) and receive-only (right-side of FIG. 49) aperture layouts to protect a bidirectional signal-of-interest within a single-layer, unidirectional homogeneous single-signal, individual shielding beams effectively creating a tunnel of protection and safety for the bidirectional signal-of-interest across an open space or within a conduit to a receiving node without communication feedback to the transmitting node according to certain aspects of the present disclosure.

FIG. 50 illustrates, in an orthographic-front (head-on) view, a basic layout for a transmit-only (left-side of FIG. 50) and receive-only (right-side of FIG. 50) aperture layouts to protect a bidirectional signal-of-interest within a single-layer, unidirectional heterogeneous multi-signal, individual shielding beams effectively creating a tunnel of protection and safety for the bidirectional signal-of-interest across an open space or within a conduit to a receiving node without communication feedback to the transmitting node according to certain aspects of the present disclosure.

FIG. 51 illustrates, in an orthographic-front (head-on) view, a basic layout for a transmit-only (left-side of FIG. 51) and receive-only (right-side of FIG. 51) aperture layouts to protect a bidirectional signal-of-interest within a multi-layer, unidirectional homogeneous multi-signal, individual shielding beams effectively creating a tunnel of protection and safety for the bidirectional signal-of-interest across an open space or within a conduit to a receiving node without communication feedback to the transmitting node according to certain aspects of the present disclosure.

FIG. 52 illustrates, in an orthographic-front (head-on) view, a basic layout for a transmit-only (left-side of FIG. 52) and receive-only (right-side of FIG. 52) aperture layouts to protect a bidirectional signal-of-interest within a multi-layer, unidirectional heterogeneous multi-signal, individual shielding beams effectively creating a tunnel of protection and safety for the bidirectional signal-of-interest across an open space or within a conduit to a receiving node without communication feedback to the transmitting node according to certain aspects of the present disclosure.

FIG. 53 illustrates, in an orthographic-front (head-on) view, a basic layout for a transmit-only (left-side of FIG. 53) and receive-only (right-side of FIG. 53) aperture layouts to protect a bidirectional signal-of-interest within a multi-layer, unidirectional homogeneous multi-signal, continuous and individual shielding beams effectively creating a tunnel of protection and safety for the bidirectional signal-of-interest across an open space or within a conduit to a receiving node without communication feedback to the transmitting node according to certain aspects of the present disclosure.

FIG. 54 illustrates, in an orthographic-front (head-on) view, a basic layout for a transmit-only (left-side of FIG. 54) and receive-only (right-side of FIG. 54) aperture layouts to protect a bidirectional signal-of-interest within a multi-layer, unidirectional homogeneous multi-signal, individual and continuous shielding beams effectively creating a tunnel of protection and safety for the bidirectional signal-of-interest across an open space or within a conduit to a receiving node without communication feedback to the transmitting node according to certain aspects of the present disclosure.

FIG. 55 illustrates, in an orthographic-front (head-on) view, a basic layout for a transmit-only (left-side of FIG. 55) and receive-only (right-side of FIG. 55) aperture layouts to protect a bidirectional signal-of-interest within a multi-layer, opposite unidirectional homogeneous multi-signal, continuous shielding beams effectively creating a tunnel of protection and safety for the bidirectional signal-of-interest across an open space or within a conduit to a receiving node with communication feedback to the transmitting node according to certain aspects of the present disclosure.

FIG. 56 illustrates, in an orthographic-front (head-on) view, a basic layout for a transmit-only (left-side of FIG. 56) and receive-only (right-side of FIG. 56) aperture layouts to protect a bidirectional signal-of-interest within a single-layer, opposite unidirectional heterogeneous multi-signal, individual shielding beams effectively creating a tunnel of protection and safety for the bidirectional signal-of-interest across an open space or within a conduit to a receiving node with communication feedback to the transmitting node according to certain aspects of the present disclosure.

FIG. 57 illustrates, in an orthographic-front (head-on) view, a basic layout for a transmit-only (left-side of FIG. 57) and receive-only (right-side of FIG. 57) aperture layouts to protect a bidirectional signal-of-interest within a multi-layer, opposite unidirectional homogeneous multi-signal, individual shielding beams effectively creating a tunnel of protection and safety for the bidirectional signal-of-interest across an open space or within a conduit to a receiving node with communication feedback to the transmitting node according to certain aspects of the present disclosure.

FIG. 58 illustrates, in an orthographic-front (head-on) view, a basic layout for a transmit-only (left-side of FIG. 58) and receive-only (right-side of FIG. 58) aperture layouts to protect a bidirectional signal-of-interest within a multi-layer, opposite unidirectional heterogeneous multi-signal, individual shielding beams effectively creating a tunnel of protection and safety for the bidirectional signal-of-interest across an open space or within a conduit to a receiving node with communication feedback to the transmitting node according to certain aspects of the present disclosure.

FIG. 59 illustrates, in an orthographic-front (head-on) view, a basic layout for a transmit-only (left-side of FIG. 59) and receive-only (right-side of FIG. 59) aperture layouts to protect a bidirectional signal-of-interest within a multi-layer, opposite unidirectional homogeneous multi-signal, continuous and individual shielding beams effectively creating a tunnel of protection and safety for the bidirectional signal-of-interest across an open space or within a conduit to a receiving node with communication feedback to the transmitting node according to certain aspects of the present disclosure.

FIG. 60 illustrates, in an orthographic-front (head-on) view, a basic layout for a transmit-only (left-side of FIG. 60) and receive-only (right-side of FIG. 60) aperture layouts to protect a bidirectional signal-of-interest within a multi-layer, opposite unidirectional homogeneous multi-signal, individual and continuous shielding beams effectively creating a tunnel of protection and safety for the bidirectional signal-of-interest across an open space or within a conduit to a receiving node with communication feedback to the transmitting node according to certain aspects of the present disclosure.

FIG. 61 illustrates multiple views of how the signal being transmitted may be interpreted by the receiver to check for known or expected security features of the beam to include aperture intensity profiles, signal polarization, signal beam shape, etc., according to certain aspects of the present disclosure.

FIG. 62 illustrates how the apparatus is able to directionally steer its signal beam by making use of gravitational bodies according to certain aspects of the present disclosure.

FIG. 63 illustrates how the apparatus is able to directionally steer its signal beam by making use of environmental surroundings and transmission medium properties and characteristics according to certain aspects of the present disclosure.

FIG. 64 illustrates how the apparatus is able to directionally steer its signal beam by actively modifying its environmental surroundings and transmission medium according to certain aspects of the present disclosure.

FIG. 65 illustrates, at a high-level, a differing states of operation (Safe, Developer, Operational, and Maintenance) and transition paths between them. according to certain aspects of the present disclosure

FIG. 66 illustrates, at a lower-level, the differing states of operation within the Operational system state and the transition paths between them according to certain aspects of the present disclosure.

FIG. 67 illustrates, at a lower-level, the differing states of operation within the Safe system state and the transition paths between them according to certain aspects of the present disclosure.

FIG. 68 illustrates, at a lower-level, the differing states of operation within the Maintenance system state and the transition paths between them according to certain aspects of the present disclosure.

FIG. 69 illustrates, at a lower-level, the differing states of operation within the Developer system state and the transition paths between them according to certain aspects of the present disclosure.

FIG. 70 illustrates a mode of operation if the outer shielding signals are obstructed for a unidirectional signal-of-interest and unidirectional outer shielding signals.

FIG. 71 illustrates a mode of operation if the outer shielding signals are obstructed for a unidirectional signal-of-interest and two opposite unidirectional outer shielding signals according to certain aspects of the present disclosure.

FIG. 72 illustrates a mode of operation if the outer shielding signals are obstructed for a bidirectional signal-of-interest and unidirectional outer shielding signals according to certain aspects of the present disclosure.

FIG. 73 illustrates a mode of operation if the outer shielding signals are obstructed for a bidirectional signal-of-interest and two opposite unidirectional outer shielding signals according to certain aspects of the present disclosure.

FIG. 74 illustrates, at a generic subsystem level, the fault-detection and fault-isolation (FDFI) configurations of the apparatus has implemented within critical subsystems to ensure proper system operation to include changes to the FDFI logic control as needed according to certain aspects of the present disclosure.

FIG. 75 illustrates examples of possible employments of the apparatus by domain (far-space, near-space, exo-atmospheric, endo-atmospheric, terrestrial-ground, terrestrial-sea surface, subterranean, sub-sea surface, and seabed) and the connections between each domain if a wireless connection medium is deployed according to certain aspects of the present disclosure.

FIG. 76 illustrates examples of possible employments of the apparatus by domain (far-space, near-space, exo-atmospheric, endo-atmospheric, terrestrial-ground, terrestrial-sea surface, subterranean, sub-sea surface, and seabed) and the connections between each domain if a wired connection medium is deployed according to certain aspects of the present disclosure.

FIG. 77 illustrates examples of possible end-item systems within the far-space domain the apparatus may be installed upon or integrated into according to certain aspects of the present disclosure.

FIG. 78 illustrates examples of possible end-item systems within the near-space domain the apparatus may be installed upon or integrated into according to certain aspects of the present disclosure.

FIG. 79 illustrates examples of possible end-item systems within the exo-atmospheric domain the apparatus may be installed upon or integrated into according to certain aspects of the present disclosure.

FIG. 80 illustrates examples of possible end-item systems within the endo-atmospheric domain the apparatus may be installed upon or integrated into according to certain aspects of the present disclosure.

FIG. 81 illustrates examples of possible end-item systems within the terrestrial-ground domain the apparatus may be installed upon or integrated into according to certain aspects of the present disclosure.

FIG. 82 illustrates examples of possible end-item systems within the terrestrial-sea surface domain the apparatus may be installed upon or integrated into according to certain aspects of the present disclosure.

FIG. 83 illustrates examples of possible end-item systems within the subterranean domain the apparatus may be installed upon or integrated into according to certain aspects of the present disclosure.

FIG. 84 illustrates examples of possible end-item systems within the sub-sea surface domain the apparatus may be installed upon or integrated into according to certain aspects of the present disclosure.

FIG. 85 illustrates examples of possible end-item systems within the seabed domain the apparatus may be installed upon or integrated into according to certain aspects of the present disclosure.

FIG. 86 illustrates an exemplary method for network security for transmitted signals according to certain aspects of the present disclosure.

### DETAILED DESCRIPTION

The embodiments of the present invention described herein are not intended to be exhaustive or to limit the invention to precise forms disclosed. Rather, the embodiments selected for description have been chosen to enable one skilled in the art to practice the invention.

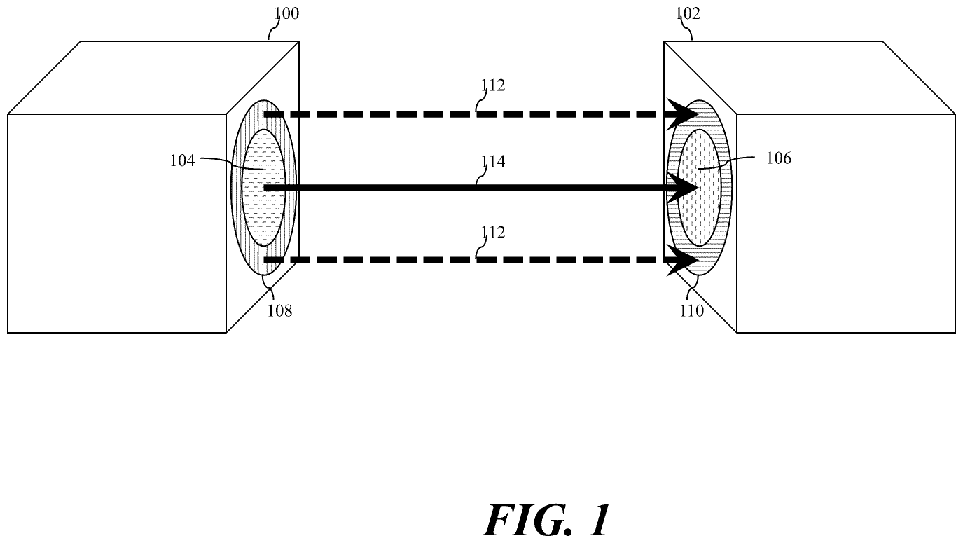

FIG. 1 depicts a system layout for an apparatus for a unidirectional signal-of-interest to be transmitted across an open space or enclosed within a conduit according to an example. This system configuration effectively creates a tunnel of protection and safety for the unidirectional signal-of-interest across an open space or within a conduit to a receiving node without communication feedback to the transmitting node. In particular, the system of FIG. 1 includes a signal-of-interest source transmitter (TX) node 100, a signal-of-interest destination receiver (RX) node 102, a signal-of-interest transmitter node aperture 104, a signal-of-interest receiver node aperture 106, a surrounding outer transmitted protection signal transmitter node aperture 108, and a surrounding outer received protection signal receiver node aperture 110. A signal-of-interest 114 is transmitted from the signal-of-interest aperture 104 of the TX node 100 and is received by the signal-of-interest aperture 106 of the RX node 102 while being surrounded by the outer protection signal 112 as transmitted from the surrounding outer transmitted protection signal transmitter node aperture 108 of the TX node 100 and is received by the surrounding outer received protection signal receiver node aperture 110 of RX node 102. In aspects, the outer protection signal 112 may surround the unidirectional signal-of-interest 114 in whole (e.g., a tube or tunnel configuration) or in part (e.g., less than a tube or tunnel or multiple distinct beams/signals surrounding the unidirectional signal-of-interest 114 either at regular intervals/angles or irregular intervals/angles). As will be explained in more detail herein, the TX and/or RX nodes may monitor the outer protection signal 112 for interruptions, interferences, blockages, obstructions, misalignments, occlusions, and/or impingements thereupon (collectively referred to herein as “interrupted, “interrupts”, “interruptions”, “obstructions” or “obstructed”). When an interruption of the outer protection signal 112 is detected, the apparatus may suspend or cease transmission of

It is noted that in certain aspects, for the various embodiments described herein the transmitter node (e.g., transmitter node 100) may be configured to transmit coherent electromagnetic signals within either the optical spectrum or in the radio spectrum, particularly in free space transmissions. Additionally, it is noted the coherent electromagnetic signals may be transmitted with spatial coherence, which allows the signals to be focused and/or contained to a particular point or area (such as at a particular receiver location) and to be collimated with little or no divergence (i.e., the signal stays narrow over great distances). Furthermore, in some aspects, the present apparatus may also employ transmission of electromagnetic signals (optical or radio frequency) having the characteristic of temporal coherence, allowing transmission in a very narrow spectrum or with ultrashort pulses of light with a broad spectrum but very short durations (e.g., in the femtosecond range). In the case of transmission in the optical spectrum (e.g., 300 GHz-300 EHz) a transmitter may be configured using a laser device configured to transmit coherent light signals including signals in the following various spectra: Far Infrared (FIR), Mid Infrared (MIR), Near Infrared (NIR), Visible, Near Ultraviolet (NUV), Extreme Ultraviolet (EUV), Soft X-rays (SX), Hard X-rays (HX), and Gamma rays (γ). Within the radio spectrum (e.g., 0 Hz-300 GHz), transmitter may be configured using a maser configured to transmit coherent radio frequency waves in various spectra including Ultra High Frequency (UHF), Super High Frequency (SHF), and Extremely High Frequency (EHF) bands.

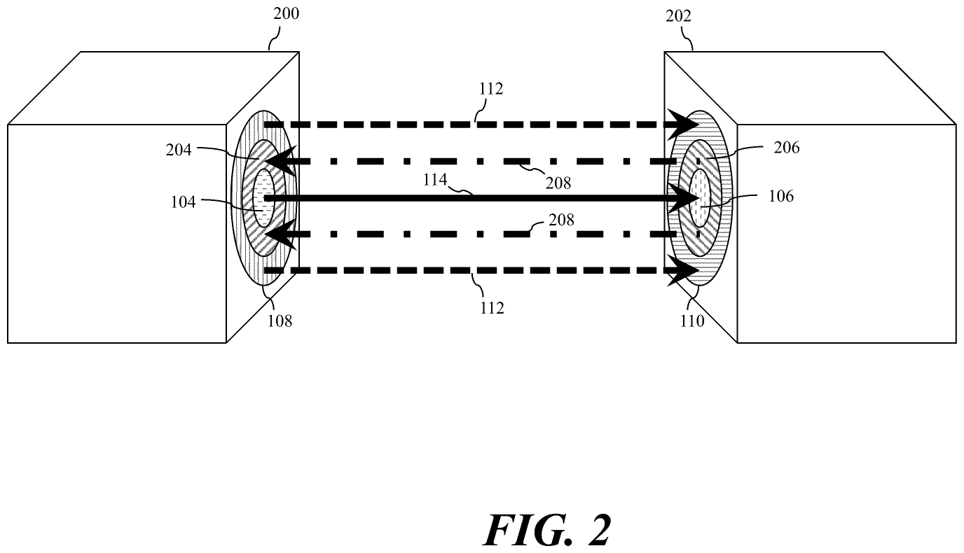

FIG. 2 depicts a system layout for an apparatus for a unidirectional signal-of-interest to be transmitted across an open space or enclosed within a conduit according to an example. This system configuration effectively creates a tunnel of protection and safety for the unidirectional signal-of-interest across an open space or within a conduit to a receiving node with communication feedback to the transmitting node The system of FIG. 2 includes a unidirectional signal-of-interest source transmitter (TX) node 200, a unidirectional signal-of-interest destination receiver (RX) node 202, a unidirectional signal-of-interest transmitter node aperture 104, a unidirectional signal-of-interest receiver node aperture 106, a surrounding unidirectional outer transmitted protection signal transmitter node aperture 108, a unidirectional surrounding outer received protection signal receiver node aperture 110, an opposing unidirectional inner-surrounding received protection signal transmitter node aperture 204, and an opposing unidirectional inner-surrounding transmitted protection signal receiver node aperture 206. The unidirectional signal-of-interest 114 is transmitted from unidirectional signal-of-interest aperture 104 of TX node 200 and is received by the unidirectional signal-of-interest aperture 106 of RX node 202 while being surrounded by the unidirectional outer protection signal 112 as transmitted from unidirectional outer protection signal aperture 108 of TX node 200 and is received by the unidirectional outer protection signal aperture 110 of RX node 202. Additionally, the unidirectional signal-of-interest 114 is further surrounded by the opposing unidirectional inner protection signal 208 as transmitted from unidirectional inner protection signal aperture 206 of RX node 202 and is received by the unidirectional inner protection signal aperture 204 of TX node 200. This encases the unidirectional signal-of-interest 114 with two opposing unidirectional protection signals 112 and 208 allowing for the TX node 200 and RX node 202 to communicate if the either opposing unidirectional signals 112 and/or 208 have been obstructed or misaligned in order to modify the transmit or receive operation of the signal-of-interest 114 through the direct control of the unidirectional signal-of-interest transmitter node 200 aperture 104 or the unidirectional signal-of-interest receiver node 202 aperture 106.

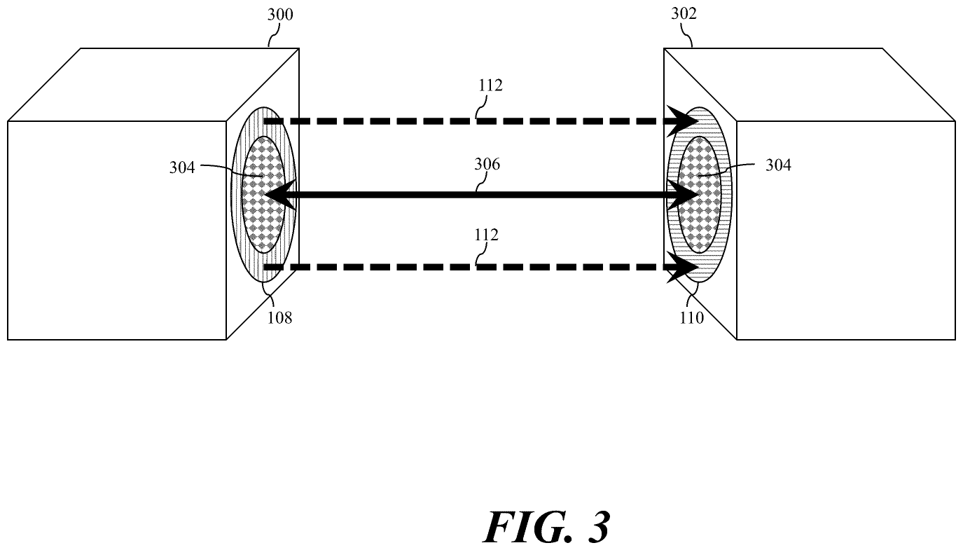

FIG. 3 depicts a system layout for an apparatus for a bidirectional signal-of-interest to be transmitted across an open space or enclosed within a conduit according to an example. Here, the system effectively creates a tunnel of protection and safety for the bidirectional signal-of-interest across an open space or within a conduit to a receiving node without communication feedback to the transmitting node. The system of FIG. 3 includes a bidirectional signal-of-interest source transmitter (TX) node 300, a bidirectional signal-of-interest destination receiver (RX) node 302, a bidirectional signal-of-interest transmitter node aperture 304, a bidirectional signal-of-interest receiver node aperture 304, a surrounding unidirectional outer transmitted protection signal transmitter node aperture 108, and a unidirectional surrounding outer received protection signal receiver node aperture 110. The bidirectional signal-of-interest 306 is transmitted from bidirectional signal-of-interest aperture 304 of TX node 300 and is received by the bidirectional signal-of-interest aperture 304 of RX node 302 while being surrounded by the unidirectional outer protection signal 112 as transmitted from unidirectional outer protection signal aperture 108 of TX node 300 and is received by the unidirectional outer protection signal aperture 110 of RX node 302.

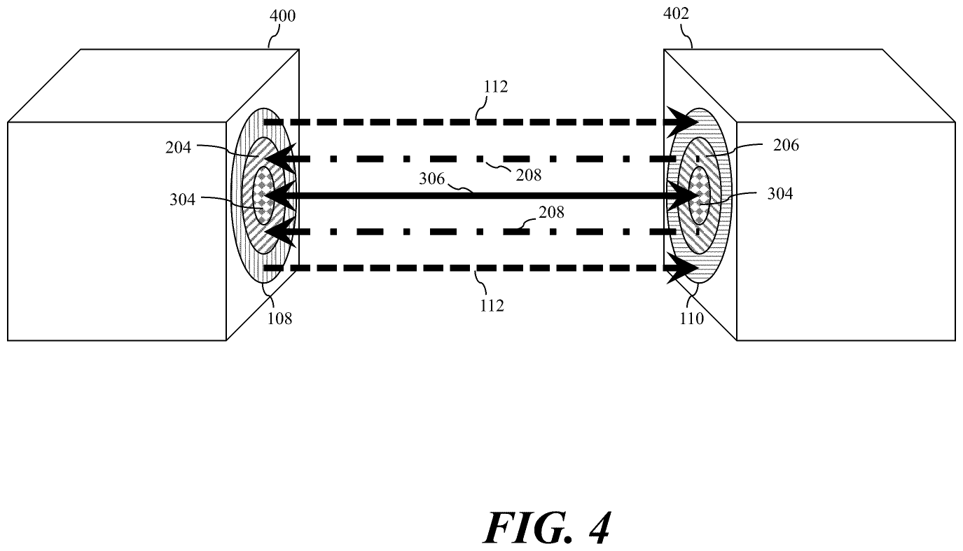

FIG. 4 depicts a system layout for a bidirectional signal-of-interest to be transmitted across an open space or enclosed within a conduit according to an example. This layout effectively creates a tunnel of protection and safety for the bidirectional signal-of-interest across an open space or within a conduit to a receiving node with communication feedback to the transmitting node. The system of FIG. 4 includes a bidirectional signal-of-interest source transmitter (TX) node 400, a bidirectional signal-of-interest destination receiver (RX) node 402, a bidirectional signal-of-interest transmitter node aperture 304, a bidirectional signal-of-interest receiver node aperture 306, a surrounding unidirectional outer transmitted protection signal transmitter node aperture 108, a unidirectional surrounding outer received protection signal receiver node aperture 110, an opposing unidirectional inner-surrounding received protection signal transmitter node aperture 204, and an opposing unidirectional inner-surrounding transmitted protection signal receiver node aperture 206. The bidirectional signal-of-interest 306 is transmitted from bidirectional signal-of-interest aperture 304 of TX node 400 and is received by the bidirectional signal-of-interest aperture 304 of RX node 402 while being surrounded by the unidirectional outer protection signal 112 as transmitted from unidirectional outer protection signal aperture 108 of TX node 400 and is received by the unidirectional outer protection signal aperture 110 of RX nodes 402. Additionally, the bidirectional signal-of-interest 306 is further surrounded by the opposing unidirectional inner protection signal 208 as transmitted from unidirectional inner protection signal aperture 206 of RX node 402 and is received by the unidirectional inner protection signal aperture 204 of TX node 400. This encases the bidirectional signal-of-interest 306 with two opposing unidirectional protection signals 112 and 208 allowing for the TX node 400 and RX node 402 to communicate if the either opposing unidirectional signals 112 and/or 208 have been obstructed or misaligned in order to modify the transmit or receive operation of the signal-of-interest 306 through the direct control of the bidirectional signal-of-interest transmitter node 400 aperture 304 or the bidirectional signal-of-interest receiver node 402 aperture 304.

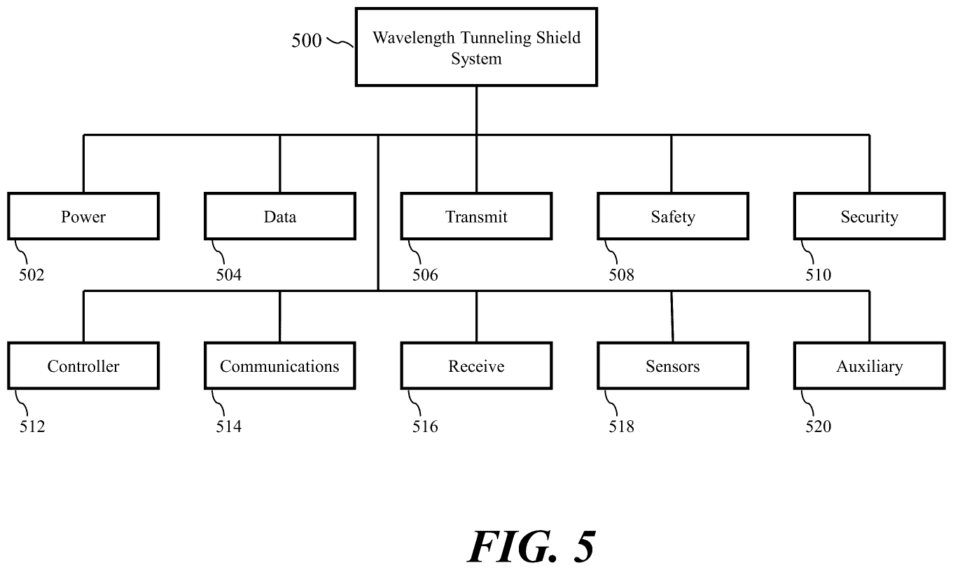

FIG. 5 illustrates a system diagram of major functions of an apparatus including critical subsystems. The apparatus 500 consists of the following major functions which manage their respective areas of responsibility: power 502, data 504, transmit 506, safety 508, security 510, controller 512, communications 514, receive 516, sensors 518, and auxiliary 520. The power function 502 controls and manages a 500 power within the system as well as external power received by various sources. The power function 502 also controls fault detection/fault isolation (FDFI) sub functions as it relates to the operation and protection of the apparatus 500. The data function 504 controls and manages a 500 data within the system as well as external data received by various sources. The data function 504 also controls fault detection/fault isolation (FDFI), encoding, decoding, protocol definition, timing, and compression sub functions as it relates to the operation and protection of the apparatus 500. The transmit function 506 controls and manages a 500 signal-of-interest and protection beam transmission. The transmit function 506 also controls fault detection/fault isolation (FDFI), coherent source signal generation and thermal management, modulation, internal signal distribution network, beam train direction, emitter operation, and external apparatus 500 housing sub functions as it relates to the operation and protection of the apparatus 500. The safety function 508 controls and manages a 500 signal-of-interest transmission operations to ensure the apparatus 500 does not harm itself or its surroundings during operation or pre/post-operational maneuvers. The safety function 508 also controls fault detection/fault isolation (FDFI), threshold transmission power levels, transmission cut-out/non-radiating zones, apparatus 500 near-item collision awareness for deployed non-fixed site locations, and other safety action sub functions as dictated by command and control messages. The security function 510 controls and manages a 500 signal-of-interest and protection beam(s) transmission operations to ensure secure signal transmission and receive operations. The security function 510 also controls fault detection/fault isolation (FDFI), encryption, signal-of-interest routing, signal-of-interest message parsing and breakup, and obstruction/malicious intent detection response sub functions as it relates to the operation and protection of the apparatus 500. The controller function 512 controls and manages aspects of the sub functions of apparatus 500. The controller function 512 is the central command and control for other sub functions within the apparatus 500 to include the orchestration, prioritization, and management of sub functions. The controller function 512 also dictates when sub functions should schedule and/or perform fault detection/fault isolation (FDFI) checks, reprogramming of sub functional memory, instruction sets, and apparatus 500 boot up and initialization operations. The communications function 514 controls and manages apparatus 500 external communications. The communications function 514 also controls messages set and received by other apparatus 500 or command and control orders for the apparatus 500 to forward to the controller function 512 to interpret and act upon. The receive function 516 controls and manages apparatus 500 signal-of-interest and protection beam receivers. The receive function 516 also controls fault detection/fault isolation (FDFI), demodulation, internal signal distribution network, beam train direction, receiver operation, and external apparatus 500 housing sub functions as it relates to the operation and protection of the apparatus 500. The sensors function 516 controls and manages a 500 suite of sensors and the information flowing from them to ensure correct operation. The sensors function 516 also controls external environmental sensing, internal apparatus 500 shock and vibe, internal navigation, as well as each sensors fault detection/fault isolation (FDFI) sub functions as it relates to the operation and protection of the apparatus 500. The auxiliary function 520 controls and manages payloads interfaced with the apparatus 500. The auxiliary function 520 controls external payload interrupts and capabilities to ensure they align with a 500 controller function 512 commands and objectives. Auxiliary function 520 payload examples include apparatus 500 propulsion system for space positioning and signal-of-interest source/destination backup links.

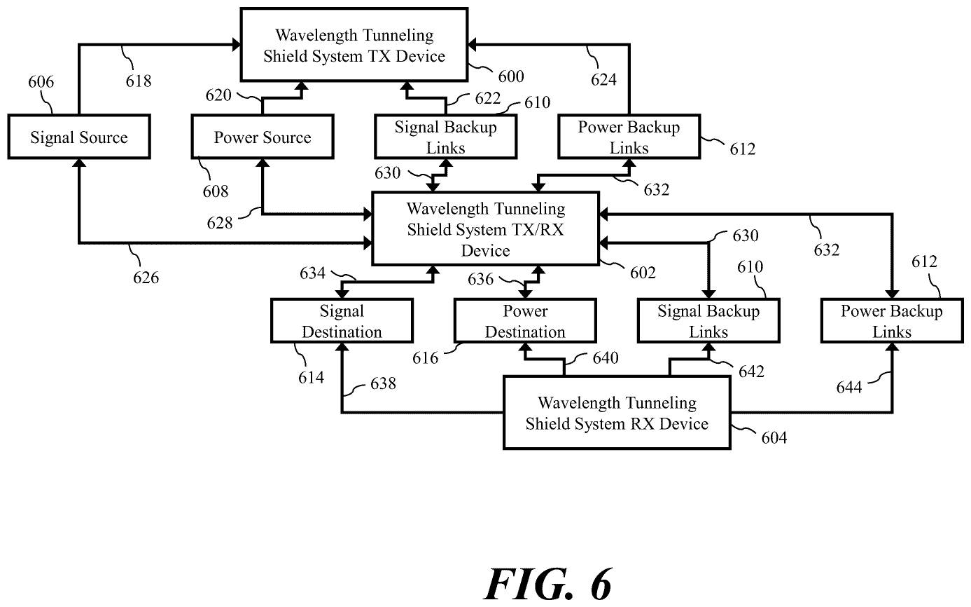

FIG. 6 illustrates, at a high level, the three different configurations of the apparatus is able to interface with external connections. As shown in this example, an apparatus in the transmit-only configuration 600 is able to: interface 618 with signal-of-interest source(s) 606, interface 620 with power-of-interest source(s) 608, interface 622 with signal backup link(s) 610, and interface 624 with power backup link(s) 612. An apparatus in the revive-only configuration 604 is able to: interface 638 with signal-of-interest destination(s) 614, interface 640 with power-of-interest destination(s) 616, interface 642 with signal backup link(s) 610, and interface 644 with power backup link(s) 612. An apparatus in the transmit/revive configuration 602 is able to: interface 634 with signal-of-interest destination(s) 614, interface 636 with power-of-interest destination(s) 616, interface 630 with signal backup link(s) 610, interface 632 with power backup link(s) 612, interface 626 with signal-of-interest source(s) 606, and interface 628 with power-of-interest source(s) 608.

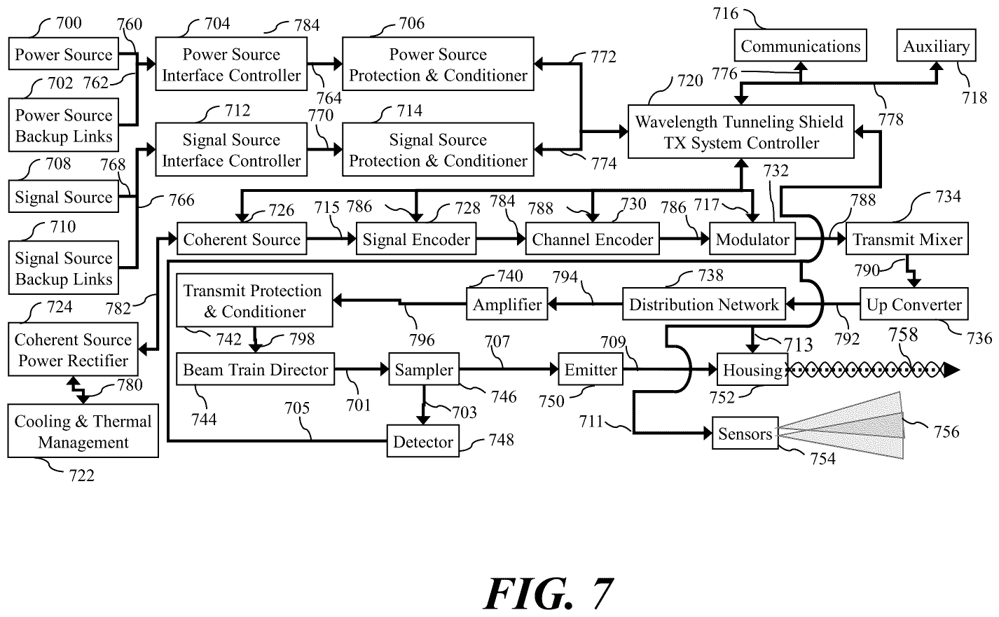

FIG. 7 illustrates the functional block diagram of a transmitting node configuration showing the internal data/information/control flows and various functional subsystem interactions when operating. As shown in this example, a transmitting node is interfaced with four external inputs: a primary power source 700 via 760, power source backup links 702 via 762, a primary signal-of-interest source 708 via 768, and signal-of-interest source backup links 710 via 766. The primary power source 700 and power source backup links 702 are connected via 760 and 762 with a power source interface controller module 704 which provides the main external facing interface with power inputs into the apparatus. In turn, the power source interface controller module 704 is connected 764 with the power source protection and conditioner module 706 which ensure the input power into the apparatus is the proper phase, voltage, or other power characteristics as expected and required by the apparatus to function or transmit. Similarly, the primary signal-of-interest source 708 and signal-of-interest source backup links 710 are connected via 768 and 766 with a signal source interface controller module 712 which provides the main external facing interface with signal inputs into the apparatus. In turn, the signal source interface controller module 712 is connected 770 with the signal source protection and conditioner module 714 which ensure the input signal into the apparatus is the type, protocol, encryption standard, or other signal characteristics as expected and required by the apparatus to function or transmit. These two source protection and conditioning modules 706 and 714 are connected via a bidirectional command and control link 772 and 774 to a transmitter system node controller module 720. A transmitter system node controller module 720 interfaces with many major sub function modules within the system as well as many minor sub function modules within the system. To communicate with other apparatus transmit-only, receive-only, or transmit-receive nodes, the transmitter system node controller module 720 interfaces 776 with the communications module 716. To ensure external payloads connected to the apparatus support objectives for the apparatus, the transmitter system node controller module 720 interfaces 778 with the auxiliary module 718. An abbreviated example of the numerous command and control interfaces the transmitter system node controller module 720 has with minor sub function modules includes: the transmitter system node controller module 720 interfacing 784 with the coherent source module 726 to control coherent source generation at the proper power level and frequency; the transmitter system node controller module 720 interfacing 786 with the signal encoder module 728 to control proper signal encoding; the transmitter system node controller module 720 interfacing 788 with the channel encoder module 730 to control proper channel encoding; the transmitter system node controller module 720 interfacing 717 with the modulator module 732 to control proper signal modulation for phase, polarization, and other aspects as needed for optical or radio frequency arrays; the transmitter system node controller module 720 interfacing 713 with the external housing module 752 to control proper housing modulation and frequency of the vibrating emitter array face or lens to ensure environmental artifacts do not interfere with the signal-of-interest transmission; and the transmitter system node controller module 720 interfacing 711 with the sensors module 754 to receive data updates, signal-of-interest transmission performance, external environmental and security awareness. The coherent source module 726 is feed 782 by two modules: the coherent source power rectifier module 724 and the cooling and thermal management module 722 which are connected by 780. The cooling and thermal management module 722 provides thermal management capabilities to the coherent source power rectifier module 724 and the coherent source module 726 to ensure proper operation of these modules within expected performance parameters. The coherent source power rectifier module 724 ensures any power feed from the power source protection and conditioner module 706 will not harm the coherent source module 726. With the signal-of-interest and/or power-to-be-transmitted feed into the coherent source module 726, the coherent source module 726 generates the proper coherent waves to be transmitted. These proper waves are sent via 715 to the signal encoder module 728 to be encoded based on the proper or required message protocol. Once the signal has been encoded by 728 it is sent 784 to the channel encoder module 730 where it is encoded for the channel. Once complete, the signal is sent 786 to the modulator module 717 where the signal is phased align with the environmental 756, housing 752, sensor 754, auxiliary 718 inputs, and other emission characteristics like that of beam spot size, shape, pointing location(s) on receive array, and polarization. The signal is then passed to the transmit mixer module 734 via 788 where it is mixed (if needed) before being sent via 790 to the up converter module 736 to be converted (if needed) to the proper format or frequency. Once ready, the signal is then passed to the distribution network module 738 via 792 where the signal is routed based on coherent source transmission medium type through the proper splitters to separate the signal-of-interest distribution pathway from the signal-of-protection distribution pathway as both pathways will likely be transmitted with different power levels, wave and signal characteristics. These distribution pathways then follow a similar generalized path to final transmission by being sent to an amplifier module 740 via 794. Once amplified to the proper level(s), the signals are sent via 796 to a transmit protection and conditioner module 742 where the amplification of the signals is checked to ensure the resulting amplification meets the required performance levels to not only satisfy the “link equation” requirements but as well as the resultant signals amplification does not exceed thresholds which could be damaging to the transmit and/or receive hardware. After this quality and safety check has passed, the signals are sent through 798 to the beam train director module 744 which routes the signals through the rest of transmitter to the final modules prior to signal transmission. For coherent sources not making use of adaptive optics, steering mirrors, radio frequency reflectors, and wave guides, the beam train director module 744 may consist of signal-of-interest and signal-of-protection splitters and combiners to satisfy emitter module 750 requirements of multi-single beam emitters or single-continuous beam emitters. Next, the signals are sent via 701 to the sampler module 746 where portions of the signals are sampled and sent via 703 to a detector module 748 to ensure the signals meet the performance levels as expected and predicted by the wavelength tunneling shield TX system controller 720. These measurements from the detector module 748 are sent via 705 to the wavelength tunneling shield TX system controller 720. If the measurements from the detector module 748 are not within the expected and predicted performance levels, the wavelength tunneling shield TX system controller 720 will make adjustments to the coherent source module 726, signal encoder module 728, channel encoder module 730, modulator module 732, transmit protection and conditioner module 742, beam train director module 744, and housing module 752 based on feedback not only from the detector module 748, but as well as feedback from the sensors module 754 detecting environmental changes 756, auxiliary module 718, and real-time feedback from the receive node via the communications module 716 or if the node is making use of opposing signal-of-protection receiver modules or bidirectional signal-of-interest configurations. From the sampler module 746 the signals are sent via 707 to their respective emitter modules 750, if needed, for final transmission via 709 internal to the node. As the signals pass into the external environment, the housing module 752 acts as the final layer prior to this. The housing module, dependent on coherent source type, may consist of a single or multiple phase-controlled vibrating lenses or array faces to ensure clean optics or arrays by providing a buffer against particulates or foreign debris from fouling, degrading, or obstructing the emitting lenses or array face surfaces in producing the transmitted set of signals 758.

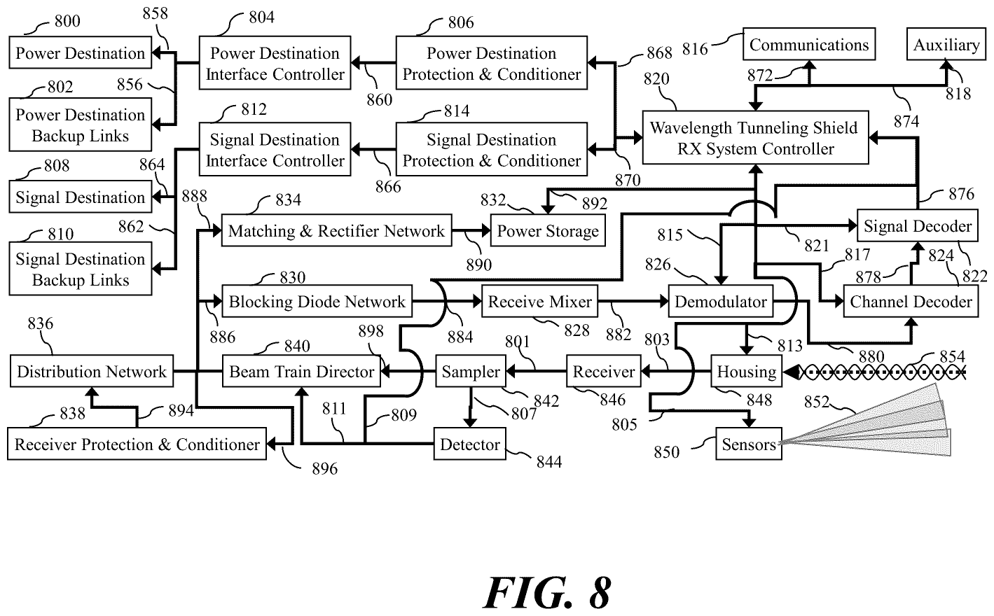

FIG. 8 illustrates the functional block diagram of a receiving node configuration showing the internal data/information/control flows and various functional subsystem interactions when operating. As shown in this example, a receiving node is interfaced with four external inputs: a primary power destination 800 via 858, power destination backup links 802 via 856, a primary signal-of-interest destination 808 via 864, and signal-of-interest destination backup links 810 via 862. The primary power destination 800 and power destination backup links 802 are connected via 858 and 856 with a power destination interface controller module 804 which provides the main external facing interface with power outputs from the apparatus. In turn, the power destination interface controller 804 is connected 860 with the power destination protection and conditioner module 806 which ensures the output power from the apparatus is the proper phase, voltage, or other power characteristics as expected and required by the destination and apparatus to function or receive. Similarly, the primary signal-of-interest destination 808 and signal-of-interest destination backup links 810 are connected via 864 and 862 with a signal destination interface controller module 812 which provides the main external facing interface with signal outputs from the apparatus. In turn, the signal destination interface controller module 812 is connected 866 with the signal destination protection and conditioner module 814 which ensure the output signal from the apparatus is the type, protocol, encryption standard, or other signal characteristics as expected and required by the destination and apparatus to function. These two destination protection and conditioning modules 806 and 814 are connected via a bidirectional command and control link 868 and 870 to a receiver system node controller module 820. A receiver system node controller module 820 interfaces with many major sub function modules within the system as well as many minor sub function modules within the system. To communicate with other apparatus transmit-only, receive-only, or transmit-receive nodes, the receiver system node controller module 820 interfaces 872 with the communications module 816. To ensure external payloads connected to the apparatus support apparatus objectives, the receiver system node controller module 820 interfaces 874 with the auxiliary module 818. An abbreviated example of the numerous command and control interfaces the receiver system node controller module 820 has with minor sub function modules includes: the receiver system node controller module 820 interfacing 892 with the power storage module 832 to ensure the receiver system node is capable of operation if external power sources are severed, the receiver system node controller module 820 interfacing 876 with the signal decoder module 822 to control proper signal decoding; the receiver system node controller module 820 interfacing 817 with the channel decoder module 824 to control proper channel decoding; the receiver system node controller module 820 interfacing 815 with the demodulator module 826 to control proper signal demodulation for phase, polarization, and other aspects as needed for optical or radio frequency arrays; the receiver system node controller module 820 interfacing 813 with the external housing module 848 to control proper housing modulation and frequency of the vibrating emitter array face or lens to ensure environmental artifacts do not interfere with the signal-of-interest receive; and the receiver system node controller module 820 interfacing 805 with the sensors module 850 to receive data updates, signal-of-interest receive performance, external environmental and security awareness. The received set of signals 854 pass through the housing module 848 which dependent on coherent source type, may consist of a single or multiple phase-controlled vibrating lenses or array faces to ensure clean optics or arrays by providing a buffer against particulates or foreign debris from fouling, degrading, or obstructing the receive lenses or array face surfaces in receiving the transmitted set of signals 854. As the signals pass into the internal environment, the housing module 848 acts as the final layer prior to this. From the housing module 848 the signals are sent via 803 to receiver module 846. As the signals are passed to the sampler module 842 via 801 where portions of them are sampled by the detector module 844 via 807 to check for expected and predicted performance levels and emission characteristics like that of beam spot size, shape, pointing location(s) on receive array, and polarization. They reported back via 809 to the receiver system node controller module 820. Additionally, the detector module 844 informs 811 the beam train director module 840 on the correct received signals to be split for routing based on the signal being a signal-of-interest or a signal-of-protection. If the measurements from the detector module 844 are not within the expected and predicted performance levels, the wavelength tunneling shield RX system controller module 820 will make adjustments to the signal decoder module 822 via 821, channel decoder module 824 via 817, demodulator module 826 via 815, receive protection and conditioner module 838, beam train director module 840, and housing module 848 via 813 based on feedback not only from the detector module 844, but as well as feedback from the sensors module 850 detecting environmental changes 852, auxiliary module 818, and real-time feedback from the transmit node via the communications module 816 or if the node is making use of opposing signal-of-protection emitter modules or bidirectional signal-of-interest configurations. The signal-of-interest and signal-of-protection are now passed down their own individual pathways from the beam train detector module 840 via 896 to the receiver protection and conditioner module 838 when the signals are inspected to ensure they are within the correct power and phase thresholds as to not damage internal receive system node components. Once these checks are passed, the signals are passed to the distribution network module 836 via 894 there they are routed to the proper pathway for receiver system node power functionality or receiver system node signal communication functionality. For power functionality, the distribution network module 836 will route the power signal via 888 to the matching and rectifier network module 834 before forwarding the final power signal via 890 to the power storage module 832. For signal communication functionality, the distribution network module 836 will route communication signal via 886 to the blocking diode network module 830. From here the signal is passed via 884 to the receiver mixer module 828, if needed. The signal is then passed via 882 to the demodulator module 826 where it is demodulated. From there the signal is passed via 880 to the channel decoder module 824. Once demodulated, the signal is passed via 878 to the signal decoder module 822 where it is decoded and final transmitted via 876 to the receiver system node controller module 820.

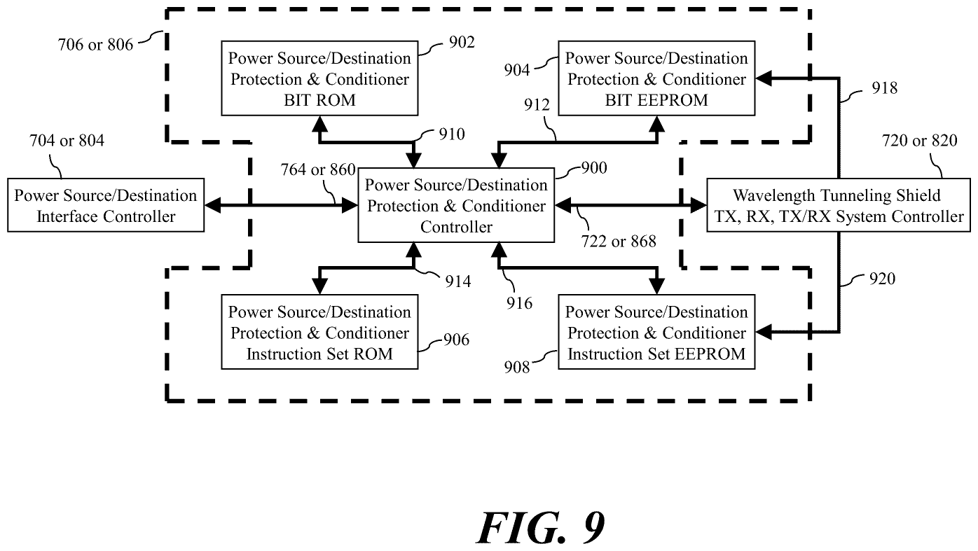

FIG. 9 illustrates, at a further lower level, the internal data/information/control flows and various functional subsystem interactions of the Power Source/Destination Protection and Conditioner subsystem of the apparatus. Due to this illustration combining the transmit and receive system nodes for this subsystem, some of the numberings in FIG. 9 contain two options to refer to based on the perspective from which elements in FIG. 9 are being described. From the transmit perspective, the power source protection and conditioner subsystem 706 of FIG. 9 includes: a power source protection and conditioner controller module 900, a power source protection and conditioner BIT ROM module 902, a power source protection and conditioner BIT EEPROM module 904, a power source protection and conditioner instruction set ROM module 906, and a power source protection and conditioner instruction set EEPROM module 908. The power source protection and conditioner subsystem 706 interfaces with the power source interface controller module 704 via 764 and the wavelength tunneling shield TX system controller module 720 via 722. As the power signal is feed into the power source protection and conditioner subsystem 706 from power source interface controller module 704 via 764, its characteristics and properties are checked against performance measures and quality metrics. For operations where no power source protection and conditioner instruction set ROM module 906 reprogramming have taken place since initial power source protection and conditioner subsystem 706 creation, the power source protection and conditioner controller module 900 conditions the received power signal per the power source protection and conditioner instruction set ROM module 906 via 914 and is sent to the wavelength tunneling shield TX system controller module 720 via 722. For FDFI operations, if the wavelength tunneling shield TX system controller module 720 via 722 or the power source protection and conditioner controller module 900 command a FDFI BIT is needed or scheduled, the power source protection and conditioner controller module 900 via 910 will retrieve a pre-determined raw power signal from the power source protection and conditioner BIT ROM module 902 via 914 and condition it per the power source protection and conditioner instruction set ROM module 906. Once the power source protection and conditioner controller module 900 has conditioned the FDFI BIT pre-determined raw power signal, it will send it back to the power source protection and conditioner BIT ROM module 902 for comparison. Once the result has been determined, error or non-error, it is reported to the wavelength tunneling shield TX system controller module 720 via 722 for an overall transmit system node status. For operations where the power source protection and conditioner subsystem 706 has had its power source protection and conditioner BIT EEPROM module 904 and power source protection and conditioner instruction set EEPROM module 908 reprogrammed by the wavelength tunneling shield TX system controller module 720 via 918 and 920, the power source protection and conditioner controller module 900 conditions the received power signal per the power source protection and conditioner instruction set EEPROM module 908 via 916 and is sent to the wavelength tunneling shield TX system controller module 720 via 722. For FDFI operations, if the wavelength tunneling shield TX system controller module 720 via 722 or the power source protection and conditioner controller module 900 command a FDFI BIT is needed or scheduled, the power source protection and conditioner controller module 900 via 912 will retrieve the reprogrammed pre-determined raw power signal from the power source protection and conditioner BIT EEPROM module 904 via 912 and condition it per the power source protection and conditioner reprogrammed instruction set EEPROM module 908. Once the power source protection and conditioner controller module 900 has conditioned the FDFI BIT reprogrammed pre-determined raw power signal, it will send it back to the power source protection and conditioner BIT EEPROM module 904 for comparison. Once the result has been determined, error or non-error, it is reported to the wavelength tunneling shield TX system controller module 720 via 722 for an overall transmit system node status. From the receive perspective, the power source protection and conditioner subsystem 806 of FIG. 9 includes: a power destination protection and conditioner controller module 900, a power destination protection and conditioner BIT ROM module 902, a power destination protection and conditioner BIT EEPROM module 904, a power destination protection and conditioner instruction set ROM module 906, and a power destination protection and conditioner instruction set EEPROM module 908. The power destination protection and conditioner subsystem 806 interfaces with the power destination interface controller module 804 via 860 and the wavelength tunneling shield RX system controller module 820 via 868. As the power signal is feed from the power destination protection and conditioner subsystem 806 to power destination interface controller module 804 via 860, its characteristics and properties are checked against performance measures and quality metrics. For operations where no power destination protection and conditioner instruction set ROM module 906 reprogramming have taken place since initial power destination protection and conditioner subsystem 806 creation, the power destination protection and conditioner controller module 900 conditions the received power signal per the power destination protection and conditioner instruction set ROM module 906 via 914 and is sent to the power destination interface controller module 804 via 860. For FDFI operations, if the wavelength tunneling shield RX system controller module 820 via 868 or the power destination protection and conditioner controller module 900 command a FDFI BIT is needed or scheduled, the power destination protection and conditioner controller module 900 via 910 will retrieve a pre-determined raw power signal from the power destination protection and conditioner BIT ROM module 902 via 914 and condition it per the power destination protection and conditioner instruction set ROM module 906. Once the power destination protection and conditioner controller module 900 has conditioned the FDFI BIT pre-determined raw power signal, it will send it back to the power destination protection and conditioner BIT ROM module 902 for comparison. Once the result has been determined, error or non-error, it is reported to the wavelength tunneling shield RX system controller module 820 via 868 for an overall receive system node status. For operations where the power destination protection and conditioner subsystem 806 has had its power destination protection and conditioner BIT EEPROM module 904 and power destination protection and conditioner instruction set EEPROM module 908 reprogrammed by the wavelength tunneling shield RX system controller module 820 via 918 and 920, the power destination protection and conditioner controller module 900 conditions the received power signal per the power destination protection and conditioner instruction set EEPROM module 908 via 916 and is sent to the power destination interface controller module 804 via 860. For FDFI operations, if the wavelength tunneling shield RX system controller module 820 via 868 or the power destination protection and conditioner controller module 900 command a FDFI BIT is needed or scheduled, the power destination protection and conditioner controller module 900 via 912 will retrieve the reprogrammed pre-determined raw power signal from the power destination protection and conditioner BIT EEPROM module 904 via 912 and condition it per the power destination protection and conditioner reprogrammed instruction set EEPROM module 908. Once the power destination protection and conditioner controller module 900 has conditioned the FDFI BIT reprogrammed pre-determined raw power signal, it will send it back to the power destination protection and conditioner BIT EEPROM module 904 for comparison. Once the result has been determined, error or non-error, it is reported to the wavelength tunneling shield RX system controller module 820 via 868 for an overall receive system node status. For system nodes capable of transmitting and receiving, they contain both subsystems: power source protection and conditioner subsystem 706 and power destination protection and conditioner subsystem 806 within their respective transmit/receive chains.

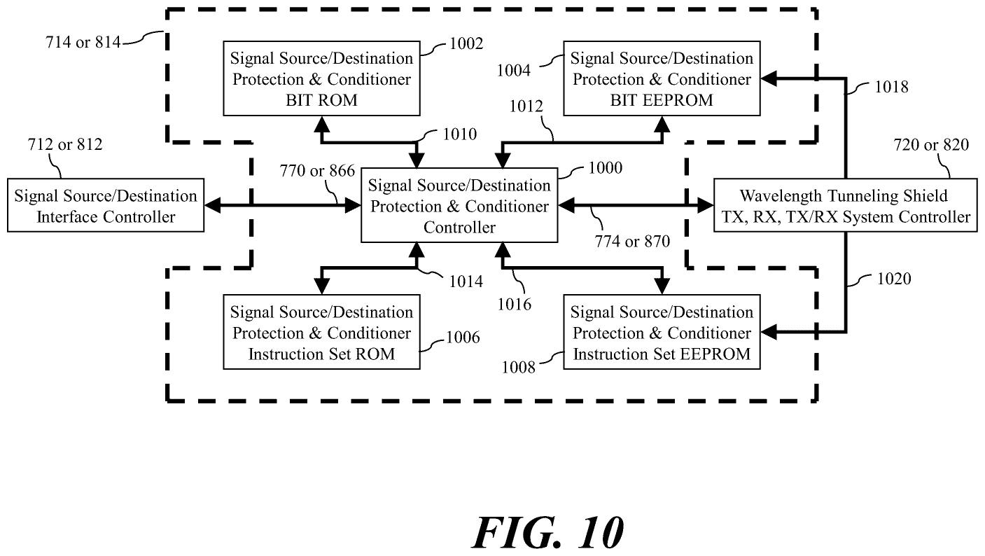

FIG. 10 illustrates, at a further lower level, the internal data/information/control flows and various functional subsystem interactions of as Signal Source/Destination Protection and Conditioner subsystem. Due to this illustration combining the transmit and receive system nodes for this subsystem, some of the numberings FIG. 10 contain two options to refer to based on the perspective from which elements in FIG. 10 are being described. From the transmit perspective, the signal source protection and conditioner subsystem 714 of FIG. 10 includes: a signal source protection and conditioner controller module 1000, a signal source protection and conditioner BIT ROM module 1002, a signal source protection and conditioner BIT EEPROM module 1004, a signal source protection and conditioner instruction set ROM module 1006, and a signal source protection and conditioner instruction set EEPROM module 1008. The signal source protection and conditioner subsystem 714 interfaces with the signal source interface controller module 712 via 770 and the wavelength tunneling shield TX system controller module 720 via 774. As the signal is feed into the signal source protection and conditioner subsystem 714 from signal source interface controller module 712 via 770, its characteristics and properties are checked against performance measures and quality metrics. For operations where no signal source protection and conditioner instruction set ROM module 1006 reprogramming have taken place since initial signal source protection and conditioner subsystem 714 creation, the signal source protection and conditioner controller module 1000 conditions the received signal per the signal source protection and conditioner instruction set ROM module 1006 via 1014 and is sent to the wavelength tunneling shield TX system controller module 720 via 774. For FDFI operations, if the wavelength tunneling shield TX system controller module 720 via 774 or the signal source protection and conditioner controller module 1000 command a FDFI BIT is needed or scheduled, the signal source protection and conditioner controller module 1000 via 1010 will retrieve a pre-determined raw signal from the signal source protection and conditioner BIT ROM module 1002 via 1014 and condition it per the signal source protection and conditioner instruction set ROM module 1006. Once the signal source protection and conditioner controller module 1000 has conditioned the FDFI BIT pre-determined raw signal, it will send it back to the signal source protection and conditioner BIT ROM module 1002 for comparison. Once the result has been determined, error or non-error, it is reported to the wavelength tunneling shield TX system controller module 720 via 774 for an overall transmit system node status. For operations where the signal source protection and conditioner subsystem 714 has had its signal source protection and conditioner BIT EEPROM module 1004 and signal source protection and conditioner instruction set EEPROM module 1008 reprogrammed by the wavelength tunneling shield TX system controller module 720 via 1018 and 1020, the signal source protection and conditioner controller module 1000 conditions the received signal per the signal source protection and conditioner instruction set EEPROM module 1008 via 1016 and is sent to the wavelength tunneling shield TX system controller module 720 via 774. For FDFI operations, if the wavelength tunneling shield TX system controller module 720 via 774 or the signal source protection and conditioner controller module 1000 command a FDFI BIT is needed or scheduled, the signal source protection and conditioner controller module 1000 via 1012 will retrieve the reprogrammed pre-determined raw signal from the signal source protection and conditioner BIT EEPROM module 1004 via 1012 and condition it per the signal source protection and conditioner reprogrammed instruction set EEPROM module 1008. Once the signal source protection and conditioner controller module 1000 has conditioned the FDFI BIT reprogrammed pre-determined raw signal, it will send it back to the signal source protection and conditioner BIT EEPROM module 1004 for comparison. Once the result has been determined, error or non-error, it is reported to the wavelength tunneling shield TX system controller module 720 via 774 for an overall transmit system node status. From the receive perspective, the signal source protection and conditioner subsystem 814 of FIG. 10 includes: a signal destination protection and conditioner controller module 1000, a signal destination protection and conditioner BIT ROM module 1002, a signal destination protection and conditioner BIT EEPROM module 1004, a signal destination protection and conditioner instruction set ROM module 1006, and a signal destination protection and conditioner instruction set EEPROM module 1008. The signal destination protection and conditioner subsystem 814 interfaces with the signal destination interface controller module 812 via 866 and the wavelength tunneling shield RX system controller module 820 via 870. As the signal is feed from the signal destination protection and conditioner subsystem 814 to signal destination interface controller module 812 via 866, its characteristics and properties are checked against performance measures and quality metrics. For operations where no signal destination protection and conditioner instruction set ROM module 1006 reprogramming have taken place since initial signal destination protection and conditioner subsystem 814 creation, the signal destination protection and conditioner controller module 1000 conditions the received signal per the signal destination protection and conditioner instruction set ROM module 1006 via 1014 and is sent to the signal destination interface controller module 812 via 866. For FDFI operations, if the wavelength tunneling shield RX system controller module 820 via 870 or the signal destination protection and conditioner controller module 1000 command a FDFI BIT is needed or scheduled, the signal destination protection and conditioner controller module 1000 via 1010 will retrieve a pre-determined raw signal from the signal destination protection and conditioner BIT ROM module 1002 via 1014 and condition it per the signal destination protection and conditioner instruction set ROM module 1006. Once the signal destination protection and conditioner controller module 1000 has conditioned the FDFI BIT pre-determined raw signal, it will send it back to the signal destination protection and conditioner BIT ROM module 1002 for comparison. Once the result has been determined, error or non-error, it is reported to the wavelength tunneling shield RX system controller module 820 via 870 for an overall receive system node status. For operations where the signal destination protection and conditioner subsystem 814 has had its signal destination protection and conditioner BIT EEPROM module 1004 and signal destination protection and conditioner instruction set EEPROM module 1008 reprogrammed by the wavelength tunneling shield RX system controller module 820 via 1018 and 1020, the signal destination protection and conditioner controller module 1000 conditions the received signal per the signal destination protection and conditioner instruction set EEPROM module 1008 via 1016 and is sent to the signal destination interface controller module 812 via 866. For FDFI operations, if the wavelength tunneling shield RX system controller module 820 via 870 or the signal destination protection and conditioner controller module 1000 command a FDFI BIT is needed or scheduled, the signal destination protection and conditioner controller module 1000 via 1012 will retrieve the reprogrammed pre-determined raw signal from the signal destination protection and conditioner BIT EEPROM module 1004 via 1012 and condition it per the signal destination protection and conditioner reprogrammed instruction set EEPROM module 1008. Once the signal destination protection and conditioner controller module 1000 has conditioned the FDFI BIT reprogrammed pre-determined raw signal, it will send it back to the signal destination protection and conditioner BIT EEPROM module 1004 for comparison. Once the result has been determined, error or non-error, it is reported to the wavelength tunneling shield RX system controller module 820 via 870 for an overall receive system node status. For system nodes capable of transmitting and receiving, they contain both subsystems: signal source protection and conditioner subsystem 714 and signal destination protection and conditioner subsystem 814 within their respective transmit/receive chains.

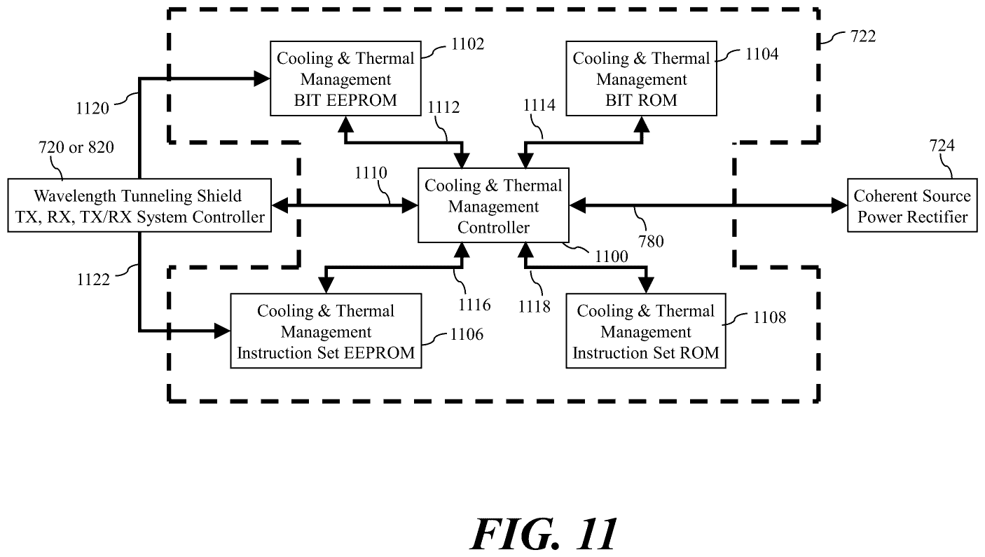

FIG. 11 illustrates, at a further lower level, the internal data/information/control flows and various functional subsystem interactions of the transmit apparatus' Cooling and Thermal Management subsystem 722. The Cooling and Thermal Management subsystem 722 of FIG. 11 includes: cooling and thermal management controller module 1100, a cooling and thermal management BIT ROM module 1104, a cooling and thermal management BIT EEPROM module 1102, a cooling and thermal management instruction set ROM module 1108, and a cooling and thermal management instruction set EEPROM module 1106. The cooling and thermal management subsystem 722 interfaces with the coherent source power rectifier module 724 via 780 and the wavelength tunneling shield TX system controller module 720 via 1110. For operations where no cooling and thermal management instruction set ROM module 1108 reprogramming have taken place since initial cooling and thermal management subsystem 722 creation, the cooling and thermal management controller module 1100 provides cooling and thermal services to the coherent source power rectifier module 724 to which in turn provides power and cooling services to the coherent source module 726 per cooling and thermal management instruction set ROM module 1108 via 1118. For FDFI operations, if the wavelength tunneling shield TX system controller module 720 via 1110 or the cooling and thermal management controller module 1100 command a FDFI BIT is needed or scheduled, the cooling and thermal management controller module 1100 via 1114 will retrieve a pre-determined raw signal from the cooling and thermal management BIT ROM module 1104 and via 1118 condition it per the cooling and thermal management instruction set ROM module 1108. Once the cooling and thermal management controller module 1100 has conditioned the FDFI BIT pre-determined raw signal, it will send it back to the cooling and thermal management BIT ROM module 1104 for comparison. Once the result has been determined, error or non-error, it is reported to the wavelength tunneling shield TX system controller module 720 via 1110 for an overall transmit system node status. For operations where the cooling and thermal management subsystem 722 has had its cooling and thermal management BIT EEPROM module 1102 and cooling and thermal management instruction set EEPROM module 1106 reprogrammed by the wavelength tunneling shield TX system controller module 720 via 1120 and 1122, the cooling and thermal management controller module 1100 conditions the received signal per the cooling and thermal management instruction set EEPROM module 1106 via 1116 and is sent to the coherent source power rectifier module 724 via 780. For FDFI operations, if the wavelength tunneling shield TX system controller module 720 via 1110 or the cooling and thermal management controller module 1100 command a FDFI BIT is needed or scheduled, the cooling and thermal management controller module 1100 via 1112 will retrieve the reprogrammed pre-determined raw signal from the cooling and thermal management BIT EEPROM module 1102 and via 1116 and condition it per the cooling and thermal management instruction set EEPROM module 1106. Once the cooling and thermal management controller module 1100 has conditioned the FDFI BIT reprogrammed pre-determined raw signal, it will send it back to the cooling and thermal management BIT EEPROM module 1102 for comparison. Once the result has been determined, error or non-error, it is reported to the wavelength tunneling shield TX system controller module 720 via 1110 for an overall transmit system node status.

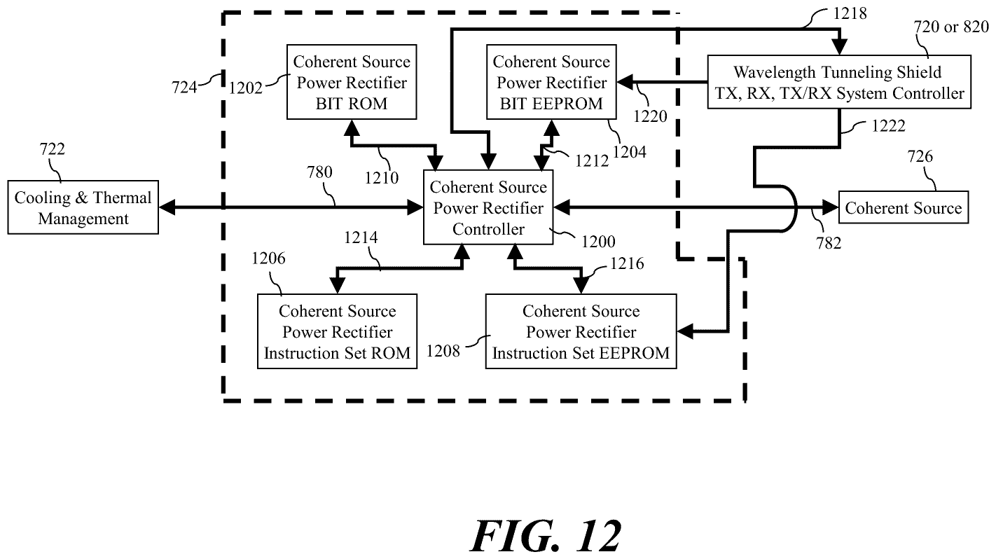

FIG. 12 illustrates, at a further lower level, the internal data/information/control flows and various functional subsystem interactions of the transmit apparatus' Coherent Source Power Rectifier subsystem 724. The Coherent Source Power Rectifier subsystem 724 of FIG. 12 includes: coherent source power rectifier controller module 1200, a coherent source power rectifier BIT ROM module 1202, a coherent source power rectifier BIT EEPROM module 1204, a coherent source power rectifier instruction set ROM module 1206, and a coherent source power rectifier instruction set EEPROM module 1208. The coherent source power rectifier subsystem 724 interfaces with the coherent source module 726 via 782, the cooling and thermal management module 722 via 780, and the wavelength tunneling shield TX system controller module 720 via 1218. For operations where no coherent source power rectifier instruction set ROM module 1206 reprogramming have taken place since initial coherent source power rectifier subsystem 724 creation, the coherent source power rectifier controller module 1200 provides power rectifying services to the coherent source module 726 per the coherent source power rectifier instruction set ROM module 1206 via 1214. For FDFI operations, if the wavelength tunneling shield TX system controller module 720 via 1218 or the coherent source power rectifier controller module 1200 command a FDFI BIT is needed or scheduled, the coherent source power rectifier controller module 1200 via 1210 will retrieve a pre-determined raw signal from the coherent source power rectifier BIT ROM module 1202 and via 1214 condition it per the coherent source power rectifier instruction set ROM module 1206. Once the coherent source power rectifier controller module 1200 has conditioned the FDFI BIT pre-determined raw signal, it will send it back to the coherent source power rectifier BIT ROM module 1202 for comparison. Once the result has been determined, error or non-error, it is reported to the wavelength tunneling shield TX system controller module 720 via 1218 for an overall transmit system node status. For operations where the coherent source power rectifier subsystem 724 has had its coherent source power rectifier BIT EEPROM module 1204 and coherent source power rectifier instruction set EEPROM module 1208 reprogrammed by the wavelength tunneling shield TX system controller module 720 via 1220 and 1222, the coherent source power rectifier controller module 1200 conditions the received signal per the coherent source power rectifier instruction set EEPROM module 1208 via 1216 and is sent to the coherent source module 726 via 782. For FDFI operations, if the wavelength tunneling shield TX system controller module 720 via 1218 or the coherent source power rectifier controller module 1200 command a FDFI BIT is needed or scheduled, the coherent source power rectifier controller module 1200 via 1212 will retrieve the reprogrammed pre-determined raw signal from the coherent source power rectifier BIT EEPROM module 1204 and via 1216 and condition it per the coherent source power rectifier instruction set EEPROM module 1208. Once the coherent source power rectifier controller module 1200 has conditioned the FDFI BIT reprogrammed pre-determined raw signal, it will send it back to the coherent source power rectifier BIT EEPROM module 1204 for comparison. Once the result has been determined, error or non-error, it is reported to the wavelength tunneling shield TX system controller module 720 via 1218 for an overall transmit system node status.

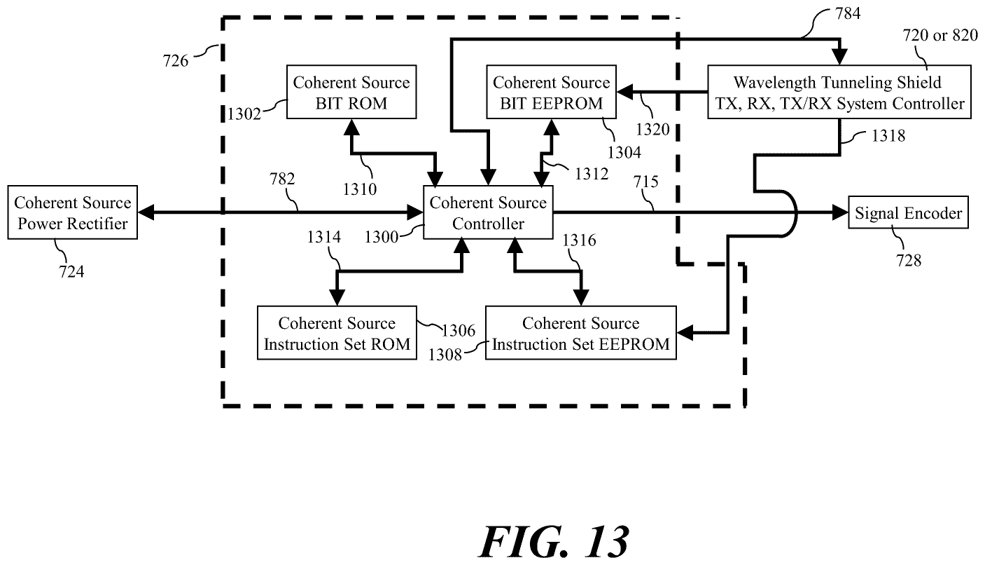

FIG. 13 illustrates, at a further lower level, the internal data/information/control flows and various functional subsystem interactions of the transmit apparatus' Coherent Source subsystem 726. The Coherent Source subsystem 726 of FIG. 13 includes: coherent source controller module 1300, a coherent source BIT ROM module 1302, a coherent source BIT EEPROM module 1304, a coherent source instruction set ROM module 1306, and a coherent source instruction set EEPROM module 1308. The coherent source subsystem 726 interfaces with the coherent source module 728 via 715, the coherent source power rectifier module 724 via 782, and the wavelength tunneling shield TX system controller module 720 via 784. For operations where no coherent source instruction set ROM module 1306 reprogramming actions have taken place since initial coherent source subsystem 726 creation, the coherent source controller module 1300 provides coherent source generation services to the signal encoder module 728 per the coherent source instruction set ROM module 1306 via 1314. For FDFI operations, if the wavelength tunneling shield TX system controller module 720 via 784 or the coherent source controller module 1300 command a FDFI BIT is needed or scheduled, the coherent source controller module 1300 via 1310 will retrieve a pre-determined raw signal from the coherent source BIT ROM module 1302 and via 1314 generate it per the coherent source instruction set ROM module 1306. Once the coherent source controller module 1300 has generated the FDFI BIT pre-determined raw signal, it will send it back to the coherent source BIT ROM module 1302 for comparison. Once the result has been determined, error or non-error, it is reported to the wavelength tunneling shield TX system controller module 720 via 784 for an overall transmit system node status. For operations where the coherent source subsystem 726 has had its coherent source BIT EEPROM module 1304 and coherent source instruction set EEPROM module 1308 reprogrammed by the wavelength tunneling shield TX system controller module 720 via 1318 and 1320, the coherent source controller module 1300 generates the received signal per the coherent source instruction set EEPROM module 1308 via 1316 and is sent to the signal encoder module 728 via 715. For FDFI operations, if the wavelength tunneling shield TX system controller module 720 via 784 or the coherent source controller module 1300 command a FDFI BIT is needed or scheduled, the coherent source controller module 1300 via 1312 will retrieve the reprogrammed pre-determined raw signal from the coherent source BIT EEPROM module 1304 and via 1316 and generates it per the coherent source instruction set EEPROM module 1308. Once the coherent source controller module 1300 has generated the FDFI BIT reprogrammed pre-determined raw signal, it will send it back to the coherent source BIT EEPROM module 1304 for comparison. Once the result has been determined, error or non-error, it is reported to the wavelength tunneling shield TX system controller module 720 via 784 for an overall transmit system node status.

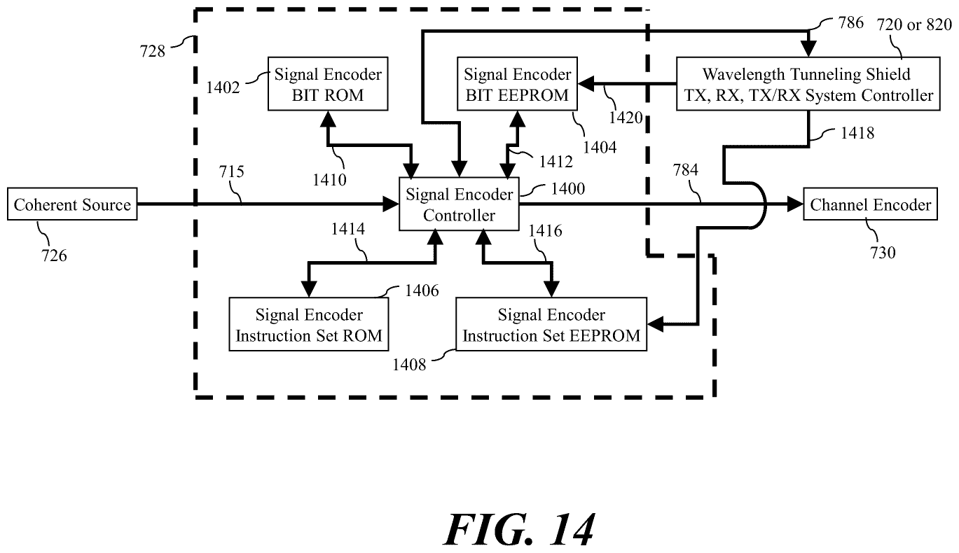

FIG. 14 illustrates, at a further lower level, the internal data/information/control flows and various functional subsystem interactions of the transmit apparatus' Signal Encoder subsystem 728. The Signal Encoder subsystem 728 of FIG. 14 includes: signal encoder controller module 1400, a signal encoder BIT ROM module 1402, a signal encoder BIT EEPROM module 1404, a signal encoder instruction set ROM module 1406, and a signal encoder instruction set EEPROM module 1408. The signal encoder subsystem 728 interfaces with the coherent source module 726 via 715, the channel encoder module 730 via 784, and the wavelength tunneling shield TX system controller module 720 via 786. For operations where no signal encoder instruction set ROM module 1406 reprogramming actions have taken place since initial signal encoder subsystem 728 creation, the signal encoder controller module 1400 provides signal encoder services to the channel encoder module 730 per the signal encoder instruction set ROM module 1406 via 1414. For FDFI operations, if the wavelength tunneling shield TX system controller module 720 via 786 or the signal encoder controller module 1400 command a FDFI BIT is needed or scheduled, the signal encoder controller module 1400 via 1410 will retrieve a pre-determined raw signal from the signal encoder BIT ROM module 1402 and via 1414 encode it per the signal encoder instruction set ROM module 1406. Once the signal encoder controller module 1400 has encoded the FDFI BIT pre-determined raw signal, it will send it back to the signal encoder BIT ROM module 1402 for comparison. Once the result has been determined, error or non-error, it is reported to the wavelength tunneling shield TX system controller module 720 via 786 for an overall transmit system node status. For operations where the signal encoder subsystem 728 has had its signal encoder BIT EEPROM module 1404 and signal encoder instruction set EEPROM module 1408 reprogrammed by the wavelength tunneling shield TX system controller module 720 via 1418 and 1420, the signal encoder controller module 1400 encode the received signal per the signal encoder instruction set EEPROM module 1408 via 1416 and is sent to the channel encoder module 730 via 784. For FDFI operations, if the wavelength tunneling shield TX system controller module 720 via 786 or the signal encoder controller module 1400 command a FDFI BIT is needed or scheduled, the signal encoder controller module 1400 via 1412 will retrieve the reprogrammed pre-determined raw signal from the signal encoder BIT EEPROM module 1404 and via 1416 and encode it per the signal encoder instruction set EEPROM module 1408. Once the signal encoder controller module 1400 has encoded the FDFI BIT reprogrammed pre-determined raw signal, it will send it back to the signal encoder BIT EEPROM module 1404 for comparison. Once the result has been determined, error or non-error, it is reported to the wavelength tunneling shield TX system controller module 720 via 786 for an overall transmit system node status.

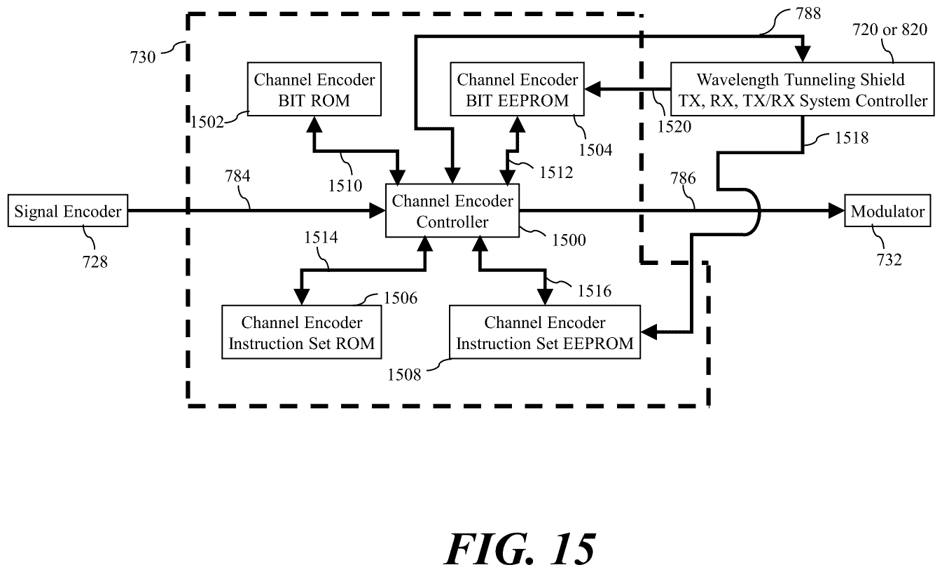

FIG. 15 illustrates, at a further lower level, the internal data/information/control flows and various functional subsystem interactions of the transmit apparatus' Channel Encoder subsystem 730. The Channel Encoder subsystem 730 of FIG. 15 includes: channel encoder controller module 1500, a channel encoder BIT ROM module 1502, a channel encoder BIT EEPROM module 1504, a channel encoder instruction set ROM module 1506, and a channel encoder instruction set EEPROM module 1508. The channel encoder subsystem 730 interfaces with the signal encoder module 728 via 784, the modulator module 732 via 786, and the wavelength tunneling shield TX system controller module 720 via 788. For operations where no channel encoder instruction set ROM module 1506 reprogramming actions have taken place since initial channel encoder subsystem 730 creation, the channel encoder controller module 1500 provides channel encoder services to the modulator module 732 per the channel encoder instruction set ROM module 1506 via 1514. For FDFI operations, if the wavelength tunneling shield TX system controller module 720 via 788 or the channel encoder controller module 1500 command a FDFI BIT is needed or scheduled, the channel encoder controller module 1500 via 1510 will retrieve a pre-determined raw signal from the channel encoder BIT ROM module 1502 and via 1514 encode it per the channel encoder instruction set ROM module 1506. Once the channel encoder controller module 1500 has encoded the FDFI BIT pre-determined raw signal, it will send it back to the channel encoder BIT ROM module 1502 for comparison. Once the result has been determined, error or non-error, it is reported to the wavelength tunneling shield TX system controller module 720 via 788 for an overall transmit system node status. For operations where the channel encoder subsystem 730 has had its channel encoder BIT EEPROM module 1504 and channel encoder instruction set EEPROM module 1508 reprogrammed by the wavelength tunneling shield TX system controller module 720 via 1518 and 1520, the channel encoder controller module 1500 encodes the received signal per the channel encoder instruction set EEPROM module 1508 via 1516 and is sent to the modulator module 732 via 786. For FDFI operations, if the wavelength tunneling shield TX system controller module 720 via 788 or the channel encoder controller module 1500 command a FDFI BIT is needed or scheduled, the channel encoder controller module 1500 via 1512 will retrieve the reprogrammed pre-determined raw signal from the channel encoder BIT EEPROM module 1504 and via 1516 and encode it per the channel encoder instruction set EEPROM module 1508. Once the channel encoder controller module 1500 has encoded the FDFI BIT reprogrammed pre-determined raw signal, it will send it back to the channel encoder BIT EEPROM module 1504 for comparison. Once the result has been determined, error or non-error, it is reported to the wavelength tunneling shield TX system controller module 720 via 788 for an overall transmit system node status.

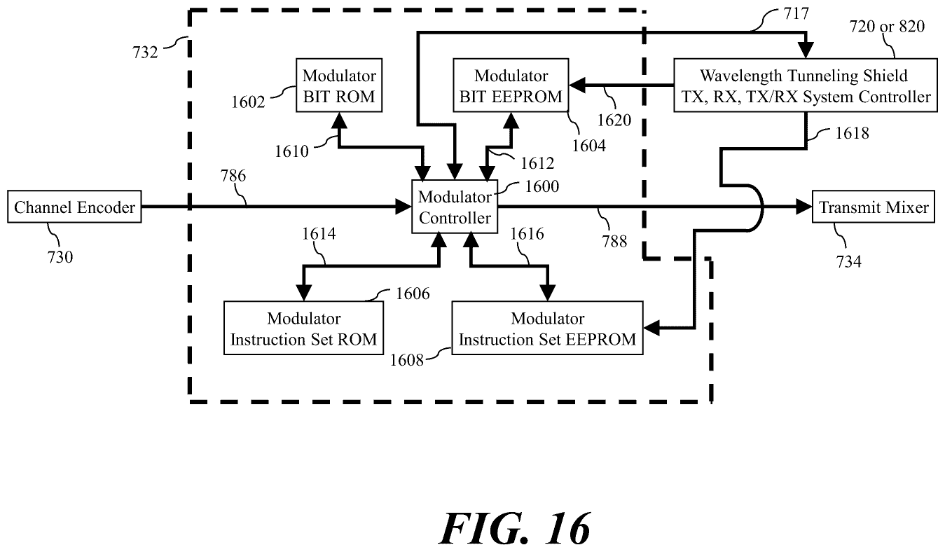

FIG. 16 illustrates, at a further lower level, the internal data/information/control flows and various functional subsystem interactions of the transmit apparatus' Modulator subsystem 732. The Modulator subsystem 732 of FIG. 16 includes: modulator controller module 1600, a modulator BIT ROM module 1602, a modulator BIT EEPROM module 1604, a modulator instruction set ROM module 1606, and a modulator instruction set EEPROM module 1608. The modulator subsystem 732 interfaces with the channel encoder module 730 via 786, the transmit mixer module 734 via 788, and the wavelength tunneling shield TX system controller module 720 via 717. For operations where no modulator instruction set ROM module 1606 reprogramming actions have taken place since initial modulator subsystem 732 creation, the modulator controller module 1600 provides modulation services to the transmit mixer module 734 per the modulator instruction set ROM module 1606 via 1614. For FDFI operations, if the wavelength tunneling shield TX system controller module 720 via 717 or the modulator controller module 1600 command a FDFI BIT is needed or scheduled, the modulator controller module 1600 via 1610 will retrieve a pre-determined raw signal from the modulator BIT ROM module 1602 and via 1614 modulate it per the modulator instruction set ROM module 1606. Once the modulator controller module 1600 has modulated the FDFI BIT pre-determined raw signal, it will send it back to the modulator BIT ROM module 1602 for comparison. Once the result has been determined, error or non-error, it is reported to the wavelength tunneling shield TX system controller module 720 via 717 for an overall transmit system node status. For operations where the modulator subsystem 732 has had its modulator BIT EEPROM module 1604 and modulator instruction set EEPROM module 1608 reprogrammed by the wavelength tunneling shield TX system controller module 720 via 1618 and 1620, the modulator controller module 1600 encodes the received signal per the modulator instruction set EEPROM module 1608 via 1616 and is sent to the transmit mixer module 734 via 788. For FDFI operations, if the wavelength tunneling shield TX system controller module 720 via 717 or the modulator controller module 1600 command a FDFI BIT is needed or scheduled, the modulator controller module 1600 via 1612 will retrieve the reprogrammed pre-determined raw signal from the modulator BIT EEPROM module 1604 and via 1616 and modulate it per the modulator instruction set EEPROM module 1608. Once the modulator controller module 1600 has modulated the FDFI BIT reprogrammed pre-determined raw signal, it will send it back to the modulator BIT EEPROM module 1604 for comparison. Once the result has been determined, error or non-error, it is reported to the wavelength tunneling shield TX system controller module 720 via 717 for an overall transmit system node status.

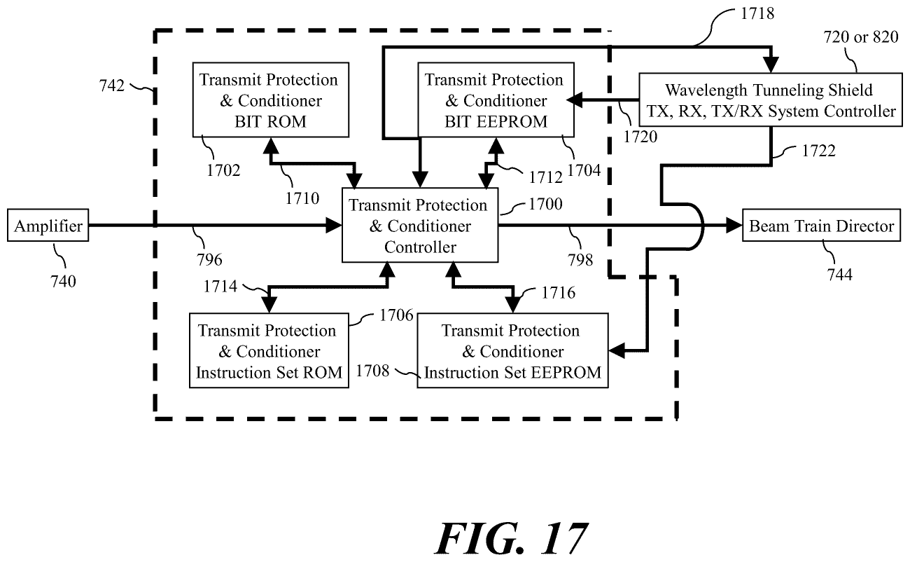

FIG. 17 illustrates, at a further lower level, the internal data/information/control flows and various functional subsystem interactions of the transmit apparatus' Transmit Protection and Conditioner subsystem 742. The Transmit Protection and Conditioner subsystem 742 of FIG. 17 includes: transmit protection and conditioner controller module 1700, a transmit protection and conditioner BIT ROM module 1702, a transmit protection and conditioner BIT EEPROM module 1704, a transmit protection and conditioner instruction set ROM module 1706, and a transmit protection and conditioner instruction set EEPROM module 1708. The transmit protection and conditioner subsystem 742 interfaces with the amplifier module 740 via 796, the beam train director module 744 via 798, and the wavelength tunneling shield TX system controller module 720 via 1718. For operations where no transmit protection and conditioner instruction set ROM module 1706 reprogramming actions have taken place since initial transmit protection and conditioner subsystem 742 creation, the transmit protection and conditioner controller module 1700 provides protection and conditioning services to the beam train director module 744 per the transmit protection and conditioner instruction set ROM module 1706 via 1714. For FDFI operations, if the wavelength tunneling shield TX system controller module 720 via 1718 or the transmit protection and conditioner controller module 1700 command a FDFI BIT is needed or scheduled, the transmit protection and conditioner controller module 1700 via 1710 will retrieve a pre-determined raw signal from the transmit protection and conditioner BIT ROM module 1702 and via 1714 condition it per the transmit protection and conditioner instruction set ROM module 1706. Once the transmit protection and conditioner controller module 1700 has conditioned the FDFI BIT pre-determined raw signal, it will send it back to the transmit protection and conditioner BIT ROM module 1702 for comparison. Once the result has been determined, error or non-error, it is reported to the wavelength tunneling shield TX system controller module 720 via 1718 for an overall transmit system node status. For operations where the transmit protection and conditioner subsystem 742 has had its transmit protection and conditioner BIT EEPROM module 1704 and transmit protection and conditioner instruction set EEPROM module 1708 reprogrammed by the wavelength tunneling shield TX system controller module 720 via 1722 and 1720, the transmit protection and conditioner controller module 1700 conditions the received signal per the transmit protection and conditioner instruction set EEPROM module 1708 via 1716 and is sent to the beam train director module 744 via 798. For FDFI operations, if the wavelength tunneling shield TX system controller module 720 via 1718 or the transmit protection and conditioner controller module 1700 command a FDFI BIT is needed or scheduled, the transmit protection and conditioner controller module 1700 via 1712 will retrieve the reprogrammed pre-determined raw signal from the transmit protection and conditioner BIT EEPROM module 1704 and via 1716 and condition it per the transmit protection and conditioner instruction set EEPROM module 1708. Once the transmit protection and conditioner controller module 1700 has conditioned the FDFI BIT reprogrammed pre-determined raw signal, it will send it back to the transmit protection and conditioner BIT EEPROM module 1704 for comparison. Once the result has been determined, error or non-error, it is reported to the wavelength tunneling shield TX system controller module 720 via 1718 for an overall transmit system node status.

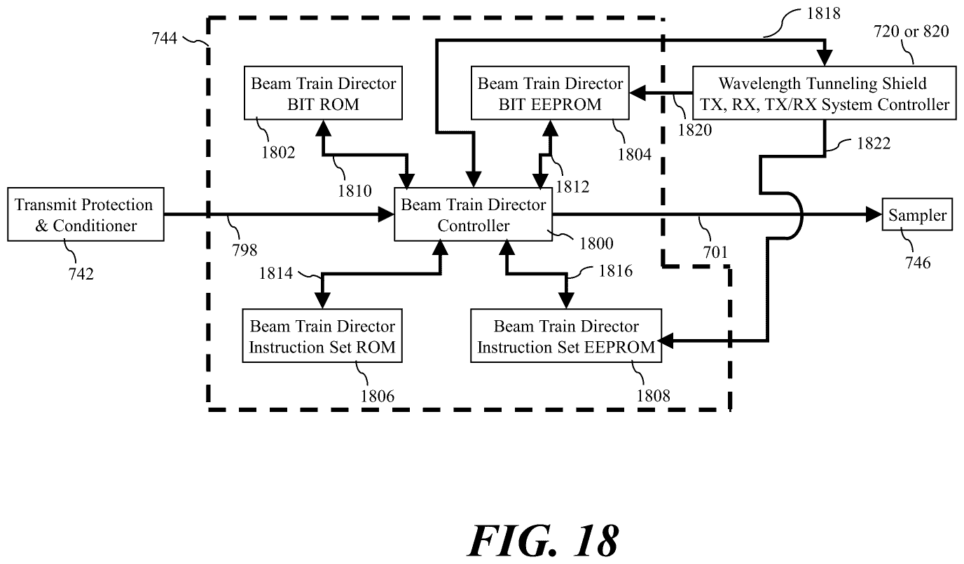

FIG. 18 illustrates, at a further lower level, the internal data/information/control flows and various functional subsystem interactions of the transmit apparatus' Beam Train Director subsystem 744. The Beam Train Director subsystem 744 of FIG. 18 includes: beam train director controller module 1800, a beam train director BIT ROM module 1802, a beam train director BIT EEPROM module 1804, a beam train director instruction set ROM module 1806, and a beam train director instruction set EEPROM module 1808. The beam train director subsystem 744 interfaces with the transmit protection and conditioner module 742 via 798, the sampler module 746 via 701, and the wavelength tunneling shield TX system controller module 720 via 1818. For operations where no beam train director instruction set ROM module 1806 reprogramming actions have taken place since initial beam train director subsystem 744 creation, the beam train director controller module 1800 provides direction services to the sampler module 746 per the beam train director instruction set ROM module 1806 via 1814. For FDFI operations, if the wavelength tunneling shield TX system controller module 720 via 1818 or the beam train director controller module 1800 command a FDFI BIT is needed or scheduled, the beam train director controller module 1800 via 1810 will retrieve a pre-determined raw signal from the beam train director BIT ROM module 1802 and via 1814 direct it per the beam train director instruction set ROM module 1806. Once the beam train director controller module 1800 has directed the FDFI BIT pre-determined raw signal, it will send it back to the beam train director BIT ROM module 1802 for comparison. Once the result has been determined, error or non-error, it is reported to the wavelength tunneling shield TX system controller module 720 via 1818 for an overall transmit system node status. For operations where the beam train director subsystem 744 has had its beam train director BIT EEPROM module 1804 and beam train director instruction set EEPROM module 1808 reprogrammed by the wavelength tunneling shield TX system controller module 720 via 1822 and 1820, the beam train director controller module 1800 directs the received signal per the beam train director instruction set EEPROM module 1808 via 1816 and is sent to the beam train director module 744 via 798. For FDFI operations, if the wavelength tunneling shield TX system controller module 720 via 1818 or the beam train director controller module 1800 command a FDFI BIT is needed or scheduled, the beam train director controller module 1800 via 1812 will retrieve the reprogrammed pre-determined raw signal from the beam train director BIT EEPROM module 1804 and via 1816 and direct it per the beam train director instruction set EEPROM module 1808. Once the beam train director controller module 1800 has directed the FDFI BIT reprogrammed pre-determined raw signal, it will send it back to the beam train director BIT EEPROM module 1804 for comparison. Once the result has been determined, error or non-error, it is reported to the wavelength tunneling shield TX system controller module 720 via 1818 for an overall transmit system node status.

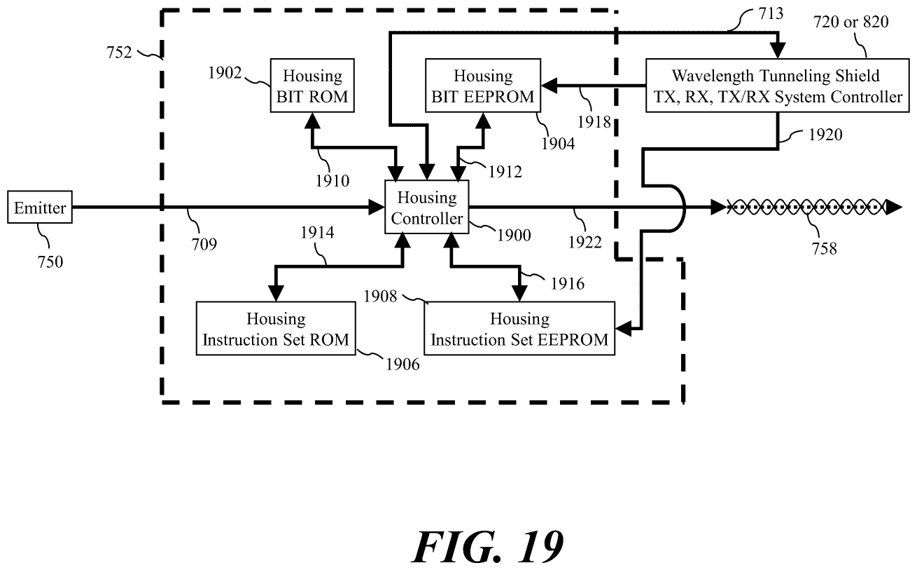

FIG. 19 illustrates, at a further lower level, the internal data/information/control flows and various functional subsystem interactions of the transmit apparatus' Housing subsystem 752. The Housing subsystem 752 of FIG. 19 includes: housing controller module 1900, a housing BIT ROM module 1902, a housing BIT EEPROM module 1904, a housing instruction set ROM module 1906, and a housing instruction set EEPROM module 1908. The housing subsystem 752 interfaces with the emitter module 750 via 709, the external environment 758 via 1922, and the wavelength tunneling shield TX system controller module 720 via 713. For operations where no housing instruction set ROM module 1906 reprogramming actions have taken place since initial housing subsystem 752 creation, the housing controller module 1900 provides environmental protection services to the emitter module 750 per the housing instruction set ROM module 1906 via 1914. For FDFI operations, if the wavelength tunneling shield TX system controller module 720 via 713 or the housing controller module 1900 command a FDFI BIT is needed or scheduled, the housing controller module 1900 via 1910 will retrieve a pre-determined raw signal from the housing BIT ROM module 1902 and via 1914 protect it per the housing instruction set ROM module 1906. Once the housing controller module 1900 has protected the FDFI BIT pre-determined raw signal, it will send it back to the housing BIT ROM module 1902 for comparison. Once the result has been determined, error or non-error, it is reported to the wavelength tunneling shield TX system controller module 720 via 713 for an overall transmit system node status. For operations where the housing subsystem 752 has had its housing BIT EEPROM module 1904 and housing instruction set EEPROM module 1908 reprogrammed by the wavelength tunneling shield TX system controller module 720 via 1920 and 1918, the housing controller module 1900 protects the received signal per the housing instruction set EEPROM module 1908 via 1916 and is sent to the external environment 758 via 1922. For FDFI operations, if the wavelength tunneling shield TX system controller module 720 via 713 or the housing controller module 1900 command a FDFI BIT is needed or scheduled, the housing controller module 1900 via 1912 will retrieve the reprogrammed pre-determined raw signal from the housing BIT EEPROM module 1904 and via 1916 and protect it per the housing instruction set EEPROM module 1908. Once the housing controller module 1900 has protected the FDFI BIT reprogrammed pre-determined raw signal, it will send it back to the housing BIT EEPROM module 1904 for comparison. Once the result has been determined, error or non-error, it is reported to the wavelength tunneling shield TX system controller module 720 via 713 for an overall transmit system node status.

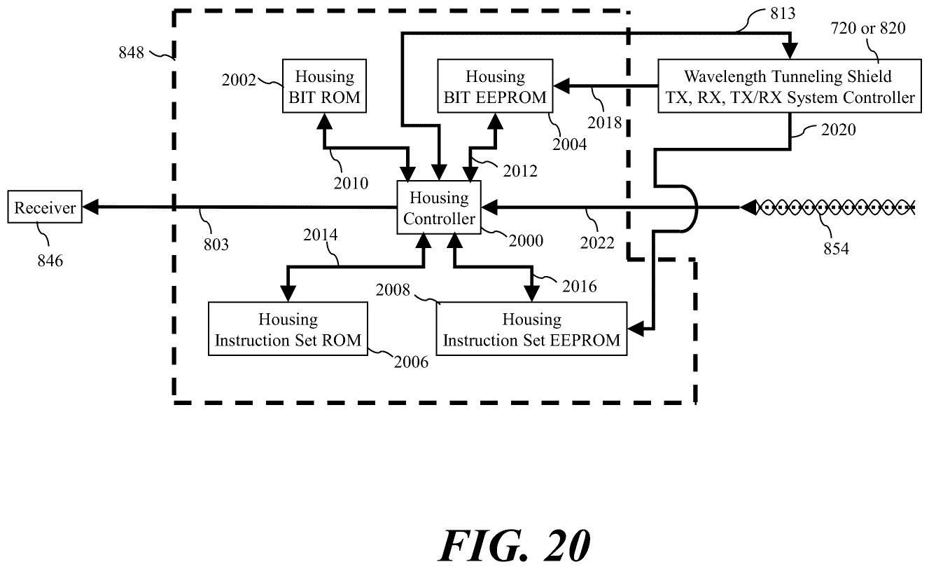

FIG. 20 illustrates, at a further lower level, the internal data/information/control flows and various functional subsystem interactions of the receive apparatus' Housing subsystem 848. The Housing subsystem 848 of FIG. 20 includes: housing controller module 2000, a housing BIT ROM module 2002, a housing BIT EEPROM module 2004, a housing instruction set ROM module 2006, and a housing instruction set EEPROM module 2008. The housing subsystem 848 interfaces with the receiver module 846 via 803, the external environment 854 via 2022, and the wavelength tunneling shield RX system controller module 820 via 813. For operations where no housing instruction set ROM module 2006 reprogramming actions have taken place since initial housing subsystem 848 creation, the housing controller module 2000 provides environmental protection services to the receiver module 846 per the housing instruction set ROM module 2006 via 2014. For FDFI operations, if the wavelength tunneling shield RX system controller module 820 via 813 or the housing controller module 2000 command a FDFI BIT is needed or scheduled, the housing controller module 2000 via 2010 will retrieve a pre-determined raw signal from the housing BIT ROM module 2002 and via 2014 protect it per the housing instruction set ROM module 2006. Once the housing controller module 2000 has protected the FDFI BIT pre-determined raw signal, it will send it back to the housing BIT ROM module 2002 for comparison. Once the result has been determined, error or non-error, it is reported to the wavelength tunneling shield RX system controller module 820 via 813 for an overall receive system node status. For operations where the housing subsystem 848 has had its housing BIT EEPROM module 2004 and housing instruction set EEPROM module 2008 reprogrammed by the wavelength tunneling shield RX system controller module 820 via 2020 and 2018, the housing controller module 2000 protects the received signal from the external environment 854 via 2022 per the housing instruction set EEPROM module 2008 via 2016 and is sent to the receiver module 846 via 803. For FDFI operations, if the wavelength tunneling shield RX system controller module 820 via 813 or the housing controller module 2000 command a FDFI BIT is needed or scheduled, the housing controller module 2000 via 2012 will retrieve the reprogrammed pre-determined raw signal from the housing BIT EEPROM module 2004 and via 2016 and protect it per the housing instruction set EEPROM module 2008. Once the housing controller module 2000 has protected the FDFI BIT reprogrammed pre-determined raw signal, it will send it back to the housing BIT EEPROM module 2004 for comparison. Once the result has been determined, error or non-error, it is reported to the wavelength tunneling shield RX system controller module 820 via 813 for an overall receive system node status.

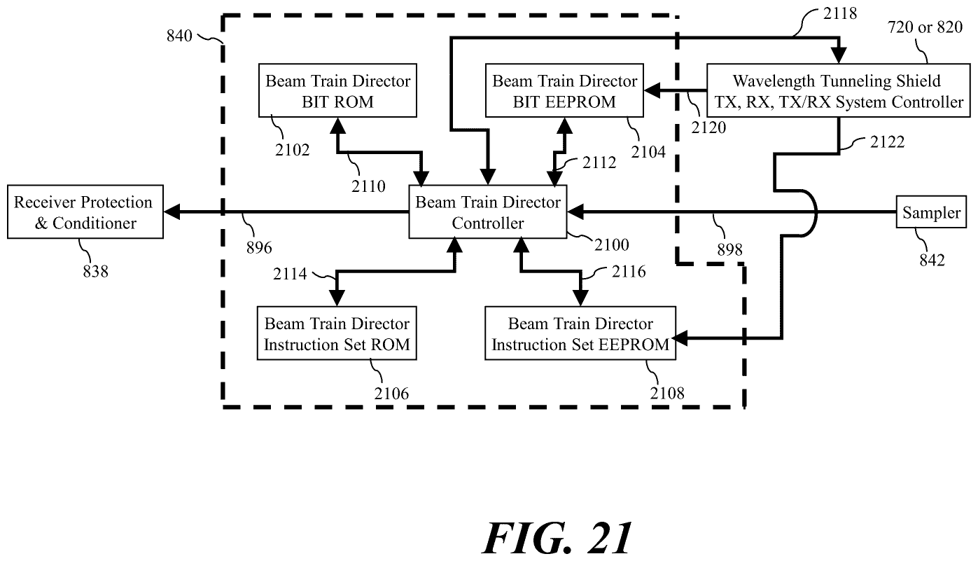

FIG. 21 illustrates, at a further lower level, the internal data/information/control flows and various functional subsystem interactions of the receive apparatus' Beam Train Director subsystem 840. The Beam Train Director subsystem 840 of FIG. 21 includes: beam train director controller module 2100, a beam train director BIT ROM module 2102, a beam train director BIT EEPROM module 2104, a beam train director instruction set ROM module 2106, and a beam train director instruction set EEPROM module 2108. The beam train director subsystem 840 interfaces with the receiver protection and conditioner module 838 via 896, the sampler module 842 via 898, and the wavelength tunneling shield RX system controller module 820 via 2118. For operations where no beam train director instruction set ROM module 2106 reprogramming actions have taken place since initial beam train director subsystem 840 creation, the beam train director controller module 2100 provides direction services to the receiver protection and conditioner module 838 per the beam train director instruction set ROM module 2106 via 2114. For FDFI operations, if the wavelength tunneling shield RX system controller module 820 via 2118 or the beam train director controller module 2100 command a FDFI BIT is needed or scheduled, the beam train director controller module 2100 via 2110 will retrieve a pre-determined raw signal from the beam train director BIT ROM module 2102 and via 2114 direct it per the beam train director instruction set ROM module 2106. Once the beam train director controller module 2100 has directed the FDFI BIT pre-determined raw signal, it will send it back to the beam train director BIT ROM module 2102 for comparison. Once the result has been determined, error or non-error, it is reported to the wavelength tunneling shield RX system controller module 820 via 2118 for an overall receive system node status. For operations where the beam train director subsystem 840 has had its beam train director BIT EEPROM module 2104 and beam train director instruction set EEPROM module 2108 reprogrammed by the wavelength tunneling shield RX system controller module 820 via 2122 and 2120, the beam train director controller module 2100 directs the received signal per the beam train director instruction set EEPROM module 2108 via 2116 and is sent to the receiver protection and conditioner module 838 via 896. For FDFI operations, if the wavelength tunneling shield RX system controller module 820 via 2118 or the beam train director controller module 2100 command a FDFI BIT is needed or scheduled, the beam train director controller module 2100 via 2112 will retrieve the reprogrammed pre-determined raw signal from the beam train director BIT EEPROM module 2104 and via 2116 and direct it per the beam train director instruction set EEPROM module 2108. Once the beam train director controller module 2100 has directed the FDFI BIT reprogrammed pre-determined raw signal, it will send it back to the beam train director BIT EEPROM module 2104 for comparison. Once the result has been determined, error or non-error, it is reported to the wavelength tunneling shield RX system controller module 820 via 2118 for an overall receive system node status.

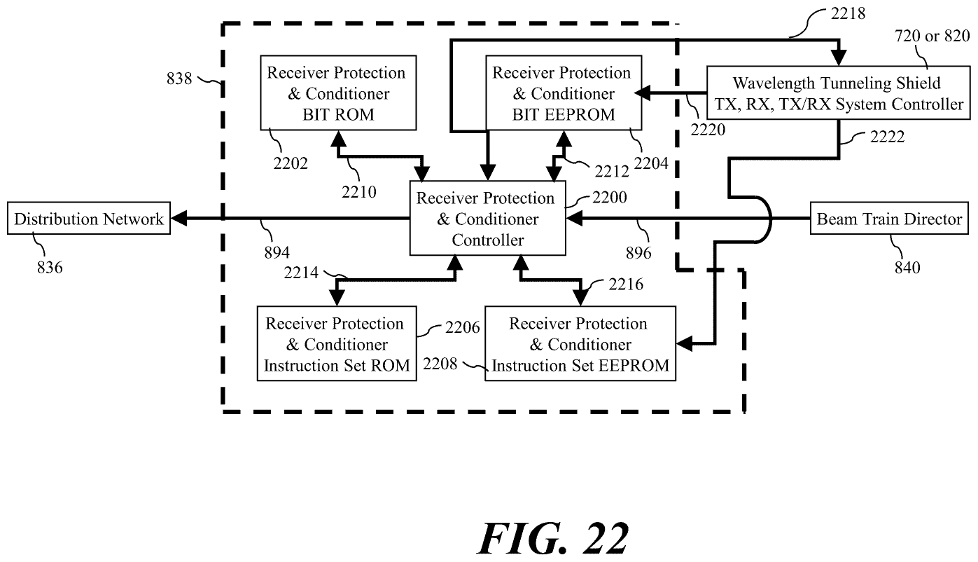

FIG. 22 illustrates, at a further lower level, the internal data/information/control flows and various functional subsystem interactions of the receive apparatus' Receiver Protection and Conditioner subsystem 838. The Receiver Protection and Conditioner subsystem 838 of FIG. 22 includes: receiver protection and conditioner controller module 2200, a receiver protection and conditioner BIT ROM module 2202, a receiver protection and conditioner BIT EEPROM module 2204, a receiver protection and conditioner instruction set ROM module 2206, and a receiver protection and conditioner instruction set EEPROM module 2208. The receiver protection and conditioner subsystem 838 interfaces with the distribution network module 836 via 894, the beam train director module 840 via 896, and the wavelength tunneling shield RX system controller module 820 via 2218. For operations where no receiver protection and conditioner instruction set ROM module 2206 reprogramming actions have taken place since initial receiver protection and conditioner subsystem 838 creation, the receiver protection and conditioner controller module 2200 provides protection and conditioning services to the distribution network module 836 per the receiver protection and conditioner instruction set ROM module 2206 via 2214. For FDFI operations, if the wavelength tunneling shield RX system controller module 820 via 2218 or the receiver protection and conditioner controller module 2200 command a FDFI BIT is needed or scheduled, the receiver protection and conditioner controller module 2200 via 2210 will retrieve a pre-determined raw signal from the receiver protection and conditioner BIT ROM module 2202 and via 2214 condition it per the receiver protection and conditioner instruction set ROM module 2206. Once the receiver protection and conditioner controller module 2200 has conditioned the FDFI BIT pre-determined raw signal, it will send it back to the receiver protection and conditioner BIT ROM module 2202 for comparison. Once the result has been determined, error or non-error, it is reported to the wavelength tunneling shield RX system controller module 820 via 2218 for an overall receive system node status. For operations where the receiver protection and conditioner subsystem 838 has had its receiver protection and conditioner BIT EEPROM module 2204 and receiver protection and conditioner instruction set EEPROM module 2208 reprogrammed by the wavelength tunneling shield RX system controller module 820 via 2222 and 2220, the receiver protection and conditioner controller module 2200 conditions the received signal per the receiver protection and conditioner instruction set EEPROM module 2208 via 2216 and is sent to the distribution network module 836 via 894. For FDFI operations, if the wavelength tunneling shield RX system controller module 820 via 2218 or the receiver protection and conditioner controller module 2200 command a FDFI BIT is needed or scheduled, the receiver protection and conditioner controller module 2200 via 2212 will retrieve the reprogrammed pre-determined raw signal from the receiver protection and conditioner BIT EEPROM module 2204 and via 2216 and condition it per the receiver protection and conditioner instruction set EEPROM module 2208. Once the receiver protection and conditioner controller module 2200 has conditioned the FDFI BIT reprogrammed pre-determined raw signal, it will send it back to the receiver protection and conditioner BIT EEPROM module 2204 for comparison. Once the result has been determined, error or non-error, it is reported to the wavelength tunneling shield RX system controller module 820 via 2218 for an overall receive system node status.

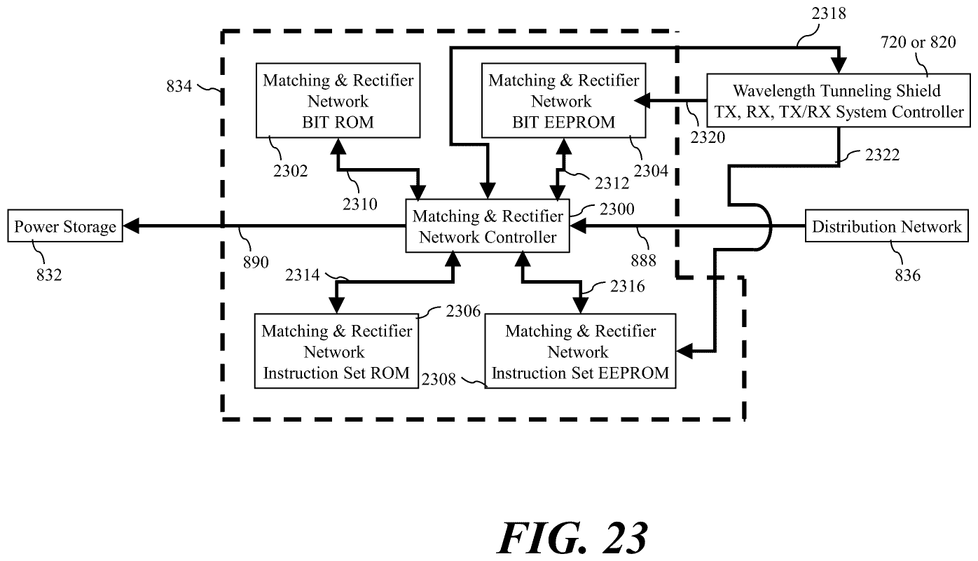

FIG. 23 illustrates, at a further lower level, the internal data/information/control flows and various functional subsystem interactions of the receive apparatus' Matching and Rectifier Network subsystem 834. The Matching and Rectifier Network subsystem 834 of FIG. 23 includes: matching and rectifier network controller module 2300, a matching and rectifier network BIT ROM module 2302, a matching and rectifier network BIT EEPROM module 2304, a matching and rectifier network instruction set ROM module 2306, and a matching and rectifier network instruction set EEPROM module 2308. The matching and rectifier network subsystem 834 interfaces with the power storage module 832 via 890, the distribution network module 836 via 888, and the wavelength tunneling shield RX system controller module 820 via 2318. For operations where no matching and rectifier network instruction set ROM module 2306 reprogramming actions have taken place since initial matching and rectifier network subsystem 834 creation, the matching and rectifier network controller module 2300 provides matching and rectifying services to the power storage module 832 per the matching and rectifier network instruction set ROM module 2306 via 2314. For FDFI operations, if the wavelength tunneling shield RX system controller module 820 via 2318 or the matching and rectifier network controller module 2300 command a FDFI BIT is needed or scheduled, the matching and rectifier network controller module 2300 via 2310 will retrieve a pre-determined raw signal from the matching and rectifier network BIT ROM module 2302 and via 2314 rectify it per the matching and rectifier network instruction set ROM module 2306. Once the matching and rectifier network controller module 2300 has rectified the FDFI BIT pre-determined raw signal, it will send it back to the matching and rectifier network BIT ROM module 2302 for comparison. Once the result has been determined, error or non-error, it is reported to the wavelength tunneling shield RX system controller module 820 via 2318 for an overall receive system node status. For operations where the matching and rectifier network subsystem 834 has had its matching and rectifier network BIT EEPROM module 2304 and matching and rectifier network instruction set EEPROM module 2308 reprogrammed by the wavelength tunneling shield RX system controller module 820 via 2322 and 2320, the matching and rectifier network controller module 2300 rectifies the received signal per the matching and rectifier network instruction set EEPROM module 2308 via 2316 and is sent to the power storage module 832 via 890. For FDFI operations, if the wavelength tunneling shield RX system controller module 820 via 2318 or the matching and rectifier network controller module 2300 command a FDFI BIT is needed or scheduled, the matching and rectifier network controller module 2300 via 2312 will retrieve the reprogrammed pre-determined raw signal from the matching and rectifier network BIT EEPROM module 2304 and via 2316 and rectify it per the matching and rectifier network instruction set EEPROM module 2308. Once the matching and rectifier network controller module 2300 has rectified the FDFI BIT reprogrammed pre-determined raw signal, it will send it back to the matching and rectifier network BIT EEPROM module 2304 for comparison. Once the result has been determined, error or non-error, it is reported to the wavelength tunneling shield RX system controller module 820 via 2318 for an overall receive system node status.

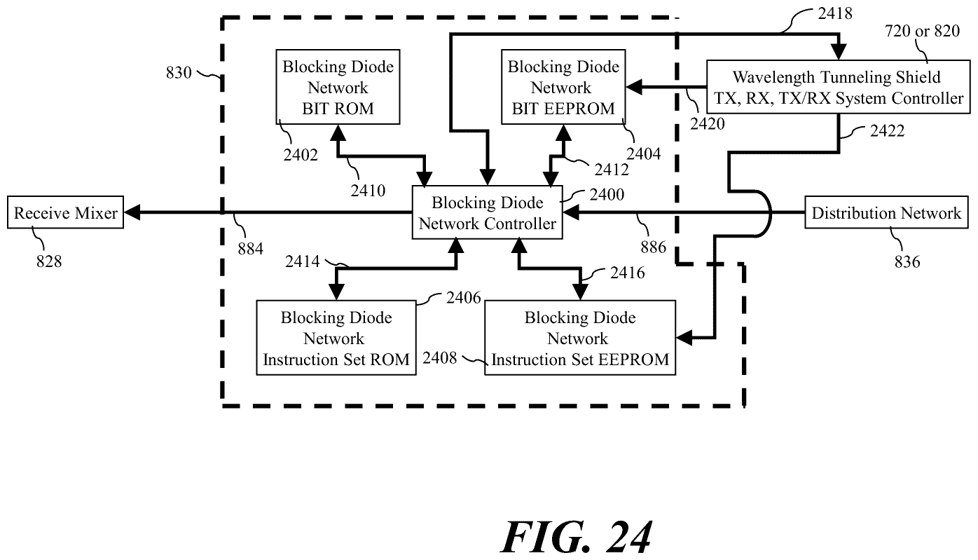

FIG. 24 illustrates, at a further lower level, the internal data/information/control flows and various functional subsystem interactions of the receive apparatus' Blocking Diode Network subsystem 830. The Blocking Diode Network subsystem 830 of FIG. 24 includes: blocking diode network controller module 2400, a blocking diode network BIT ROM module 2402, a blocking diode network BIT EEPROM module 2404, a blocking diode network instruction set ROM module 2406, and a blocking diode network instruction set EEPROM module 2408. The blocking diode network subsystem 830 interfaces with receive mixer module 828 via 884, the distribution network module 836 via 886, and the wavelength tunneling shield RX system controller module 820 via 2418. For operations where no blocking diode network instruction set ROM module 2406 reprogramming actions have taken place since initial blocking diode network subsystem 830 creation, the blocking diode network controller module 2400 provides blocking services to the receive mixer module 828 per the blocking diode network instruction set ROM module 2406 via 2414. For FDFI operations, if the wavelength tunneling shield RX system controller module 820 via 2418 or the blocking diode network controller module 2400 command a FDFI BIT is needed or scheduled, the blocking diode network controller module 2400 via 2410 will retrieve a pre-determined raw signal from the blocking diode network BIT ROM module 2402 and via 2414 block it per the blocking diode network instruction set ROM module 2406. Once the blocking diode network controller module 2400 has blocked the FDFI BIT pre-determined raw signal, it will send it back to the blocking diode network BIT ROM module 2402 for comparison. Once the result has been determined, error or non-error, it is reported to the wavelength tunneling shield RX system controller module 820 via 2418 for an overall receive system node status. For operations where the blocking diode network subsystem 830 has had its blocking diode network BIT EEPROM module 2404 and blocking diode network instruction set EEPROM module 2408 reprogrammed by the wavelength tunneling shield RX system controller module 820 via 2422 and 2420, the blocking diode network controller module 2400 blocks the received signal per the blocking diode network instruction set EEPROM module 2408 via 2416 and is sent to the receive mixer module 828 via 884. For FDFI operations, if the wavelength tunneling shield RX system controller module 820 via 2418 or the blocking diode network controller module 2400 command a FDFI BIT is needed or scheduled, the blocking diode network controller module 2400 via 2412 will retrieve the reprogrammed pre-determined raw signal from the blocking diode network BIT EEPROM module 2404 and via 2416 and block it per the blocking diode network instruction set EEPROM module 2408. Once the blocking diode network controller module 2400 has blocked the FDFI BIT reprogrammed pre-determined raw signal, it will send it back to the blocking diode network BIT EEPROM module 2404 for comparison. Once the result has been determined, error or non-error, it is reported to the wavelength tunneling shield RX system controller module 820 via 2418 for an overall receive system node status.

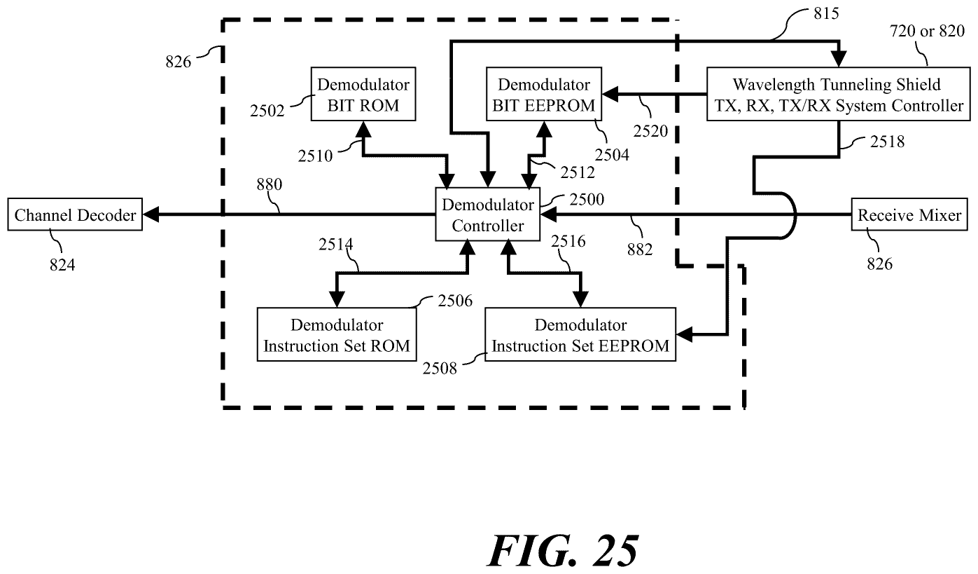

FIG. 25 illustrates, at a further lower level, the internal data/information/control flows and various functional subsystem interactions of the receive apparatus' Demodulator subsystem 826. The Demodulator subsystem 826 of FIG. 25 includes: demodulator controller module 2500, a demodulator BIT ROM module 2502, a demodulator BIT EEPROM module 2504, a demodulator instruction set ROM module 2506, and a demodulator instruction set EEPROM module 2508. The demodulator subsystem 826 interfaces with the channel decoder module 824 via 880, the receive mixer module 826 via 882, and the wavelength tunneling shield RX system controller module 820 via 815. For operations where no demodulator instruction set ROM module 2506 reprogramming actions have taken place since initial demodulator subsystem 826 creation, the demodulator controller module 2500 provides demodulation services to the channel decoder module 824 per the demodulator instruction set ROM module 2506 via 2514. For FDFI operations, if the wavelength tunneling shield RX system controller module 820 via 815 or the demodulator controller module 2500 command a FDFI BIT is needed or scheduled, the demodulator controller module 2500 via 2510 will retrieve a pre-determined raw signal from the demodulator BIT ROM module 2502 and via 2514 demodulate it per the demodulator instruction set ROM module 2506. Once the demodulator controller module 2500 has demodulated the FDFI BIT pre-determined raw signal, it will send it back to the demodulator BIT ROM module 2502 for comparison. Once the result has been determined, error or non-error, it is reported to the wavelength tunneling shield RX system controller module 820 via 815 for an overall receive system node status. For operations where the demodulator subsystem 826 has had its demodulator BIT EEPROM module 2504 and demodulator instruction set EEPROM module 2508 reprogrammed by the wavelength tunneling shield RX system controller module 820 via 2518 and 2520, the demodulator controller module 2500 demodulates the received signal per the demodulator instruction set EEPROM module 2508 via 2516 and is sent to the channel decoder module 824 via 880. For FDFI operations, if the wavelength tunneling shield RX system controller module 820 via 815 or the demodulator controller module 2500 command a FDFI BIT is needed or scheduled, the demodulator controller module 2500 via 2512 will retrieve the reprogrammed pre-determined raw signal from the demodulator BIT EEPROM module 2504 and via 2516 and demodulate it per the demodulator instruction set EEPROM module 2508. Once the demodulator controller module 2500 has demodulated the FDFI BIT reprogrammed pre-determined raw signal, it will send it back to the demodulator BIT EEPROM module 2504 for comparison. Once the result has been determined, error or non-error, it is reported to the wavelength tunneling shield RX system controller module 820 via 815 for an overall receive system node status.

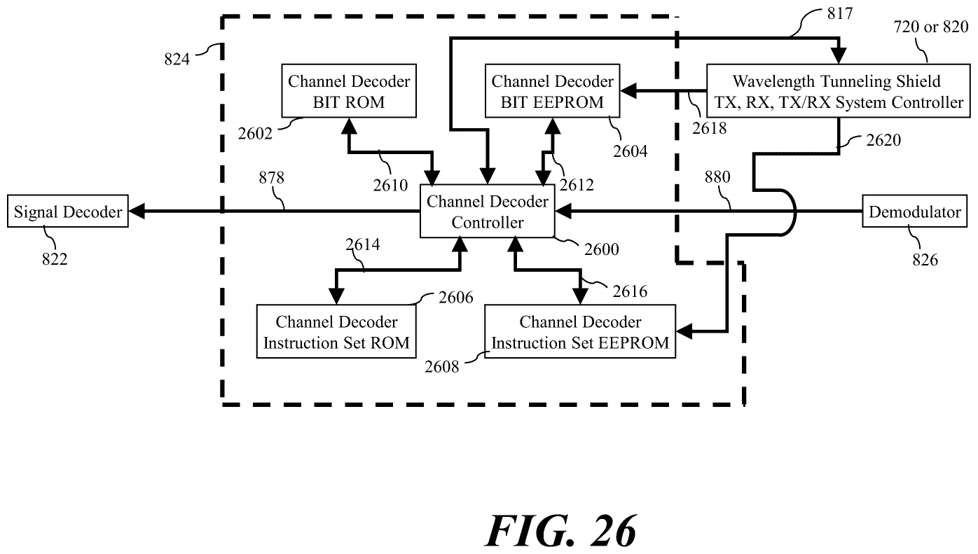

FIG. 26 illustrates, at a further lower level, the internal data/information/control flows and various functional subsystem interactions of the receive apparatus' Channel Decoder subsystem 824. The Channel Decoder subsystem 824 of FIG. 26 includes: channel decoder controller module 2600, a channel decoder BIT ROM module 2602, a channel decoder BIT EEPROM module 2604, a channel decoder instruction set ROM module 2606, and a channel decoder instruction set EEPROM module 2608. The channel decoder subsystem 824 interfaces with the signal decoder module 822 via 878, the demodulator module 826 via 880, and the wavelength tunneling shield RX system controller module 820 via 817. For operations where no channel decoder instruction set ROM module 2606 reprogramming actions have taken place since initial channel decoder subsystem 824 creation, the channel decoder controller module 2600 provides channel decoder services to the signal decoder module 822 per the channel decoder instruction set ROM module 2606 via 2614. For FDFI operations, if the wavelength tunneling shield RX system controller module 820 via 817 or the channel decoder controller module 2600 command a FDFI BIT is needed or scheduled, the channel decoder controller module 2600 via 2610 will retrieve a pre-determined raw signal from the channel decoder BIT ROM module 2602 and via 2614 decode it per the channel decoder instruction set ROM module 2606. Once the channel decoder controller module 2600 has decoded the FDFI BIT pre-determined raw signal, it will send it back to the channel decoder BIT ROM module 2602 for comparison. Once the result has been determined, error or non-error, it is reported to the wavelength tunneling shield RX system controller module 820 via 817 for an overall receive system node status. For operations where the channel decoder subsystem 824 has had its channel decoder BIT EEPROM module 2604 and channel decoder instruction set EEPROM module 2608 reprogrammed by the wavelength tunneling shield RX system controller module 820 via 2620 and 2618, the channel decoder controller module 2600 decodes the received signal per the channel decoder instruction set EEPROM module 2608 via 2616 and is sent to the signal decoder module 822 via 878. For FDFI operations, if the wavelength tunneling shield RX system controller module 820 via 817 or the channel decoder controller module 2600 command a FDFI BIT is needed or scheduled, the channel decoder controller module 2600 via 2612 will retrieve the reprogrammed pre-determined raw signal from the channel decoder BIT EEPROM module 2604 and via 2616 and decode it per the channel decoder instruction set EEPROM module 2608. Once the channel decoder controller module 2600 has decoded the FDFI BIT reprogrammed pre-determined raw signal, it will send it back to the channel decoder BIT EEPROM module 2604 for comparison. Once the result has been determined, error or non-error, it is reported to the wavelength tunneling shield RX system controller module 820 via 817 for an overall receive system node status.

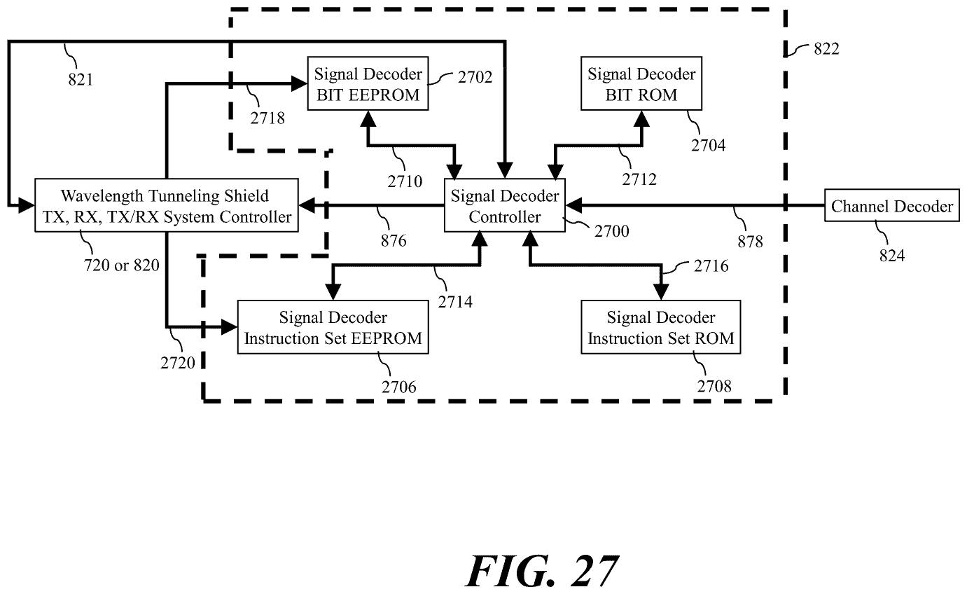

FIG. 27 illustrates, at a further lower level, the internal data/information/control flows and various functional subsystem interactions of the receive apparatus' Signal Decoder subsystem 822. The Signal Decoder subsystem 822 of FIG. 27 includes: signal decoder controller module 2700, a signal decoder BIT ROM module 2704, a signal decoder BIT EEPROM module 2702, a signal decoder instruction set ROM module 2708, and a signal decoder instruction set EEPROM module 2706. The signal decoder subsystem 822 interfaces with the wavelength tunneling shield RX system controller module 820 via 876 and the channel encoder module 824 via 878. For operations where no signal decoder instruction set ROM module 2708 reprogramming actions have taken place since initial signal decoder subsystem 822 creation, the signal decoder controller module 2700 provides signal decoder services to the wavelength tunneling shield RX system controller module 820 per the signal decoder instruction set ROM module 2708 via 2716. For FDFI operations, if the wavelength tunneling shield RX system controller module 820 via 821 or the signal decoder controller module 2700 command a FDFI BIT is needed or scheduled, the signal decoder controller module 2700 via 2712 will retrieve a pre-determined raw signal from the signal decoder BIT ROM module 2704 and via 2716 decode it per the signal decoder instruction set ROM module 2708. Once the signal decoder controller module 2700 has decoded the FDFI BIT pre-determined raw signal, it will send it back to the signal decoder BIT ROM module 2704 for comparison. Once the result has been determined, error or non-error, it is reported to the wavelength tunneling shield RX system controller module 820 via 821 for an overall receive system node status. For operations where the signal decoder subsystem 822 has had its signal decoder BIT EEPROM module 2702 and signal decoder instruction set EEPROM module 2706 reprogrammed by the wavelength tunneling shield RX system controller module 820 via 2820 and 2718, the signal decoder controller module 2700 encode the received signal per the signal decoder instruction set EEPROM module 2706 via 2714 and is sent to the wavelength tunneling shield RX system controller module 820 via 876. For FDFI operations, if the wavelength tunneling shield RX system controller module 820 via 821 or the signal decoder controller module 2700 command a FDFI BIT is needed or scheduled, the signal decoder controller module 2700 via 2710 will retrieve the reprogrammed pre-determined raw signal from the signal decoder BIT EEPROM module 2702 and via 2714 and decode it per the signal decoder instruction set EEPROM module 2706. Once the signal decoder controller module 2700 has decoded the FDFI BIT reprogrammed pre-determined raw signal, it will send it back to the signal decoder BIT EEPROM module 2702 for comparison. Once the result has been determined, error or non-error, it is reported to the wavelength tunneling shield RX system controller module 820 via 821 for an overall receive system node status.

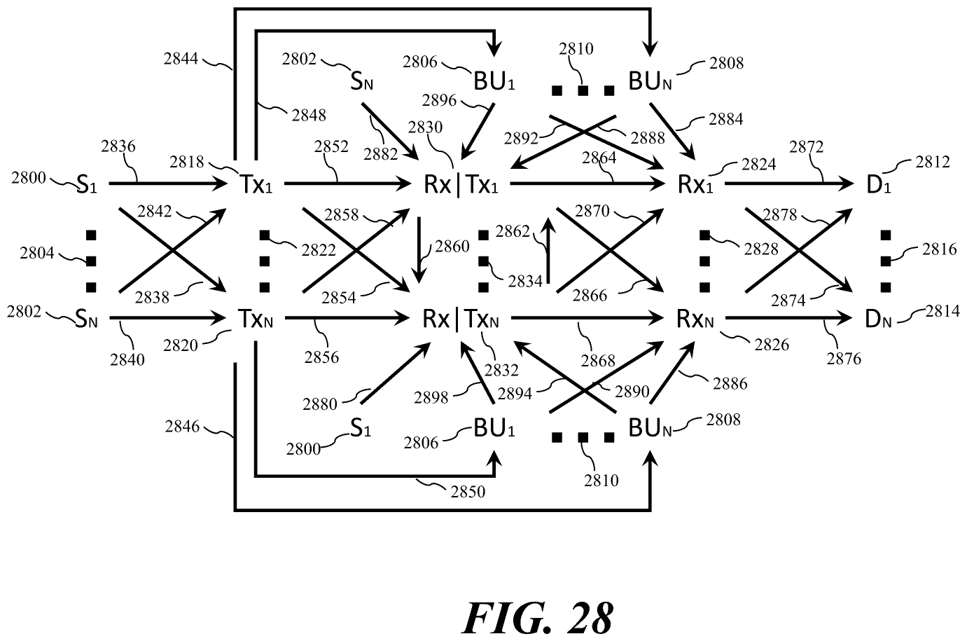

FIG. 28 illustrates the flexibility of a transmit-only and receive-only configurations in terms of one-to-one, one-to-many, many-to-one, and many-to-many connections between each of the apparatuses. As shown in this example, external inputs into a transmit-only and receive-only configurations include: a single signal-of-interest source 2800, an arbitrary number of multiple signal-of-interest sources 2802, or any number of signal-of-interest sources in between 2800 and 2802 denoted by 2804; a single backup link 2806, an arbitrary number of multiple backup links 2808, or any number of backup links in between 2806 and 2808 denoted by 2810. External outputs from a transmit-only and receive-only configurations include: a single backup link 2806, an arbitrary number of multiple backup links 2808, or any number of backup links in between 2806 and 2808 denoted by 2810; a single signal-of-interest destination 2812, an arbitrary number of multiple signal-of-interest destinations 2814, or any number of signal-of-interest destinations in between 2812 and 2814 denoted by 2816. Within FIG. 28: a single apparatus in the transmit-only configuration is denoted as 2818, an arbitrary number of multiple apparatuses in the transmit-only configuration is denoted as 2820, and any number of apparatuses in the transmit-only configuration in between 2818 and 2820 is denoted by 2822; a single apparatus in the receive-only configuration is denoted as 2824, an arbitrary number of multiple apparatuses in the receive-only configuration is denoted as 2826, and any number of apparatuses in the receive-only configuration in between 2824 and 2826 is denoted by 2828; a single apparatus in the transmit-only configuration paired with an apparatus in the receive-only configuration creating a signal-of-interest repeater is denoted as 2830, an arbitrary number of multiple apparatuses in the transmit-only configuration paired with multiple apparatuses in the receive-only configuration creating signal-of-interest repeaters are denoted as 2832, and any number of apparatuses in the transmit-only and receive-only configuration paired together in between 2830 and 2832 is denoted by 2834. Illustrating a flexibility, a single apparatus in the transmit-only configuration 2818 is capable of accepting inputs from a single signal-of-interest source 2800 via 2836 and an arbitrary number of multiple signal-of-interest sources 2802 via 2842. A single apparatus in the transmit-only configuration 2818 is capable of interfacing outputs with: a single backup link 2806 via 2848, an arbitrary number of multiple backup links 2808 via 2844, a single apparatus in the receive-only configuration 2824, an arbitrary number of multiple apparatuses in the receive-only configuration 2826, a single apparatus in the transmit-only configuration paired with an apparatus in the receive-only configuration creating a signal-of-interest repeater 2830 via 2852, and an arbitrary number of multiple apparatuses in the transmit-only configuration paired with multiple apparatuses in the receive-only configuration creating signal-of-interest repeaters 2832 via 2854. An arbitrary number of multiple apparatuses in the transmit-only configuration 2820 are capable of accepting inputs from a single signal-of-interest source 2800 via 2838 and an arbitrary number of multiple signal-of-interest sources 2802 via 2840. An arbitrary number of multiple apparatuses in the transmit-only configuration 2820 are capable of interfacing outputs with: a single backup link 2806 via 2850, an arbitrary number of multiple backup links 2808 via 2846, a single apparatus in the receive-only configuration 2824, an arbitrary number of multiple apparatuses in the receive-only configuration 2826, a single apparatus in the transmit-only configuration paired with an apparatus in the receive-only configuration creating a signal-of-interest repeater 2830 via 2858, and an arbitrary number of multiple apparatuses in the transmit-only configuration paired with multiple apparatuses in the receive-only configuration creating signal-of-interest repeaters 2832 via 2856. A single apparatus in the transmit-only configuration paired with an apparatus in the receive-only configuration creating a signal-of-interest repeater 2830 is capable of accepting inputs from: a single signal-of-interest source 2800, an arbitrary number of multiple signal-of-interest sources 2802 via 2882, a single backup link 2806 via 2896, an arbitrary number of multiple backup links 2808 via 2888, a single apparatus in the transmit-only configuration 2818 via 2852, an arbitrary number of multiple apparatuses in the transmit-only configuration 2820 via 2858, and an arbitrary number of multiple apparatuses in the transmit-only configuration paired with multiple apparatuses in the receive-only configuration creating signal-of-interest repeaters 2832 via 2862. A single apparatus in the transmit-only configuration paired with an apparatus in the receive-only configuration creating a signal-of-interest repeater 2830 is capable of interfacing outputs with: a single apparatus in the receive-only configuration 2824 via 2864, an arbitrary number of multiple apparatuses in the receive-only configuration 2826 via 2866, and an arbitrary number of multiple apparatuses in the transmit-only configuration paired with multiple apparatuses in the receive-only configuration creating signal-of-interest repeaters 2832 via 2860. An arbitrary number of multiple apparatuses in the transmit-only configuration paired with multiple apparatuses in the receive-only configuration creating signal-of-interest repeaters 2832 is capable of accepting inputs from: a single signal-of-interest source 2800 via 2880, an arbitrary number of multiple signal-of-interest sources 2802, a single backup link 2806 via 2898, an arbitrary number of multiple backup links 2808 via 2894, a single apparatus in the transmit-only configuration 2818 via 2854, an arbitrary number of multiple apparatuses in the transmit-only configuration 2820 via 2856, and a single apparatus in the transmit-only configuration paired with an apparatus in the receive-only configuration creating a signal-of-interest repeater 2830 vis 2860. An arbitrary number of multiple apparatuses in the transmit-only configuration paired with multiple apparatuses in the receive-only configuration creating signal-of-interest repeaters 2832 is capable of interfacing outputs with: a single apparatus in the receive-only configuration 2824 via 2870, an arbitrary number of multiple apparatuses in the receive-only configuration 2826 via 2868, and a single apparatus in the transmit-only configuration paired with an apparatus in the receive-only configuration creating a signal-of-interest repeater 2830 via 2862. A single apparatus in the receive-only configuration 2824 is capable of accepting inputs from: a single apparatus in the transmit-only configuration 2818, an arbitrary number of multiple apparatuses in the transmit-only configuration 2820, a single backup link 2806 via 2892, an arbitrary number of multiple backup links 2808 via 2884, a single apparatus in the transmit-only configuration paired with an apparatus in the receive-only configuration creating a signal-of-interest repeater 2830 via 2864, and an arbitrary number of multiple apparatuses in the transmit-only configuration paired with multiple apparatuses in the receive-only configuration creating signal-of-interest repeaters 2832 via 2870. A single apparatus in the receive-only configuration 2824 is capable of interfacing outputs with: a single signal-of-interest destination 2812 via 2872 and an arbitrary number of multiple signal-of-interest destinations 2814 via 2874. An arbitrary number of multiple apparatuses in the receive-only configuration 2826 are capable of accepting inputs from: a single apparatus in the transmit-only configuration 2818, an arbitrary number of multiple apparatuses in the transmit-only configuration 2820, a single backup link 2806 via 2890, an arbitrary number of multiple backup links 2808 via 2886, a single apparatus in the transmit-only configuration paired with an apparatus in the receive-only configuration creating a signal-of-interest repeater 2830 via 2866, and an arbitrary number of multiple apparatuses in the transmit-only configuration paired with multiple apparatuses in the receive-only configuration creating signal-of-interest repeaters 2832 via 2868. An arbitrary number of multiple apparatuses in the receive-only configuration 2826 are capable of interfacing outputs with: a single signal-of-interest destination 2812 via 2878 and an arbitrary number of multiple signal-of-interest destinations 2814 via 2876.

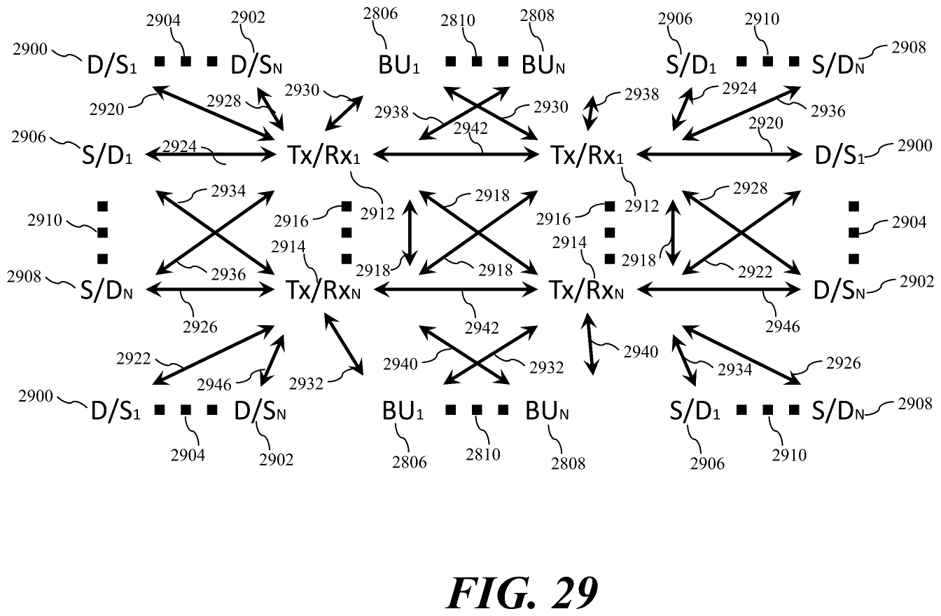

FIG. 29 illustrates the flexibility of a transmit-receive configurations in terms of one-to-one, one-to-many, many-to-one, and many-to-many connections between each of the apparatuses. As shown in this example, external inputs into a transmit-receive configurations include: a single signal-of-interest source 2906, an arbitrary number of multiple signal-of-interest sources 2908, or any number of signal-of-interest sources in between 2906 and 2908 denoted by 2910; a single backup link 2806, an arbitrary number of multiple backup links 2808, or any number of backup links in between 2806 and 2808 denoted by 2810. External outputs from a transmit-receive configurations include: a single backup link 2806, an arbitrary number of multiple backup links 2808, or any number of backup links in between 2806 and 2808 denoted by 2810; a single signal-of-interest destination 2900, an arbitrary number of multiple signal-of-interest destinations 2902, or any number of signal-of-interest destinations in between 2900 and 2902 denoted by 2904. Within FIG. 29: a single apparatus in the transmit-receive configuration is denoted as 2912, an arbitrary number of multiple apparatuses in the transmit-receive configuration is denoted as 2914, and any number of apparatuses in the transmit-receive configuration in between 2912 and 2914 is denoted by 2916. Illustrating a flexibility, a single apparatus in the transmit-receive configuration 2912 is capable of accepting inputs from and interfacing outputs with: a single signal-of-interest source 2906 via 2924, an arbitrary number of multiple signal-of-interest sources 2908 via 2936, a single backup link 2806 via 2930, an arbitrary number of multiple backup links 2808 via 2938, a single signal-of-interest destination 2900 via 2920, an arbitrary number of multiple signal-of-interest destinations 2902 via 2928, a single apparatus in the transmit-receive configuration 2912 via 2942, and an arbitrary number of multiple apparatuses in the transmit-receive configuration 2914 via 2918. An arbitrary number of multiple apparatuses in the transmit-receive configuration 2914 is capable of accepting inputs from and interfacing outputs with: a single signal-of-interest source 2906 via 2934, an arbitrary number of multiple signal-of-interest sources 2908 via 2926, a single backup link 2806 via 2932, an arbitrary number of multiple backup links 2808 via 2940, a single signal-of-interest destination 2900 via 2922, an arbitrary number of multiple signal-of-interest destinations 2902 via 2946, a single apparatus in the transmit-receive configuration 2912 via 2918, and an arbitrary number of multiple apparatuses in the transmit-receive configuration 2914 via 2942.

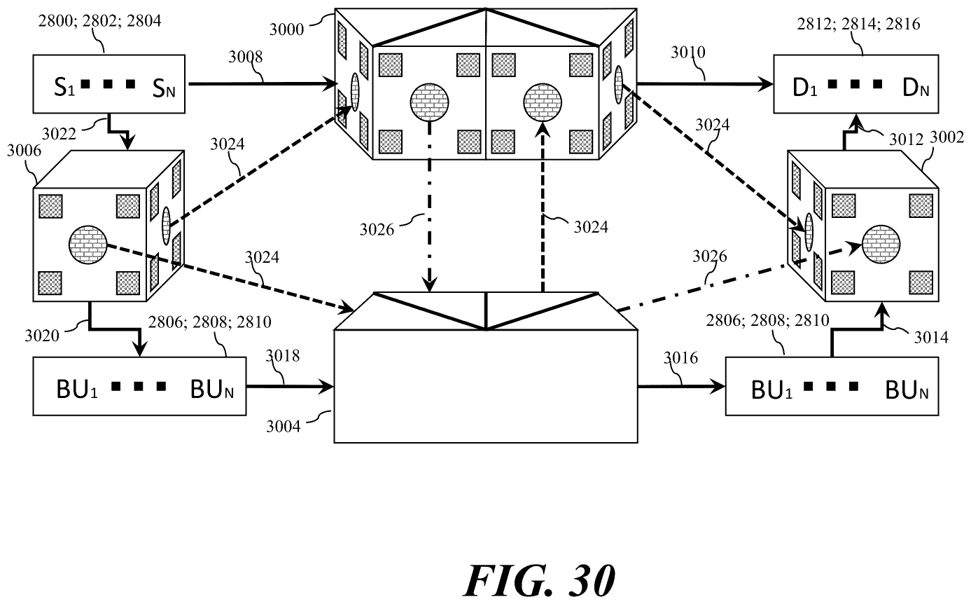

FIG. 30 illustrates the flexibility of a transmit-only and receive-only configurations in terms of single aperture transmit to single aperture receive with different signal stream simultaneously. As shown in this example, there exists a network containing: a single apparatus in the transmit-only configuration 3006, a single apparatus in the receive-only configuration 3002, and two apparatuses in the transmit-only configuration paired with two apparatuses in the receive-only configuration creating signal-of-interest repeaters 3000 and 3004. External inputs into the network include: (1) a single signal-of-interest source 2800, an arbitrary number of multiple signal-of-interest sources 2802, or any number of signal-of-interest sources in between 2800 and 2802 denoted by 2804 interfaced with a single apparatus in the transmit-only configuration 3006 via 3022 as well as interfaced with a single apparatus in the transmit-only configuration paired with an apparatus in the receive-only configuration creating a signal-of-interest repeater 3000 via 3008; and (2) a single backup link 2806, an arbitrary number of multiple backup links 2808, or any number of backup links in between 2806 and 2808 denoted by 2810 interfaced with a single apparatus in the transmit-only configuration paired with an apparatus in the receive-only configuration creating a signal-of-interest repeater 3004 via 3018 as well as interfaced with a single apparatus in the receive-only configuration 3002 via 3014. External outputs from the network include: (1) a single backup link 2806, an arbitrary number of multiple backup links 2808, or any number of backup links in between 2806 and 2808 denoted by 2810 from a single apparatus in the transmit-only configuration 3006 via 3020; (2) a single backup link 2806, an arbitrary number of multiple backup links 2808, or any number of backup links in between 2806 and 2808 denoted by 2810 from a single apparatus in the transmit-only configuration paired with an apparatus in the receive-only configuration creating a signal-of-interest repeater 3004 via 3016; and (3) a single signal-of-interest destination 2812, an arbitrary number of multiple signal-of-interest destinations 2814, or any number of signal-of-interest destinations in between 2812 and 2814 denoted by 2816 from a single apparatus in the transmit-only configuration paired with an apparatus in the receive-only configuration creating a signal-of-interest repeater 3000 via 3010 as well as from single apparatus in the receive-only configuration 3002 via 3012. The multiple external network inputs and outputs provide redundancy across the network to ensure the signal-of-interest arrives at its destination. The single apparatus in the transmit-only configuration 3006 receives the signal-of-interest to be transmitted via 3022 and routes it three separate ways simultaneously: to a single apparatus in the transmit-only configuration paired with an apparatus in the receive-only configuration creating a signal-of-interest repeater 3000 via 3024, to a single apparatus in the transmit-only configuration paired with an apparatus in the receive-only configuration creating a signal-of-interest repeater 3004 via 3024; and to the networks external backup links via 3020. The single apparatus in the transmit-only configuration paired with an apparatus in the receive-only configuration creating a signal-of-interest repeater 3000 receives multiple signals-of-interest via 3024 and 3008 for routing to a single apparatus in the transmit-only configuration paired with an apparatus in the receive-only configuration creating a signal-of-interest repeater 3004 via 3026 from 3008 and to a single apparatus in the receive-only configuration 3002 via 3024. The single apparatus in the transmit-only configuration paired with an apparatus in the receive-only configuration creating a signal-of-interest repeater 3004 receives multiple signals-of-interest via 3024 and 3018 for routing to a single apparatus in the transmit-only configuration paired with an apparatus in the receive-only configuration creating a signal-of-interest repeater 3000 via 3024 and to a single apparatus in the receive-only configuration 3002 via 3026 from 3000. FIG. 30 illustrates an ability of the apparatus to transmit and receive multiple signals-of-interest simultaneously as well as an ability to interface with multiple external signal-of-interest sources, signal-of-interest destinations, and backup links to ensure delivery redundancy.

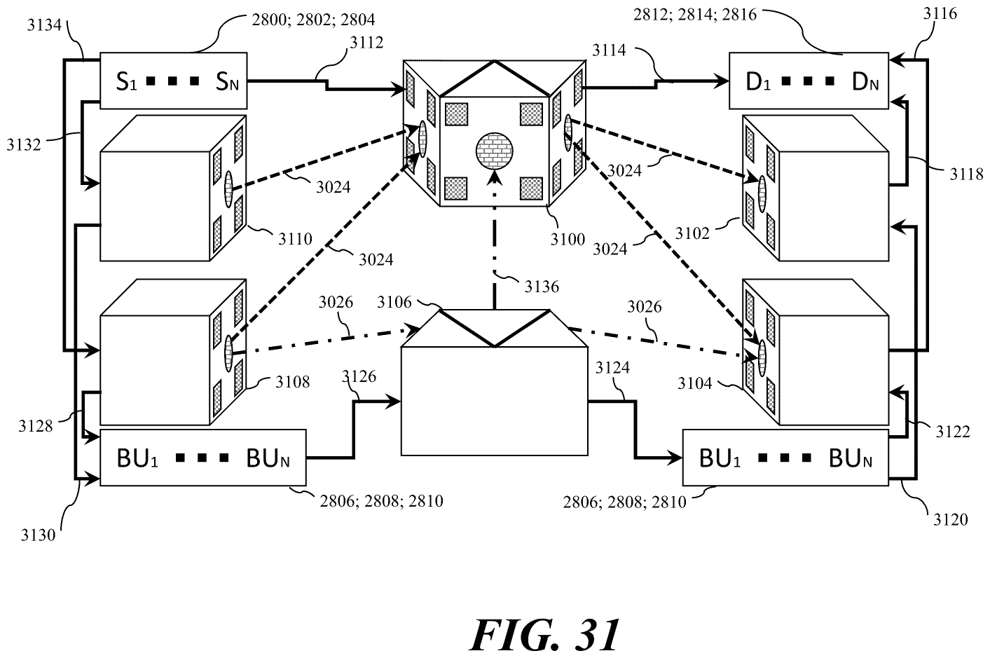

FIG. 31 illustrates the flexibility of a transmit-only and receive-only configurations in terms of: single aperture transmit to multiple aperture receive, multiple aperture transmit to single aperture receive, and multiple aperture transmit to multiple aperture receive with different signal stream simultaneously. As shown in this example, there exists a network containing: two single apparatuses in the transmit-only configuration 3110 and 3108, two single apparatuses in the receive-only configuration 3102 and 3104, and two apparatuses in the transmit-only configuration paired with multiple apparatuses in the receive-only configuration creating signal-of-interest repeaters 3100 and 3106. External inputs into the network include: (1) a single signal-of-interest source 2800, an arbitrary number of multiple signal-of-interest sources 2802, or any number of signal-of-interest sources in between 2800 and 2802 denoted by 2804 interfaced with both single apparatuses in the transmit-only configuration 3110 and 3108 via 3132 and 3134 as well as interfaced with a single apparatus in the transmit-only configuration paired with multiple apparatuses in the receive-only configuration creating a signal-of-interest repeater 3100 via 3112; and (2) a single backup link 2806, an arbitrary number of multiple backup links 2808, or any number of backup links in between 2806 and 2808 denoted by 2810 interfaced with a multiple apparatuses in the transmit-only configuration paired with a single apparatus in the receive-only configuration creating a signal-of-interest repeater 3106 via 3126 as well as interfaced with both single apparatuses in the receive-only configuration 3102 and 3104 via 3122 and 3120. External outputs from the network include: (1) a single backup link 2806, an arbitrary number of multiple backup links 2808, or any number of backup links in between 2806 and 2808 denoted by 2810 from both single apparatuses in the transmit-only configuration 3110 and 3108 via 3130 and 3128; (2) a single backup link 2806, an arbitrary number of multiple backup links 2808, or any number of backup links in between 2806 and 2808 denoted by 2810 from multiple apparatuses in the transmit-only configuration paired with a single apparatus in the receive-only configuration creating a signal-of-interest repeater 3106 via 3124; and (3) a single signal-of-interest destination 2812, an arbitrary number of multiple signal-of-interest destinations 2814, or any number of signal-of-interest destinations in between 2812 and 2814 denoted by 2816 from both single apparatuses in the receive-only configuration 3102 and 3104 via 3118 and 3116 as well as interfacing with a single apparatus in the transmit-only configuration paired with multiple apparatuses in the receive-only configuration creating a signal-of-interest repeater 3100 via 3114. The multiple external network inputs and outputs provide redundancy across the network to ensure the signals-of-interest arrives at their destination. In contrast to FIG. 30 where the each of apparatuses in the transmit-only, receive-only, and paired together configurations (3000, 3002, 3004, and 3006) only transmitted to and received from single apertures, FIG. 31 depicts how: a single apparatus in the transmit-only configuration 3108 is capable of transmitting two different signals-of-interest 3024 and 3026 simultaneously from the same aperture to two different receivers 3100 and 3106, a single apparatus in the receive-only configuration 3104 is capable of receiving two different signals-of-interest 3024 and 3026 simultaneously within the same aperture from two different transmitters 3100 and 3106. FIG. 31 also depicts how additional other signals-of-interest 3136 can make use of the network without having to be routed from an initial transmitting node.

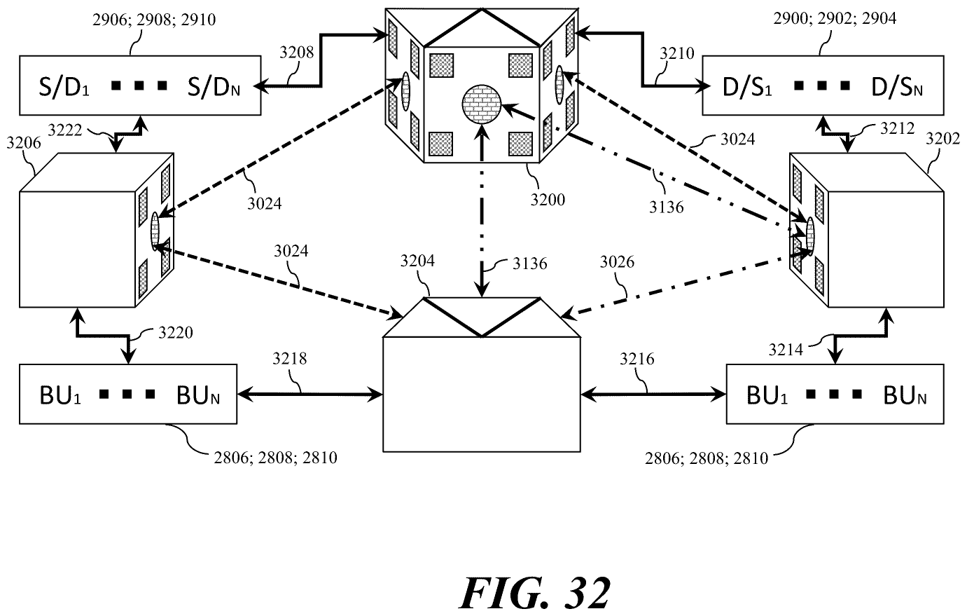

FIG. 32 illustrates the flexibility of transmit-receive configurations in terms of: single aperture transmit to single aperture receive single aperture transmit to multiple aperture receive, multiple aperture transmit to single aperture receive, and multiple aperture transmit to multiple aperture receive with different signal stream simultaneously. As shown in this example, there exists a network containing: four apparatuses in the transmit-receive configuration 3200, 3202, 3204, and 3206. External inputs into and outputs interfaced with the network include: (1) a single signal-of-interest source 2906, an arbitrary number of multiple signal-of-interest sources 2908, or any number of signal-of-interest sources in between 2906 and 2908 denoted by 2910 interfaced with two apparatuses in the transmit-receive configuration 3200 and 3206 via 3208 and 3222; (2) a single signal-of-interest destination 2900, an arbitrary number of multiple signal-of-interest destinations 2902, or any number of signal-of-interest destinations in between 2900 and 2902 denoted by 2904 interfaced with two apparatuses in the transmit-receive configuration 3200 and 3202 via 3210 and 3212; and (3) a single backup link 2806, an arbitrary number of multiple backup links 2808, or any number of backup links in between 2806 and 2808 denoted by 2810 interfaced with all four apparatuses in the transmit-receive configuration 3200, 3202, 3204, and 3206 via 3220, 3218, 3216, and 3214. Similar to FIG. 31, FIG. 32 depicts how an apparatus in the transmit-receive configuration is capable of transmitting two different signals-of-interest 3024 and 3136 simultaneously from the same aperture to two different receivers and any combination of such.

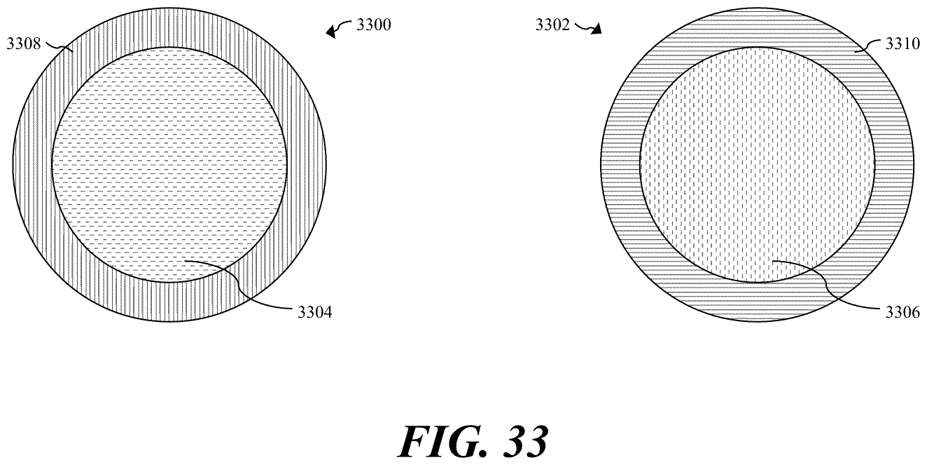

FIG. 33 illustrates, in an orthographic-front (head-on) view, a basic layout for a possible configuration of a signal-of-interest transmit-only aperture 3300 and a signal-of-interest receive-only aperture 3302 to protect a unidirectional signal-of-interest with a unidirectional signal-of-protection. A signal-of-interest transmit-only aperture 3300 consists of: a signal-of-interest transmit-only aperture 3304 and a single continuous signal-of-protection transmit-only aperture 3308. A signal-of-interest receive-only aperture 3302 consists of: a signal-of-interest receive-only aperture 3306 and a single continuous signal-of-protection receive-only aperture 3310. The unidirectional signal-of-interest is transmitted from the signal-of-interest transmit-only aperture 3304 to the signal-of-interest receive-only aperture 3306. The unidirectional signal-of-protection is transmitted from the single continuous signal-of-protection transmit-only aperture 3308 to the single continuous signal-of-protection receive-only aperture 3310 effectively surrounding the signal-of-interest within the signal-of-protection.

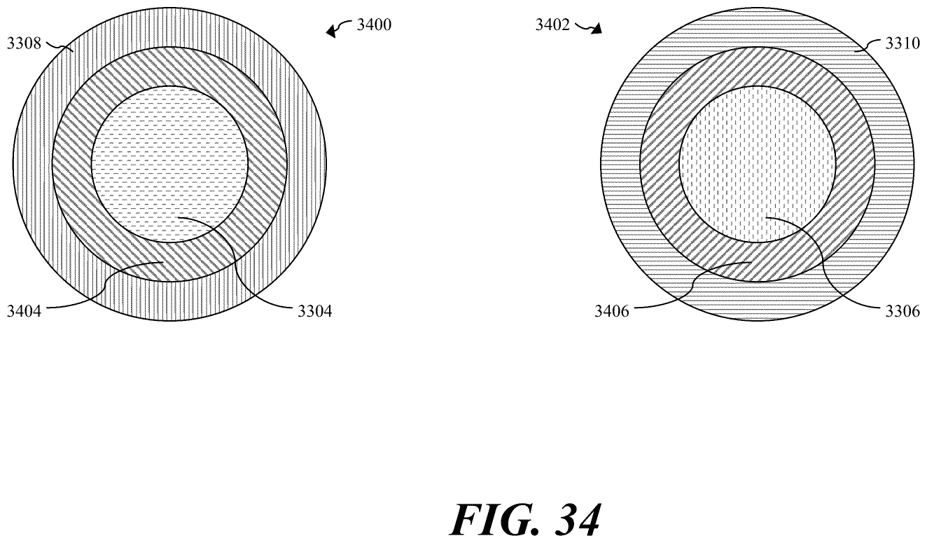

FIG. 34 illustrates, in an orthographic-front (head-on) view, a basic layout for a possible configuration of a signal-of-interest transmit-only aperture 3400 and a signal-of-interest receive-only aperture 3402 to protect a unidirectional signal-of-interest with multiple unidirectional signals-of-protection. A signal-of-interest transmit-only aperture 3400 consists of: a signal-of-interest transmit-only aperture 3304, an outer single continuous signal-of-protection transmit-only aperture 3308, and an inner single continuous signal-of-protection transmit-only aperture 3404. A signal-of-interest receive-only aperture 3402 consists of: a signal-of-interest receive-only aperture 3306, an outer single continuous signal-of-protection receive-only aperture 3310, and an inner single continuous signal-of-protection receive-only aperture 3406. The unidirectional signal-of-interest is transmitted from the signal-of-interest transmit-only aperture 3304 to the signal-of-interest receive-only aperture 3306. The outer unidirectional signal-of-protection is transmitted from the single continuous signal-of-protection transmit-only aperture 3308 to the outer single continuous signal-of-protection receive-only aperture 3310 effectively surrounding the signal-of-interest within the signal-of-protection. The inner unidirectional signal-of-protection is transmitted from the single continuous signal-of-protection transmit-only aperture 3404 to the inner single continuous signal-of-protection receive-only aperture 3406 effectively double surrounding the signal-of-interest within the signal-of-protection. The outer and inner signals-of-protection are of different types.

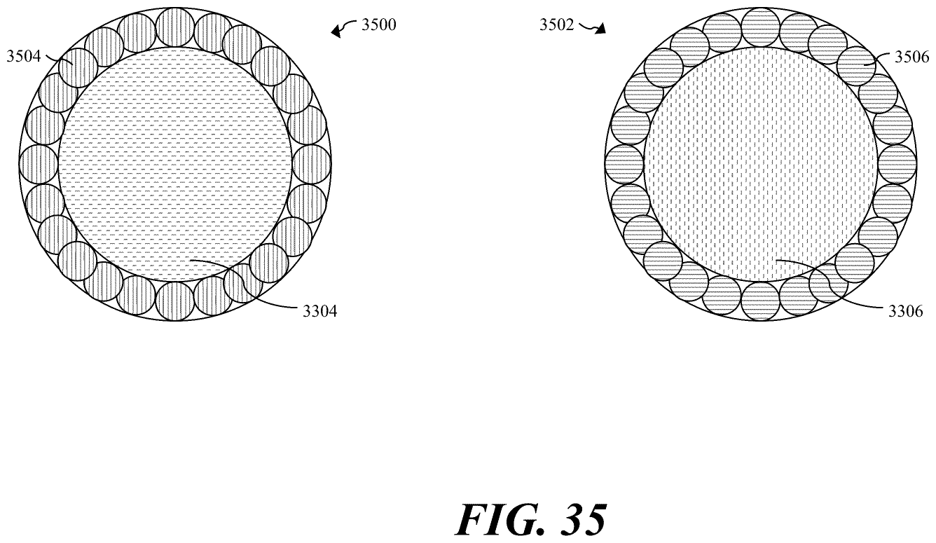

FIG. 35 illustrates, in an orthographic-front (head-on) view, a basic layout for a possible configuration of a signal-of-interest transmit-only aperture 3500 and a signal-of-interest receive-only aperture 3502 to protect a unidirectional signal-of-interest with a single set of unidirectional signals-of-protection. A signal-of-interest transmit-only aperture 3500 consists of: a signal-of-interest transmit-only aperture 3304 and a single layer of individual signal-of-protection transmit-only apertures 3504. A signal-of-interest receive-only aperture 3502 consists of: a signal-of-interest receive-only aperture 3306 and a single layer of individual signal-of-protection receive-only aperture 3506. The unidirectional signal-of-interest is transmitted from the signal-of-interest transmit-only aperture 3304 to the signal-of-interest receive-only aperture 3306. The unidirectional signal-of-protection is transmitted from the single layer of individual signal-of-protection transmit-only apertures 3504 to the single layer of individual signal-of-protection receive-only aperture 3506 effectively surrounding the signal-of-interest within the signal-of-protection.

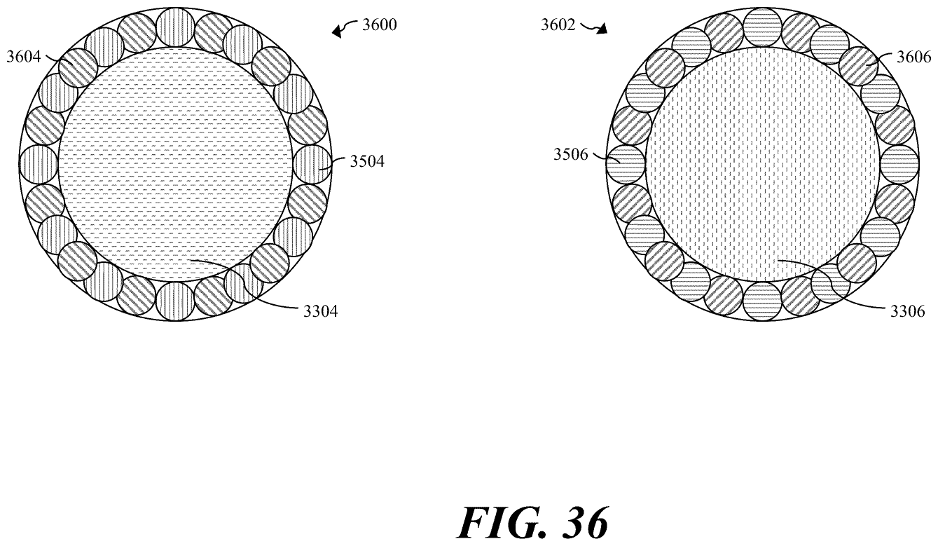

FIG. 36 illustrates, in an orthographic-front (head-on) view, a basic layout for a possible configuration of a signal-of-interest transmit-only aperture 3600 and a signal-of-interest receive-only aperture 3602 to protect a unidirectional signal-of-interest with a single set of multiple unidirectional signals-of-protection. A signal-of-interest transmit-only aperture 3600 consists of: a signal-of-interest transmit-only aperture 3304 and a single layer of multiple individual signal-of-protection transmit-only apertures 3504 and 3604. A signal-of-interest receive-only aperture 3602 consists of: a signal-of-interest receive-only aperture 3306 and a single layer of multiple individual signal-of-protection receive-only apertures 3506 and 3606. The unidirectional signal-of-interest is transmitted from the signal-of-interest transmit-only aperture 3304 to the signal-of-interest receive-only aperture 3306. The first unidirectional signal-of-protection is transmitted from the single layer of individual signal-of-protection transmit-only apertures 3504 to the single layer of individual signal-of-protection receive-only aperture 3506; the second unidirectional signal-of-protection is transmitted from the single layer of individual signal-of-protection transmit-only apertures 3604 to the single layer of individual signal-of-protection receive-only aperture 3606 effectively surrounding the signal-of-interest within an intermixed signal-of-protection.

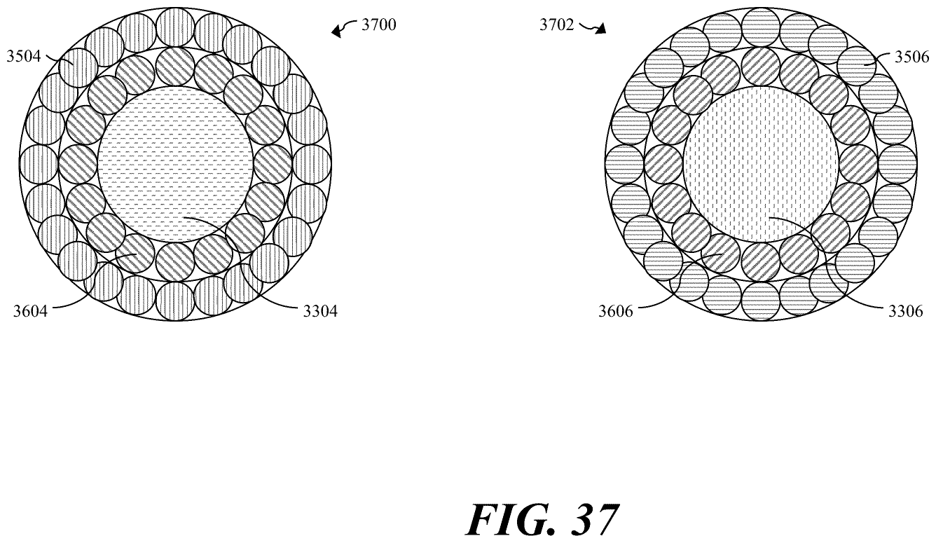

FIG. 37 illustrates, in an orthographic-front (head-on) view, a basic layout for a possible configuration of a signal-of-interest transmit-only aperture 3700 and a signal-of-interest receive-only aperture 3702 to protect a unidirectional signal-of-interest with multiple layers and types unidirectional signals-of-protection.

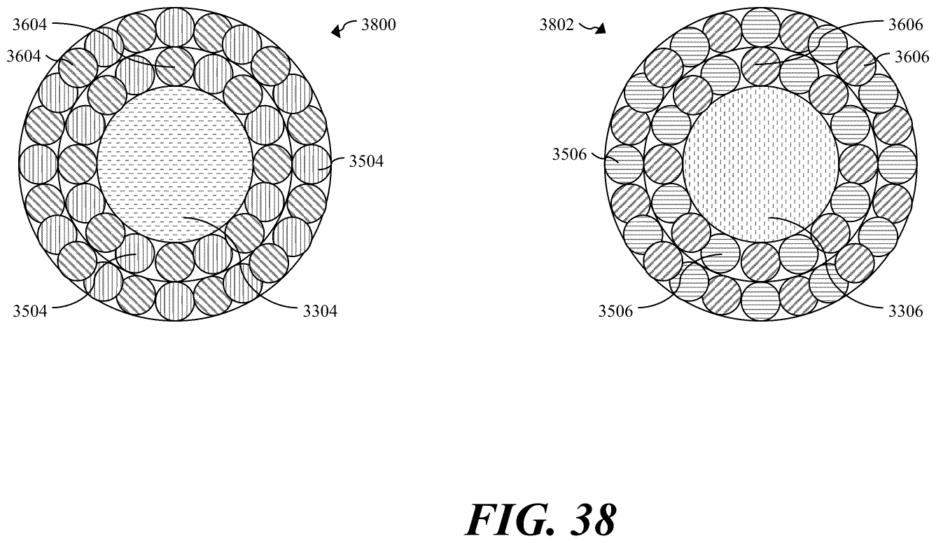

FIG. 38 illustrates, in an orthographic-front (head-on) view, a basic layout for a possible configuration of a signal-of-interest transmit-only aperture 3800 and a signal-of-interest receive-only aperture 3802 to protect a unidirectional signal-of-interest with multiple layers and types unidirectional signals-of-protection mixed together.

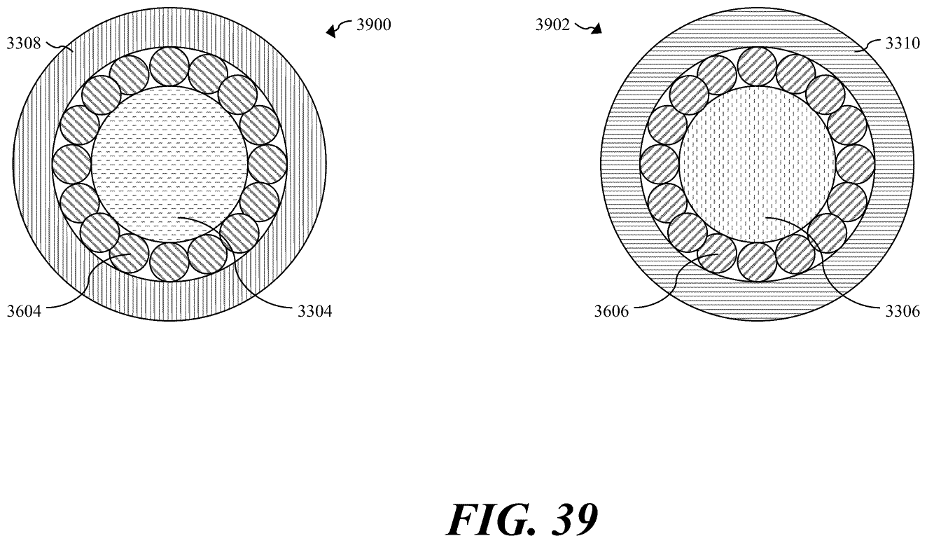

FIG. 39 illustrates, in an orthographic-front (head-on) view, a basic layout for a possible configuration of a signal-of-interest transmit-only aperture 3900 and a signal-of-interest receive-only aperture 3902 to protect a unidirectional signal-of-interest with multiple layers and types unidirectional signals-of-protection.

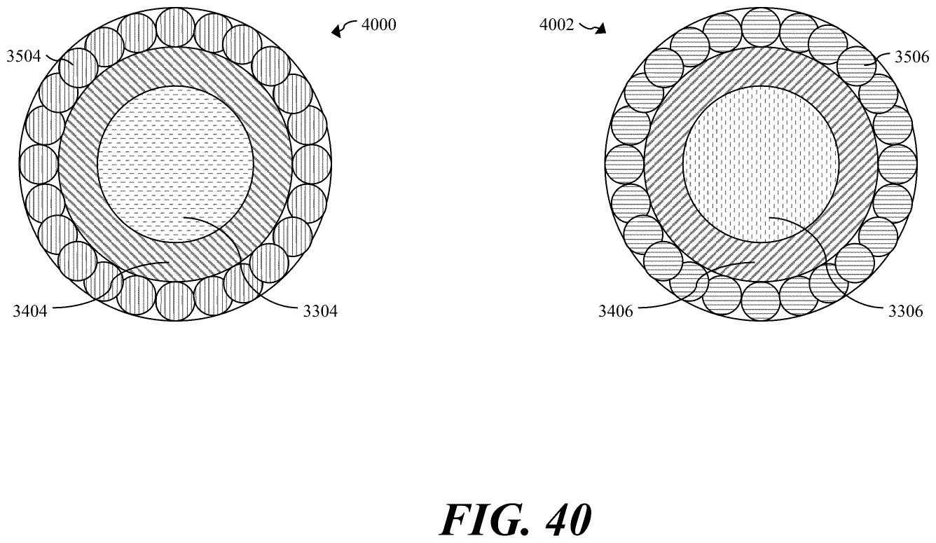

FIG. 40 illustrates, in an orthographic-front (head-on) view, a basic layout for a possible configuration of a signal-of-interest transmit-only aperture 4000 and a signal-of-interest receive-only aperture 4002 to protect a unidirectional signal-of-interest with multiple layers and types unidirectional signals-of-protection.

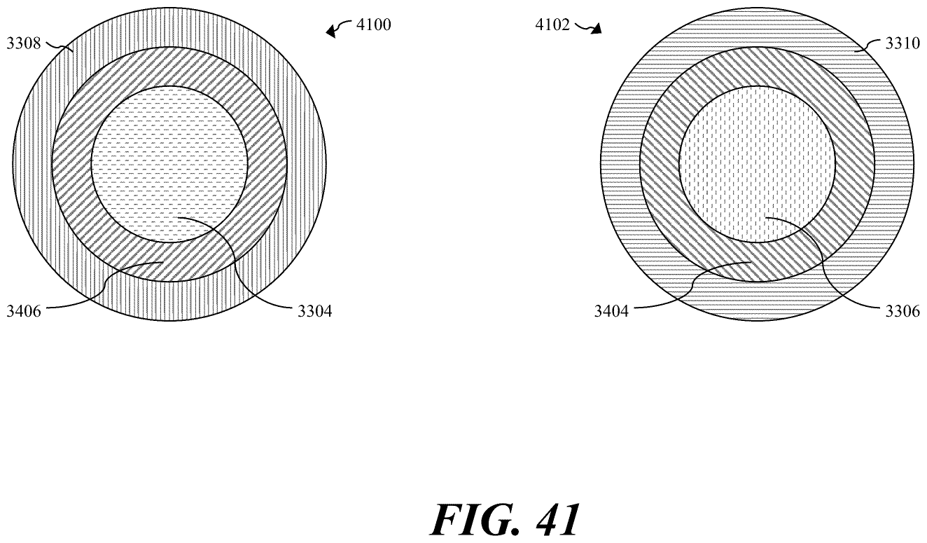

FIG. 41 illustrates, in an orthographic-front (head-on) view, a basic layout for a possible configuration of a signal-of-interest transmit-only aperture 4100 and a signal-of-interest receive-only aperture 4102 to protect a unidirectional signal-of-interest with multiple layers opposing unidirectional signals-of-protection allowing the signal-of-interest transmit-only aperture 4100 and signal-of-interest receive-only aperture 4102 to communicate or detect when the signal-of-protection has been breached.

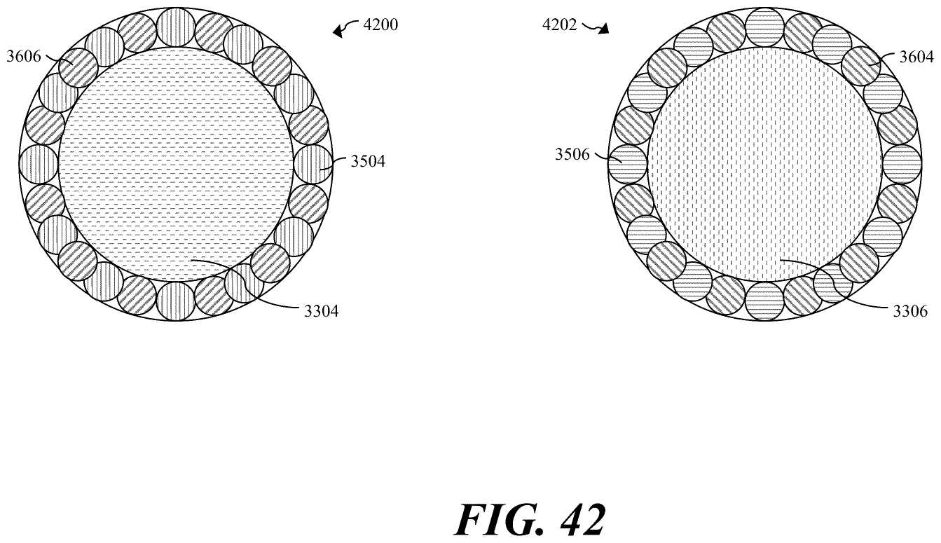

FIG. 42 illustrates, in an orthographic-front (head-on) view, a basic layout for a possible configuration of a signal-of-interest transmit-only aperture 4200 and a signal-of-interest receive-only aperture 4202 to protect a unidirectional signal-of-interest with a single layer of opposing unidirectional signals-of-protection allowing the signal-of-interest transmit-only aperture 4200 and signal-of-interest receive-only aperture 4202 to communicate or detect when the signal-of-protection has been breached.

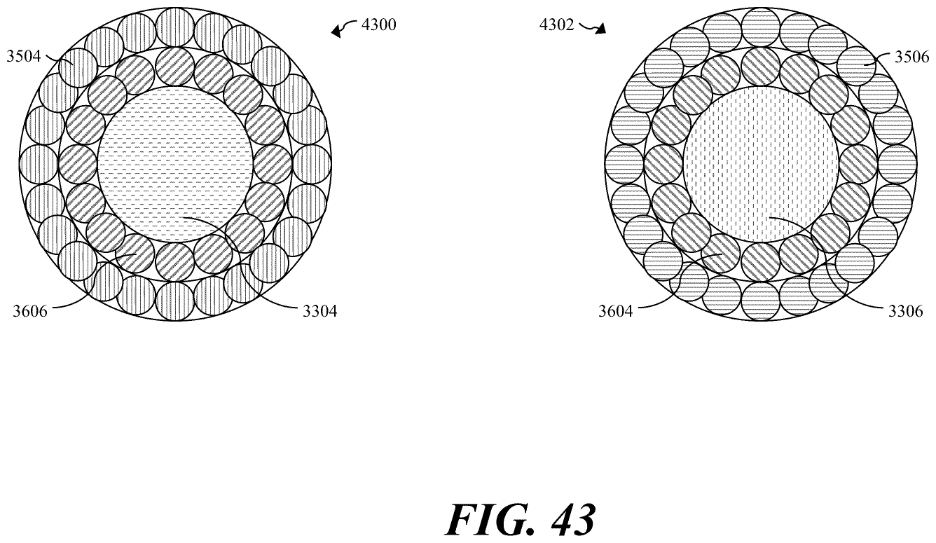

FIG. 43 illustrates, in an orthographic-front (head-on) view, a basic layout for a possible configuration of a signal-of-interest transmit-only aperture 4300 and a signal-of-interest receive-only aperture 4302 to protect a unidirectional signal-of-interest with multiple layers of opposing unidirectional signals-of-protection allowing the signal-of-interest transmit-only aperture 4300 and signal-of-interest receive-only aperture 4302 to communicate or detect when the signal-of-protection has been breached.

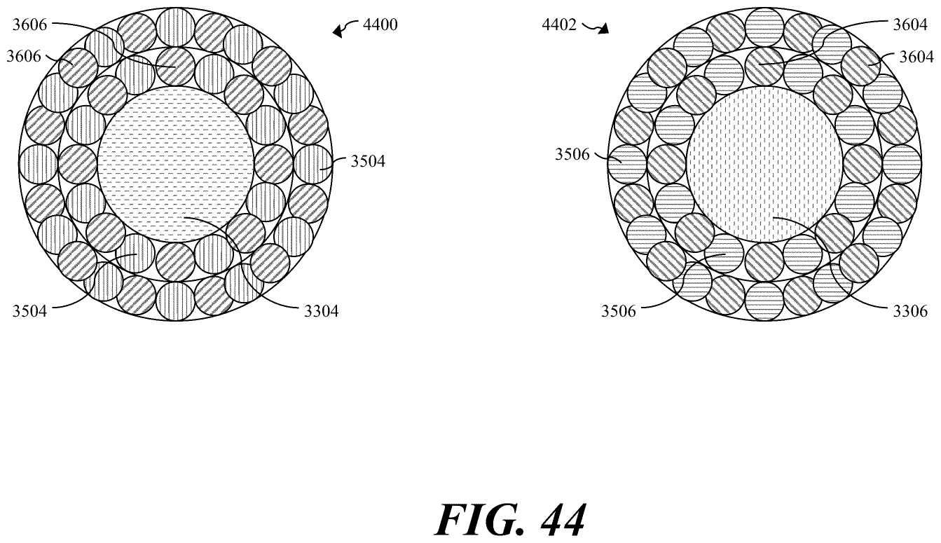

FIG. 44 illustrates, in an orthographic-front (head-on) view, a basic layout for a possible configuration of a signal-of-interest transmit-only aperture 4400 and a signal-of-interest receive-only aperture 4402 to protect a unidirectional signal-of-interest with multiple layers of intermixed opposing unidirectional signals-of-protection allowing the signal-of-interest transmit-only aperture 4400 and signal-of-interest receive-only aperture 4402 to communicate or detect when the signal-of-protection has been breached.

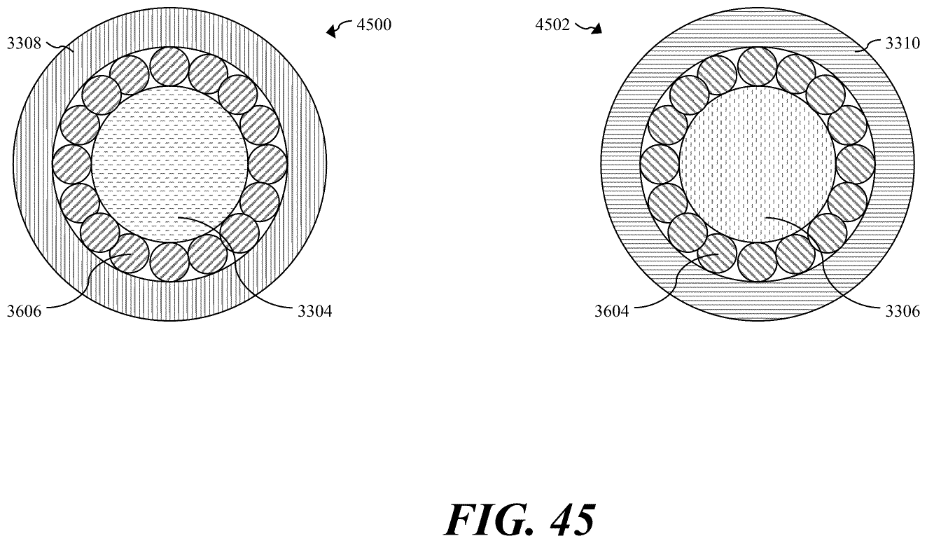

FIG. 45 illustrates, in an orthographic-front (head-on) view, a basic layout for a possible configuration of a signal-of-interest transmit-only aperture 4500 and a signal-of-interest receive-only aperture 4502 to protect a unidirectional signal-of-interest with multiple layers of opposing unidirectional signals-of-protection allowing the signal-of-interest transmit-only aperture 4500 and signal-of-interest receive-only aperture 4502 to communicate or detect when the signal-of-protection has been breached.

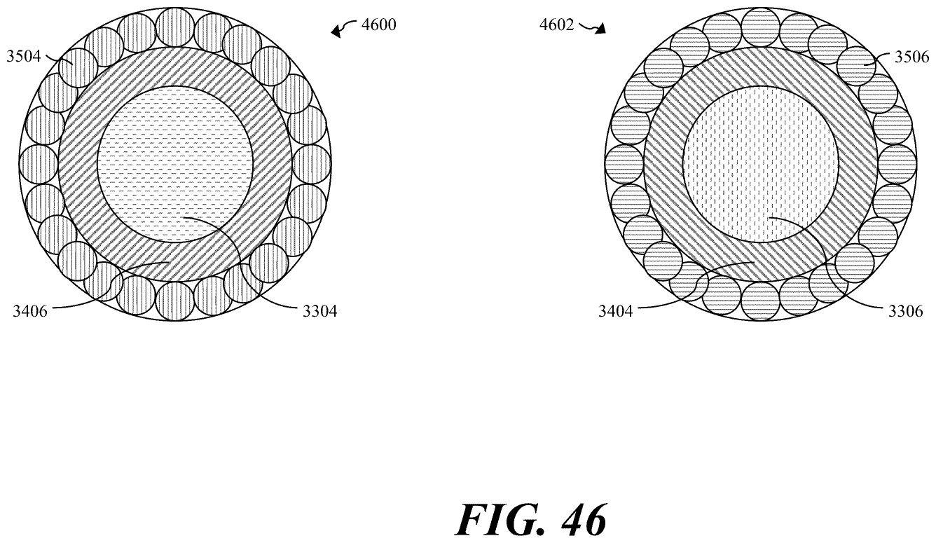

FIG. 46 illustrates, in an orthographic-front (head-on) view, a basic layout for a possible configuration of a signal-of-interest transmit-only aperture 4600 and a signal-of-interest receive-only aperture 4602 to protect a unidirectional signal-of-interest with multiple layers of opposing unidirectional signals-of-protection allowing the signal-of-interest transmit-only aperture 4600 and signal-of-interest receive-only aperture 4602 to communicate or detect when the signal-of-protection has been breached.

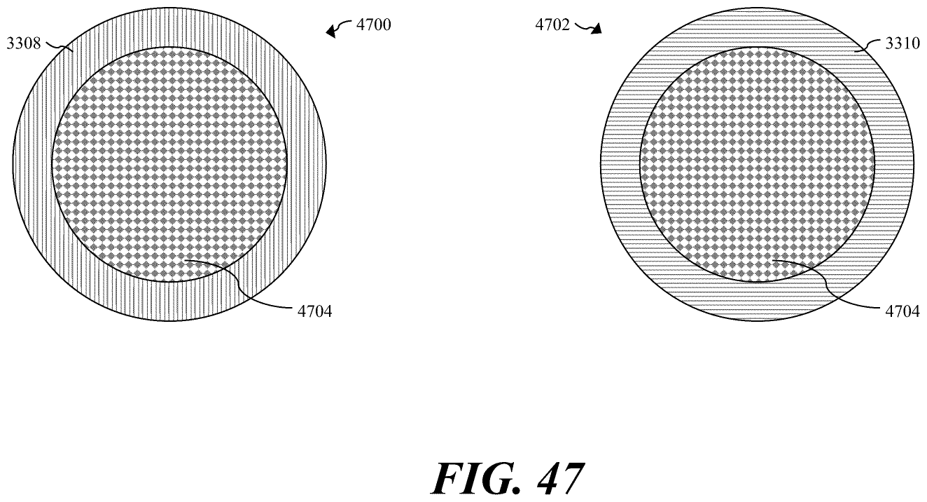

FIG. 47 illustrates, in an orthographic-front (head-on) view, a basic layout for a possible configuration of a signal-of-interest transmit-receive aperture 4700 and a signal-of-interest receive-transmit aperture 4702 to protect a bidirectional signal-of-interest with a single layer of consisting of unidirectional signal-of-protection transmitted from a single continuous signal-of-protection transmit-only aperture 3308 to a single continuous signal-of-protection receive-only aperture 3310 effectively surrounding the signal-of-interest within the signal-of-protection. In this configuration, the single unidirectional signal-of-protection does not allow for communication for signal-of-protection breach events and must rely on the bidirectional transmit-receive signal-of-interest aperture 4704 for communication between apparatus nodes.

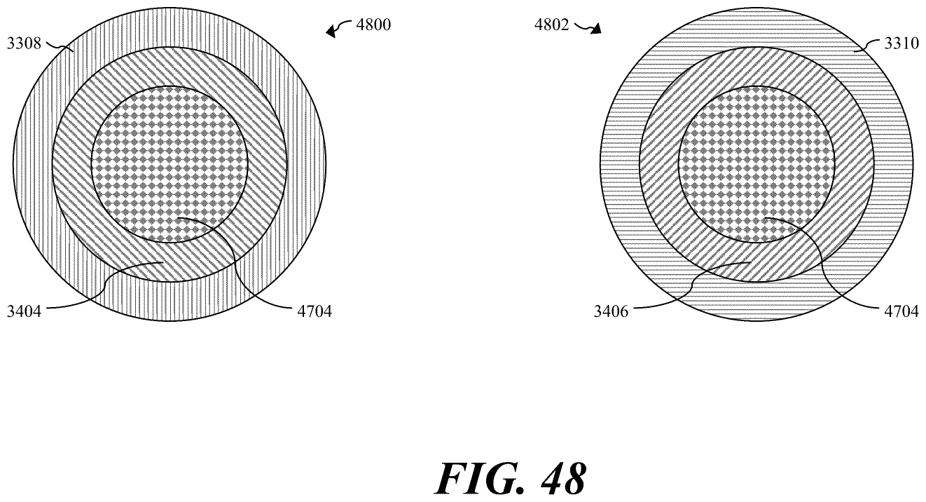

FIG. 48 illustrates, in an orthographic-front (head-on) view, a basic layout for a possible configuration of a signal-of-interest transmit-receive aperture 4800 and a signal-of-interest receive-transmit aperture 4802 to protect a bidirectional signal-of-interest multiple layers of unidirectional signals-of-protection transmitted from a single continuous signal-of-protection transmit-only aperture 3308 and 3404 to a single continuous signal-of-protection receive-only aperture 3310 and 3406 effectively surrounding the signal-of-interest within a double signal-of-protection. In this configuration, the single unidirectional signal-of-protection does not allow for communication for signal-of-protection breach events and must rely on the bidirectional transmit-receive signal-of-interest aperture 4704 for communication between apparatus nodes.

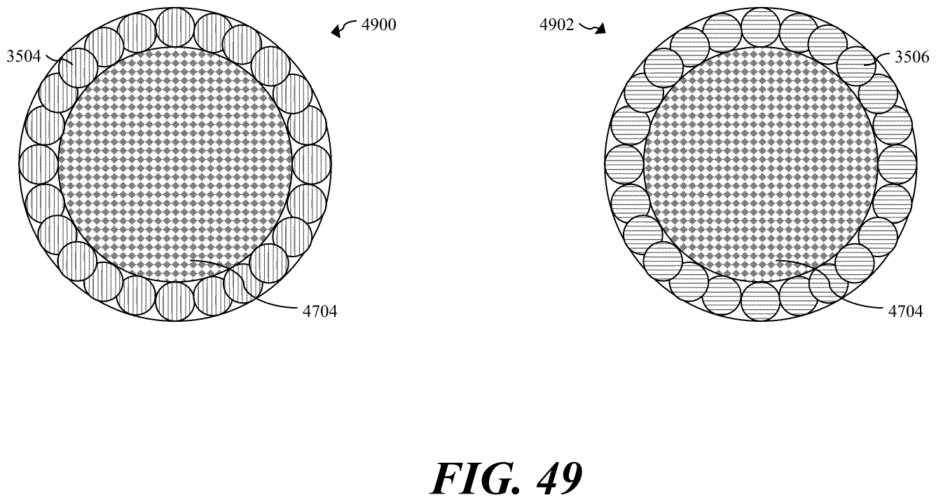

FIG. 49 illustrates, in an orthographic-front (head-on) view, a basic layout for a possible configuration of a signal-of-interest transmit-receive aperture 4900 and a signal-of-interest receive-transmit aperture 4902 to protect a bidirectional signal-of-interest with a single layer of individual unidirectional signals-of-protection transmitted from a single continuous signal-of-protection transmit-only apertures 3504 to a single layer of individual signal-of-protection receive-only apertures 3506 effectively surrounding the signal-of-interest within a signal-of-protection. In this configuration, the single unidirectional signal-of-protection does not allow for communication for signal-of-protection breach events and must rely on the bidirectional transmit-receive signal-of-interest aperture 4704 for communication between apparatus nodes.

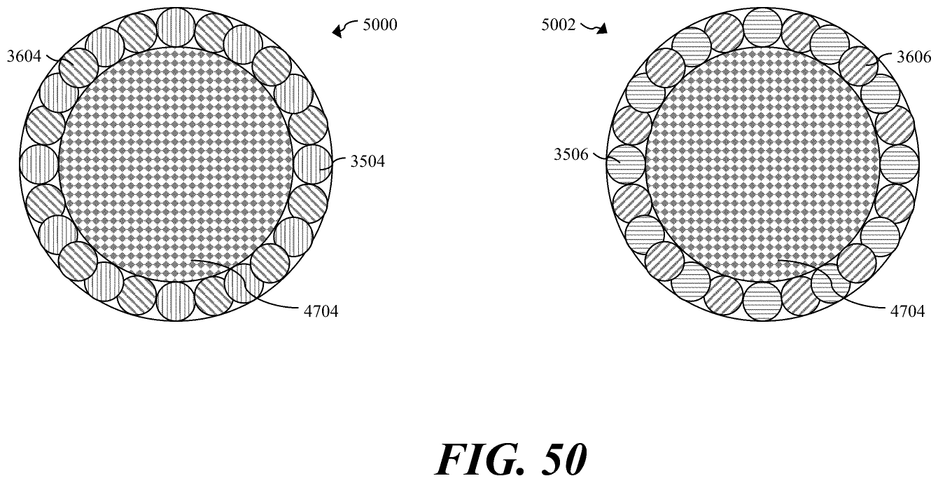

FIG. 50 illustrates, in an orthographic-front (head-on) view, a basic layout for a possible configuration of a signal-of-interest transmit-receive aperture 5000 and a signal-of-interest receive-transmit aperture 5002 to protect a bidirectional signal-of-interest with a single layer of individual unidirectional mixed signals-of-protection transmitted from a multiple signal-of-protection transmit-only apertures 3504 and 3604 to a single layer of individual signal-of-protection receive-only apertures 3506 and 3606 effectively surrounding the signal-of-interest within a mixed signal-of-protection. In this configuration, the single unidirectional signal-of-protection does not allow for communication for signal-of-protection breach events and must rely on the bidirectional transmit-receive signal-of-interest aperture 4704 for communication between apparatus nodes.

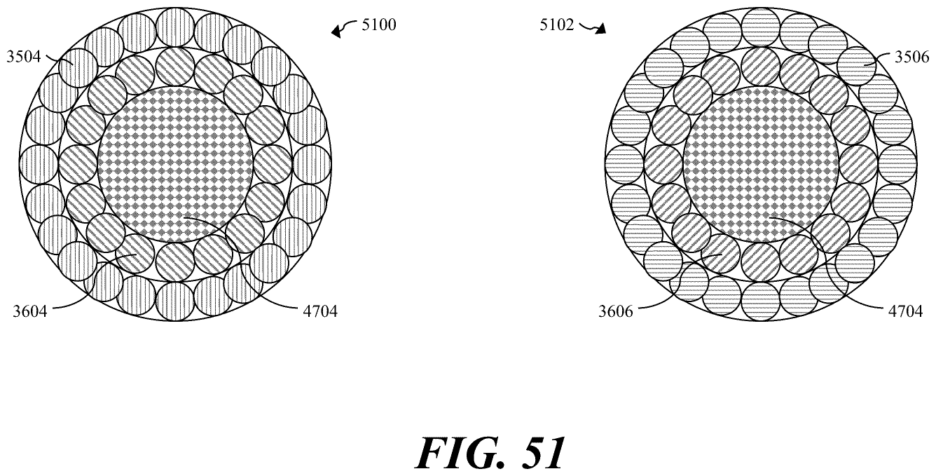

FIG. 51 illustrates, in an orthographic-front (head-on) view, a basic layout for a possible configuration of a signal-of-interest transmit-receive aperture 5100 and a signal-of-interest receive-transmit aperture 5102 to protect a bidirectional signal-of-interest with multiple layers of individual unidirectional signals-of-protection transmitted from a multiple signal-of-protection transmit-only apertures to multiple layers of individual signal-of-protection receive-only apertures effectively surrounding the signal-of-interest within a signal-of-protection. In this configuration, the single unidirectional signal-of-protection does not allow for communication for signal-of-protection breach events and must rely on the bidirectional transmit-receive signal-of-interest aperture 4704 for communication between apparatus nodes.

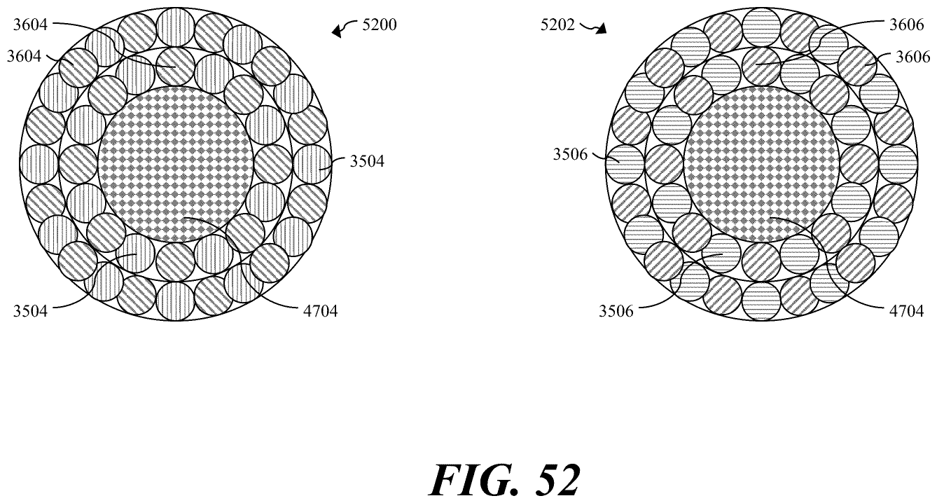

FIG. 52 illustrates, in an orthographic-front (head-on) view, a basic layout for a possible configuration of a signal-of-interest transmit-receive aperture 5200 and a signal-of-interest receive-transmit aperture 5202 to protect a bidirectional signal-of-interest with multiple layers of individual unidirectional signals-of-protection transmitted from a multiple signal-of-protection transmit-only apertures to multiple layers of individual signal-of-protection receive-only apertures effectively surrounding the signal-of-interest within a signal-of-protection. In this configuration, the single unidirectional signal-of-protection does not allow for communication for signal-of-protection breach events and must rely on the bidirectional transmit-receive signal-of-interest aperture 4704 for communication between apparatus nodes.

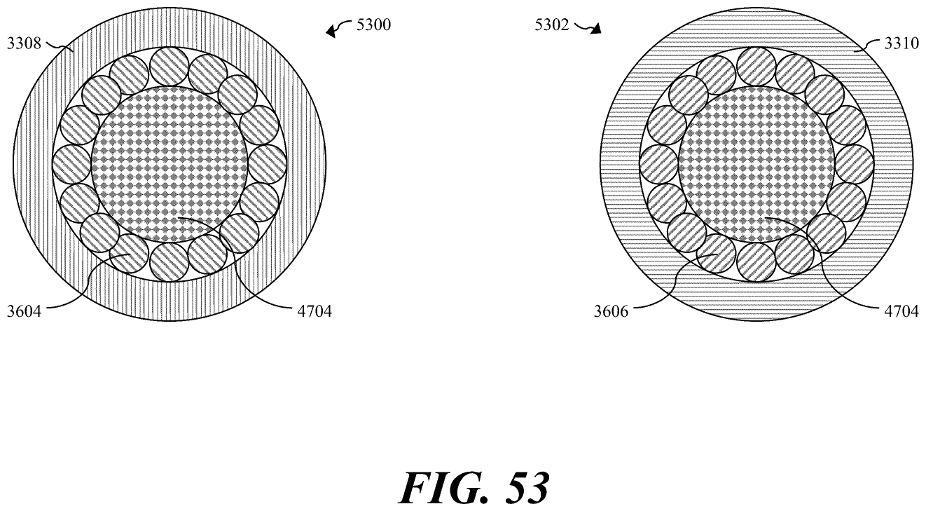

FIG. 53 illustrates, in an orthographic-front (head-on) view, a basic layout for a possible configuration of a signal-of-interest transmit-receive aperture 5300 and a signal-of-interest receive-transmit aperture 5302 to protect a bidirectional signal-of-interest with multiple layers of individual unidirectional signals-of-protection transmitted from a multiple signal-of-protection transmit-only apertures to multiple layers of individual signal-of-protection receive-only apertures effectively surrounding the signal-of-interest within a signal-of-protection. In this configuration, the single unidirectional signal-of-protection does not allow for communication for signal-of-protection breach events and must rely on the bidirectional transmit-receive signal-of-interest aperture 4704 for communication between apparatus nodes.

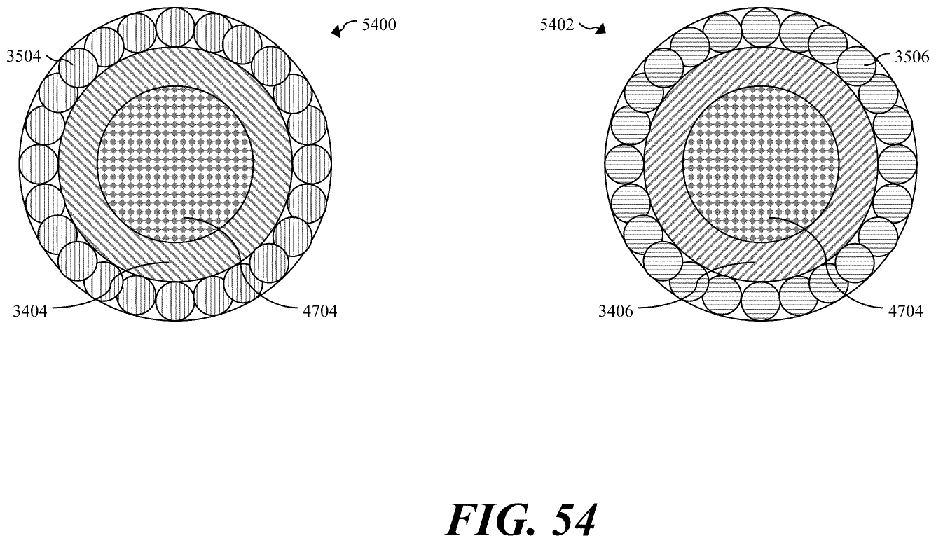

FIG. 54 illustrates, in an orthographic-front (head-on) view, a basic layout for a possible configuration of a signal-of-interest transmit-receive aperture 5400 and a signal-of-interest receive-transmit aperture 5402 to protect a bidirectional signal-of-interest with multiple layers of individual unidirectional signals-of-protection transmitted from a multiple signal-of-protection transmit-only apertures to multiple layers of individual signal-of-protection receive-only apertures effectively surrounding the signal-of-interest within a signal-of-protection. In this configuration, the single unidirectional signal-of-protection does not allow for communication for signal-of-protection breach events and must rely on the bidirectional transmit-receive signal-of-interest aperture 4704 for communication between apparatus nodes.

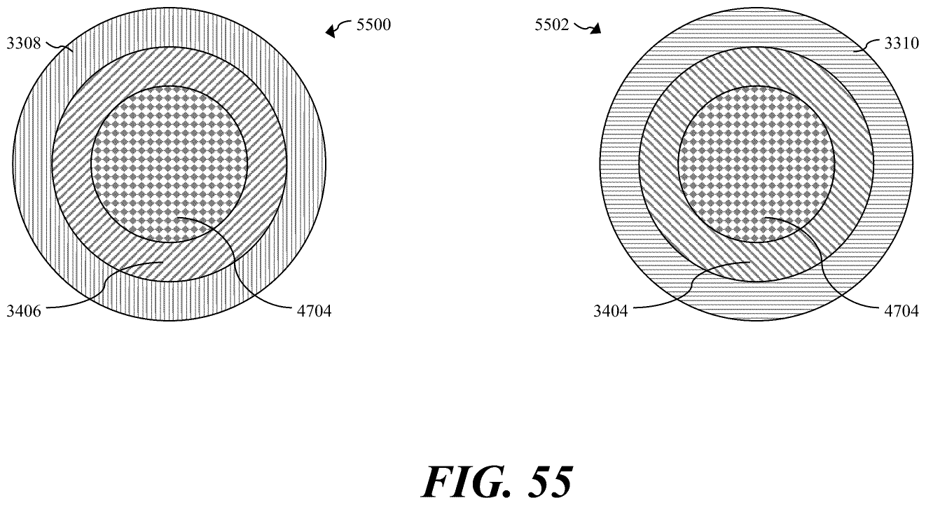

FIG. 55 illustrates, in an orthographic-front (head-on) view, a basic layout for a possible configuration of a signal-of-interest transmit-receive aperture 5500 and a signal-of-interest receive-transmit aperture 5502 to protect a bidirectional signal-of-interest with multiple layers of opposing unidirectional signals-of-protection allowing the signal-of-interest transmit-only aperture 5500 and signal-of-interest receive-only aperture 5502 to communicate or detect when the signal-of-protection has been breached.

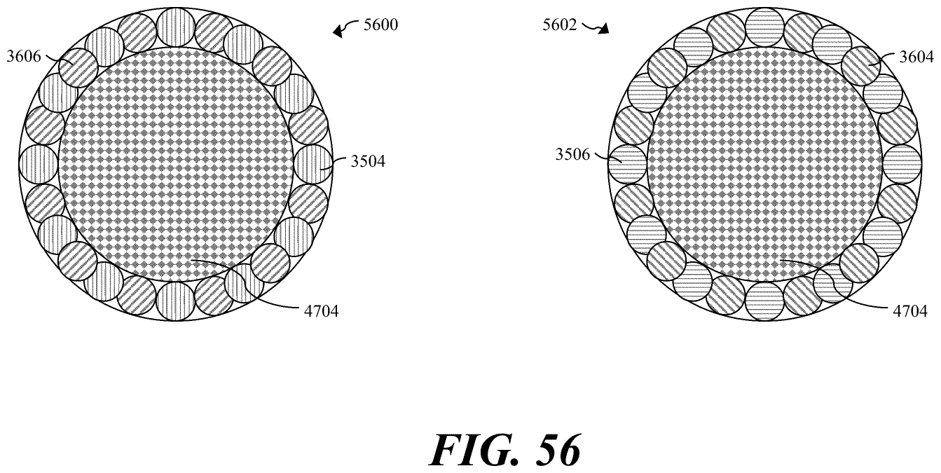

FIG. 56 illustrates, in an orthographic-front (head-on) view, a basic layout for a possible configuration of a signal-of-interest transmit-receive aperture 5600 and a signal-of-interest receive-transmit aperture 5602 to protect a bidirectional signal-of-interest with a single layer of opposing unidirectional signals-of-protection allowing the signal-of-interest transmit-only aperture 5600 and signal-of-interest receive-only aperture 5602 to communicate or detect when the signal-of-protection has been breached.

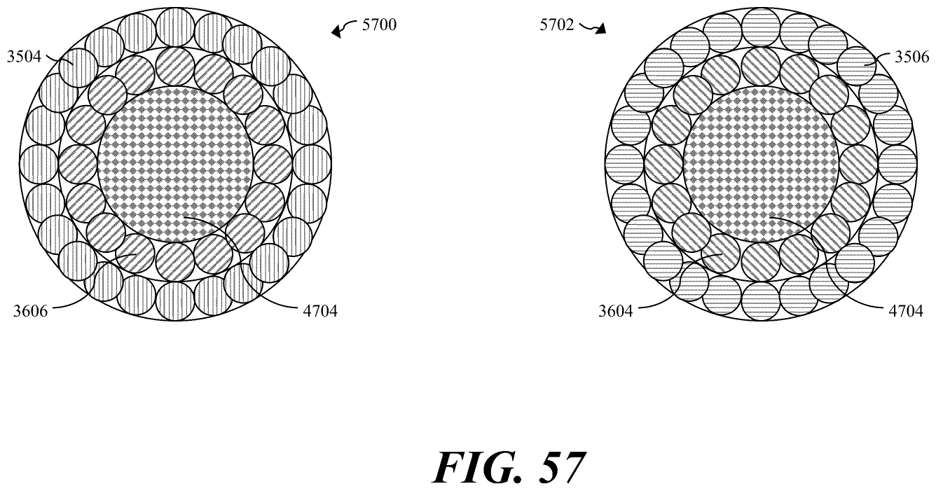

FIG. 57 illustrates, in an orthographic-front (head-on) view, a basic layout for a possible configuration of a signal-of-interest transmit-receive aperture 5700 and a signal-of-interest receive-transmit aperture 5702 to protect a bidirectional signal-of-interest with multiple layers of opposing unidirectional signals-of-protection allowing the signal-of-interest transmit-only aperture 5700 and signal-of-interest receive-only aperture 5702 to communicate or detect when the signal-of-protection has been breached.

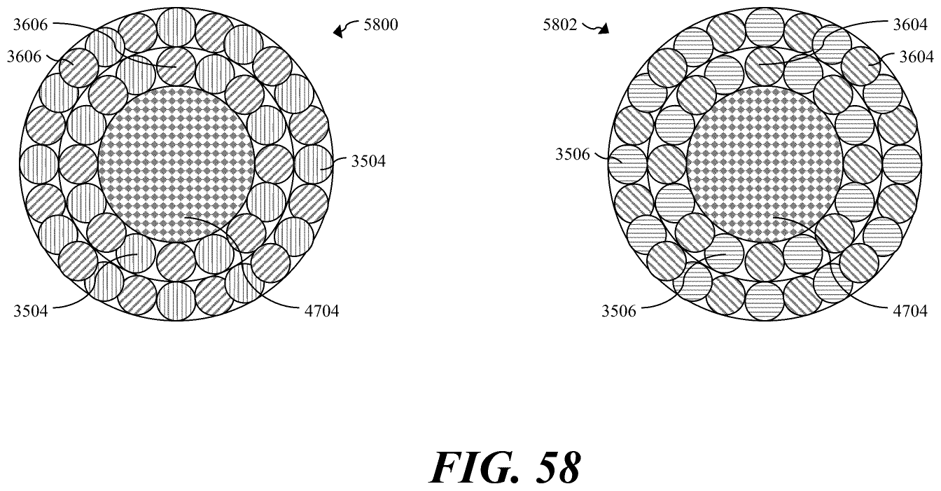

FIG. 58 illustrates, in an orthographic-front (head-on) view, a basic layout for a possible configuration of a signal-of-interest transmit-receive aperture 5800 and a signal-of-interest receive-transmit aperture 5802 to protect a bidirectional signal-of-interest with multiple layers of opposing mixed unidirectional signals-of-protection allowing the signal-of-interest transmit-only aperture 5800 and signal-of-interest receive-only aperture 5802 to communicate or detect when the signal-of-protection has been breached.

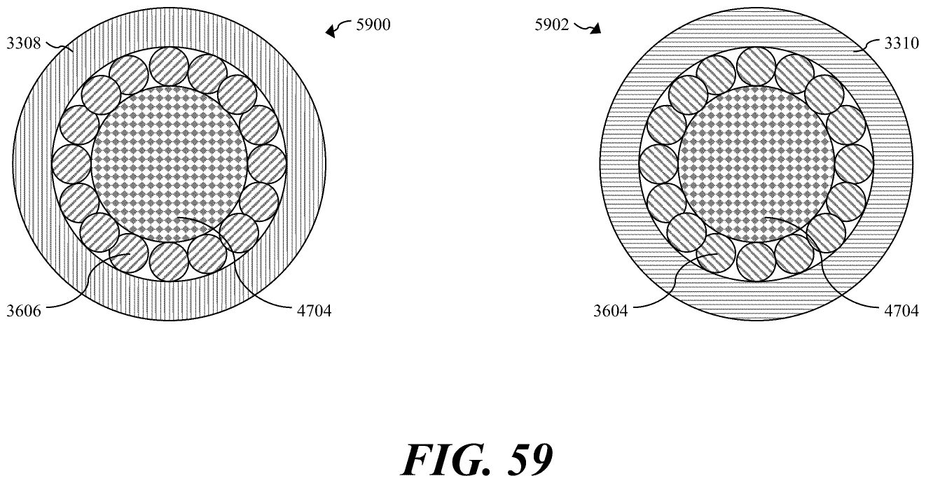

FIG. 59 illustrates, in an orthographic-front (head-on) view, a basic layout for a possible configuration of a signal-of-interest transmit-receive aperture 5900 and a signal-of-interest receive-transmit aperture 5902 to protect a bidirectional signal-of-interest with multiple layers and types of opposing unidirectional signals-of-protection allowing the signal-of-interest transmit-only aperture 5900 and signal-of-interest receive-only aperture 5902 to communicate or detect when the signal-of-protection has been breached.

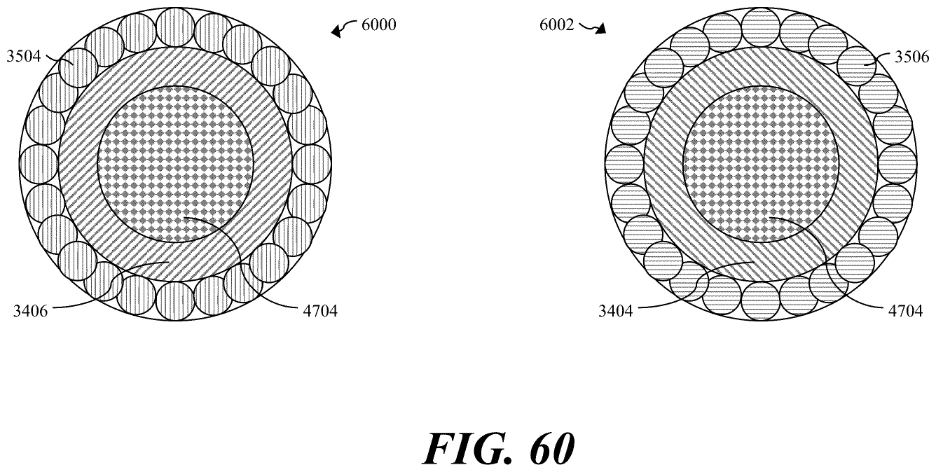

FIG. 60 illustrates, in an orthographic-front (head-on) view, a basic layout for a possible configuration of a signal-of-interest transmit-receive aperture 6000 and a signal-of-interest receive-transmit aperture 6002 to protect a bidirectional signal-of-interest with multiple layers and types of opposing unidirectional signals-of-protection allowing the signal-of-interest transmit-only aperture 6000 and signal-of-interest receive-only aperture 6002 to communicate or detect when the signal-of-protection has been breached.

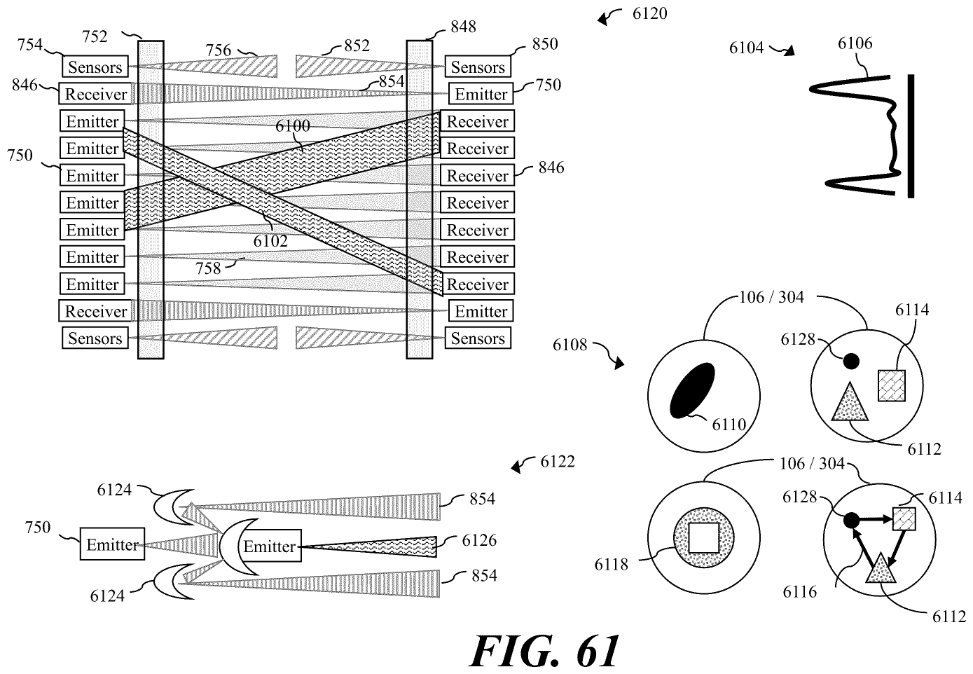

FIG. 61 illustrates some of the novel transmit and receive characteristics the apparatus is capable of performing and checking for to ensure security and safety performance levels are maintained. Two apparatus' are depicted in 6120 show a set of signals being transmitted and received. The transmitting apparatus is making use of its sensor module 754 to sense the environment 756 for changes in state as well as for foreign objects which may interest the path of the transmitted signal to the receiver; the housing module 752 is ensuring no foreign or natural debris degrade the emitter modules 750 as the signal transmitted using three separate ways my modulating and tweaking the characteristics of coherent electromagnetic sources 758, 6100, and 6102; the signal-of-protection conduit 854 can also be observed as it surrounds the signals-of-interest 758, 6100, and 6102. Similarly, the receiving apparatus is making use of its sensor module 850 to sense the environment 852 for changes in state as well as for foreign objects which may interest the path of the transmitted signal to the receiver; the housing module 848 is ensuring no foreign or natural debris degrade the receiver modules 846 as the signal is received. Element 6104 shows the received signal intensity 6106 across all of its receivers to ensure the signal being sent is of the proper intensity at the proper location on the receiver array face. Element 6122 shows an example of a possible simple setup to allow an emitter(s) 750 signal-of-interest 6126 to be surrounded by a single continuous signal-of-protection 854 by making use of beam combiners, splitters, phased array techniques, and reflectors 6124. 6108 shows, in an orthographic view, an example of how what an array face of a receiver 106 or 304 may be looking for to ensure the signal-of-interest is indeed the correct signal to receive: signal-of-interest spot size 6110; spot shape and/or polarization 6118; multiple different shapes, polarizations, and receive locations simultaneously 6114 and 6112; and all of the above (6128, 6114, 6112) dynamically changing to a specific timing algorithm 6116.

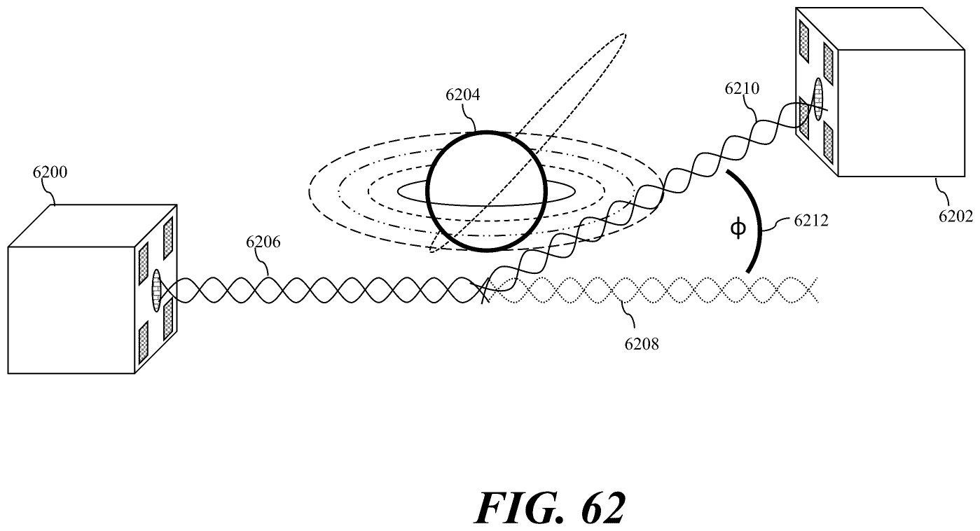

FIG. 62 illustrates the capability of the apparatus is able to directionally steer its signal beam by making use of gravitational bodies. A transmit node 6200, transmits a signal-of-interest 6206 near a large gravitational body or object 6204. The signal-of-interest deviates from its unaffected path 6208 by an amount 6212 resulting in a new signal-of-interest path 6210 to its intended receiver node 6202.

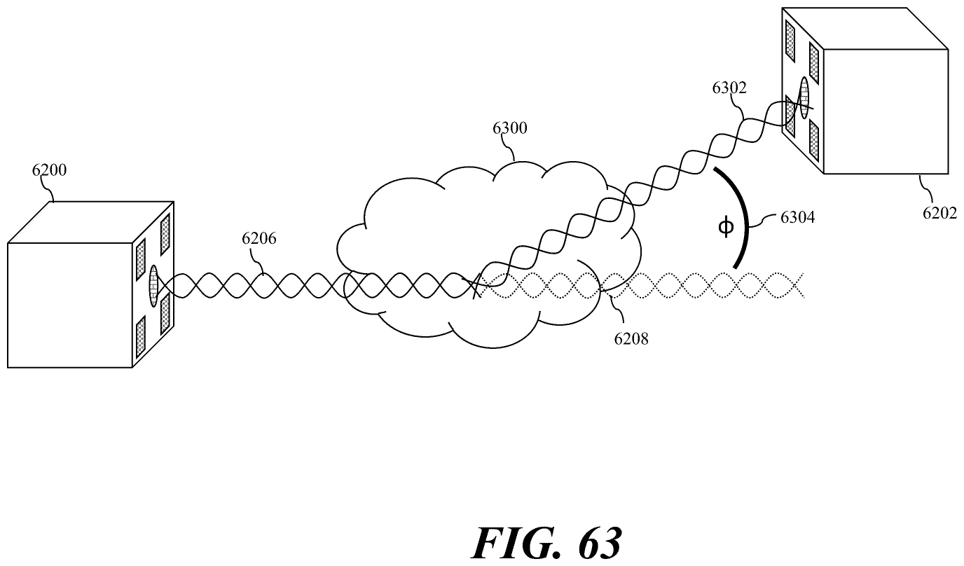

FIG. 63 illustrates the capability of the apparatus is able to directionally steer its signal beam by making use of environmental surroundings and transmission medium properties and characteristics. A transmit node 6200, transmits a signal-of-interest 6206 into a medium 6300 with properties to deviate the signal-of-interest. The signal-of-interest deviates from its unaffected path 6208 by an amount 6304 resulting in a new signal-of-interest path 6302 to its intended receiver node 6202.

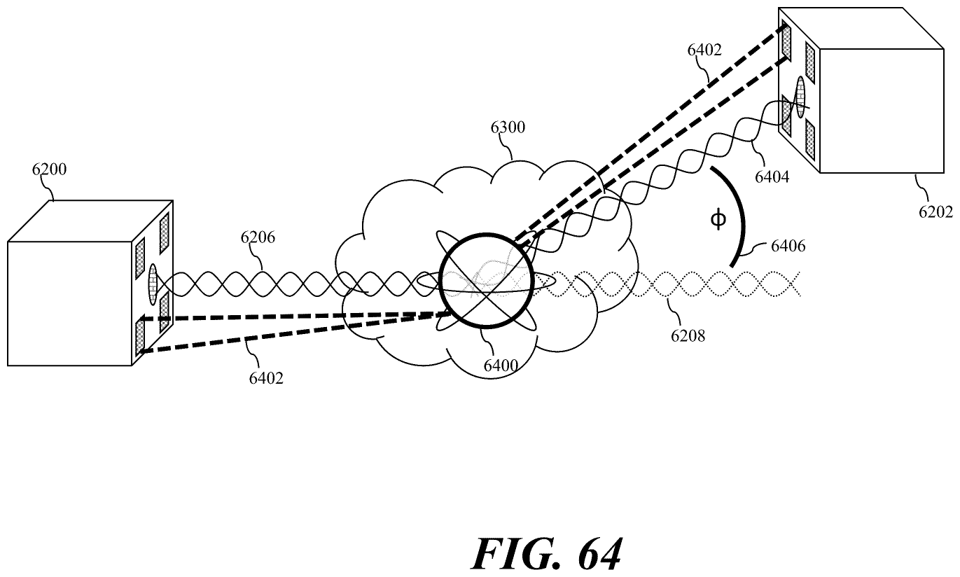

FIG. 64 illustrates the capability of the apparatus is able to directionally steer its signal beam by actively modifying its environmental surroundings and transmission medium. A transmit node 6200, transmits a signal-of-interest 6206 into a medium 6300. The transmit and/or receive node modify the medium 6300 with energy 6402 (such as creating a plasma in the atmosphere with lasers) creating a new medium 6400 with properties to deviate the signal-of-interest. The signal-of-interest deviates from its unaffected path 6208 by an amount 6406 resulting in a new signal-of-interest path 6404 to its intended receiver node 6202.

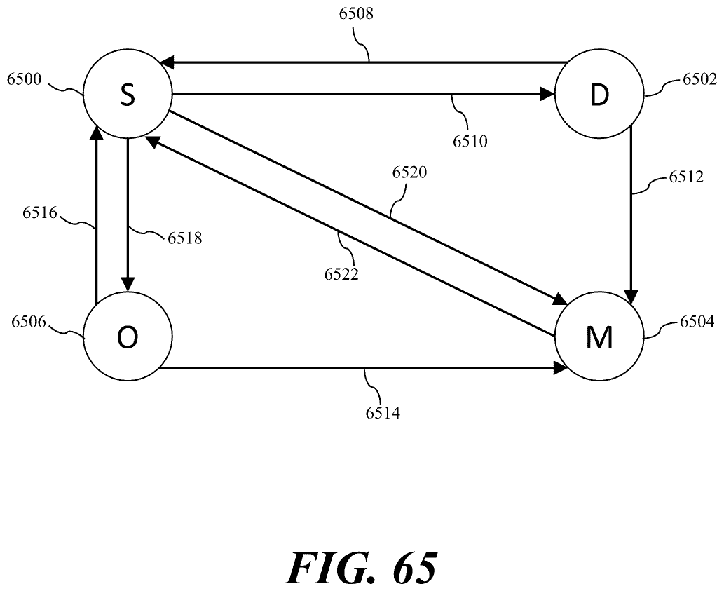

FIG. 65 illustrates, at a high-level, a differing states of operation and transition paths between them. The apparatus has four states: safe 6500, developer 6502, maintenance 6504, and operational 6506. The apparatus always defaults to the safe state 6500 when powered on. From there, it can be transitioned to the developer state 6502 via 6510 and back via 6508. The developer state 6502 can only be reached via 6510 from the safe state 6500; however, the developer state 5602 can transition to the maintenance state 6504 via 6512. Similar to the developer state 6502, the operational state 6506 can only be reached via 6518 from the safe state 6500. From the operational state 6506, it can transition to the safe state 6500 via 6516 or the maintenance state 6504 via 6514. Finally, the maintenance state 6504 can transition to and from the sate state 6500 via 6522 and 6520. The reason the safe state 6500 is the most versatile state is due to it being the predominate state within the apparatus which ensures the apparatus is not harmed by auxiliary payloads, potential operational mishaps, maintenance race conditions, and developer accidents.

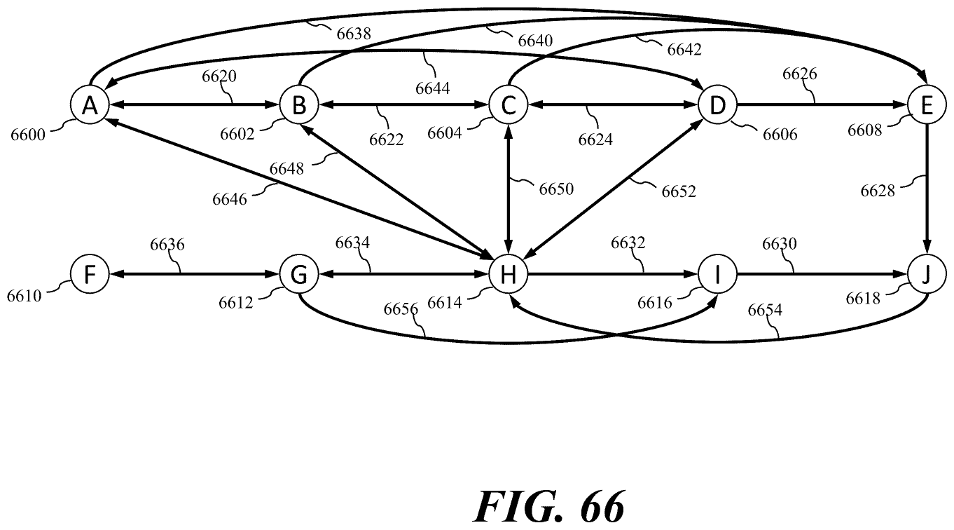

FIG. 66 illustrates, at a lower-level, the differing states of operation within the Operational system state and the transition paths between them. The operational state 6506 consists of the following states: execution transmit 6600, execution receive 6602, override transmit 6604, override receive 6606, hard interrupt 6608, stand by 6610, ready unassigned 6612, ready assigned 6614, soft interrupt 6616, and resume interrupt 6618. The execution transmit state 6600 allows the apparatus in operational state 6506 to transmit the signal(s)-of-interest and signal(s)-of-protection. The execution receive 6602 allows the apparatus in the operational state 6506 to receive the signal(s)-of-interest and signal(s)-of-protection. The override transmit 6604 state allows the apparatus in the operational state 6506 to conduct transmit operations even if the apparatus is aware of a security, safety, or other error. The override receive 6606 state allows the apparatus in the operational state 6506 to conduct receive operations even if the apparatus is aware of a security, safety, or other error. The hard interrupt 6608 state allows the apparatus in the operational state 6506 to immediately abort its current task to be re-tasked as needed. The stand by 6610 state allows the apparatus in the operational state 6506 to power down into a working, but unused dormant mode. The ready unassigned 6612 state allows the apparatus in the operational state 6506 to place the device is a ready to perform execution operations mode but is awaiting assignment. The ready assigned 6614 state allows the apparatus in the operational state 6506 place the device is a ready to perform execution operations mode and is currently initializing for imminent execution operations. The soft interrupt 6616 state allows the apparatus in the operational state 6506 to cease its current tasking when it is able to instead of hard aborting all tasking immediately. The resume interrupt 6618 state allows the apparatus in the operational state 6506 to resume its prior or new tasking after the interruption tasking has completed. The execution transmit 6600 state is able to transition to and from the: execution receive 6602 state via 6620 to enable transmitting and receiving signals-of-interest and signals-of-protection; override receive 6606 state via 6644 to enable transmit functions in spite of system security, safety, or internal errors; and ready assigned 6614 state via 6646 to start or stop transmit operations. The execution receive 6602 state is able to transition to and from the: execution transmit 6600 state via 6620; override transmit 6604 state via 6622 to enable receive functions in spite of system security, safety, or internal errors; and ready assigned 6614 state via 6648 to start or stop receive operations. The override transmit 6604 state is able to transition to and from the: execution receive 6602 state via 6622, override receive 6606 state 6624 to enable transmit functions in spite of system security, safety, or internal errors; and ready assigned 6614 state via 6650 to start or stop transmit operations. The override receive 6606 state is able to transition to and from the: execution transmit 6600 state via 6644; override transmit 6604 state via 6624; and ready assigned 6614 state via 6652 to start or stop receive operations. The hard interrupt 6608 state is able to transition from the following states by interrupting all tasks immediately: execution transmit 6600 via 6638; execution receive 6602 via 6640; override transmit 6604 via 6642; and override receive 6606 via 6626. The hard interrupt 6608 state is able to transition to the resume interrupt 6618 state via 6628 to allowing tasking to resume on the interruption task has been completed. The stand by 6610 state is able to transition to and from the: ready unassigned 6612 state via 6636. The stand by 6610 state is the entry and exit point for transition out of the operational state 6506. The ready unassigned 6612 state is able to transition to and from the: stand by 6610 state via 6636; and ready assigned 6614 state via 6634. The ready assigned 6614 state is able to transition to and from the: execution transmit 6600 state via 6646; execution receive 6602 state via 6648; override transmit 6604 state via 6650; override receive 6606 state via 6652; and ready unassigned 6612 state via 6634. The soft interrupt 6616 state is able to transition from the: ready assigned 6614 state via 6632; and ready unassigned 6612 state via 6656. The soft interrupt 6616 state is able to transition to the: resume interrupt 6618 state via 6630. The resume interrupt 6618 state is able to transition from the: hard interrupt 6608 state via 6628; and soft interrupt 6616 state via 6630. The resume interrupt 6618 state is able to transition to the: ready assigned 6614 state via 6654.

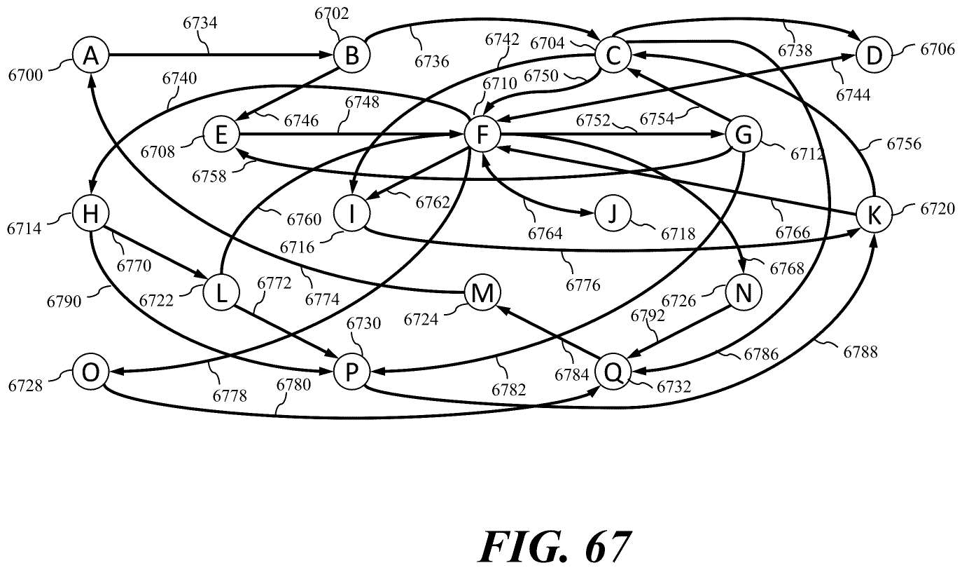

FIG. 67 illustrates, at a lower-level, the differing states of operation within the Safe system state and the transition paths between them. The safe state 6500 consists of the following states: power on 6700, initialization 6702, ready 6704, stand by 6706, error 6708, diagnostics 6710, built-in-test 6712, update 6714, soft interrupt 6716, report metrics 6718, resume interrupt 6720, configure 6722, power off 6724, reset 6726, restore 6728, hard interrupt 6730, and shutdown process 6732. The power on 6700 state allows the apparatus in safe state 6500 to energize the device. The initialization 6702 state allows the apparatus in safe state 6500 to load and boot the main devices embedded processing operating system. The ready 6704 state allows the apparatus in safe state 6500 to place the device is a ready to perform execution operations mode but is awaiting assignment. The stand by 6706 state allows the apparatus in safe state 6500 to power down into a working, but unused dormant mode. The error 6708 state allows the apparatus in safe state 6500 to flag the device as non-functioning, requiring maintenance, FDFI operations, diagnostics, or repair. The diagnostics 6710 state allows the apparatus in safe state 6500 to execute internal built-in-tests and other useful FDFI tools. The built-in-test 6712 state allows the apparatus in safe state 6500 to test individual parts of the devices subsystem in an attempt to isolate the faulty system or part. The update 6714 state allows the apparatus in safe state 6500 to update the devices software, firmware, or other rewritable code execution instructions. The soft interrupt 6716 state allows the apparatus in safe state 6500 to cease its current tasking when it is able to instead of hard aborting all tasking immediately. The report metrics 6718 state allows the apparatus in safe state 6500 to run and collect measures and metrics about various parts of the device, its subsystems, and potentially other external supporting features. The resume interrupt 6720 state allows the apparatus in safe state 6500 to resume its prior or new tasking after the interruption tasking has completed. The configure 6722 state allows the apparatus in safe state 6500 to modify, tweak, or completely change fundamental or minor aspects of the devices logic, operation, or function. The power off 6724 state allows the apparatus in safe state 6500 to de-energize the device. The reset 6726 state allows the apparatus in safe state 6500 to factory reset the device, de-energize and re-energize the device as needed. The restore 6728 state allows the apparatus in safe state 6500 to roll back the devices previous configuration and loaded memory to a prior state. The hard interrupt 6730 state allows the apparatus in safe state 6500 to immediately abort its current task to be re-tasked as needed. The shutdown process 6732 state allows the apparatus in safe state 6500 to safely and properly prepare the device to be de-energized. The power on 6700 state is able to transition to: the initialization 6702 state via 6734; the power on 6700 state is able to transition from: the power off 6724 state via 6774. The initialization 6702 state is able to transition to: the ready 6704 state via 6736, the error 6708 state via 6746; the initialization 6702 state is able to transition from: the power on 6700 state via 6734. The ready 6704 state is able to transition to: the stand by 6706 state via 6738, the shutdown process 6732 state via 6786, the diagnostics 6710 state via 6750, the soft interrupt 6716 state via 6742; the ready 6704 state is able to transition from: the initialization 6702 state via 6737, the resume interrupt 6720 state via 6756, and the built-in-test 6712 state via 6754. The stand by 6706 state is able to transition to: the diagnostics 6710 state via 6744; the stand by 6706 state is able to transition from: the diagnostics 6710 state via 6744, and the ready 6704 state via 6738. The error 6708 state is able to transition to: the diagnostics 6710 state via 6748; the error 6708 state is able to transition from: the initialization 6702 state via 6746, and the built-in-test 6712 state via 6758. The diagnostics 6710 state is able to transition to: the stand by 6706 state via 6744, the built-in-test 6712 state via 6752, the reset 6726 state via 6768, the report metrics 6718 state via 6764, the soft interrupt 6716 state via 6762, the restore 6728 state via 6778, the reset 6726 state via 6768, and the update 6714 state via 6740; the diagnostics 6710 state is able to transition from: the error 6708 state via 6748, the configure 6722 state via 6760, the report metrics 6718 state via 6764, the resume interrupt 6720 state via 6766, the stand by 6706 state via 6744, and the ready 6704 state via 6750. The built-in-test 6712 state is able to transition to: the ready 6704 state via 6754, the error 6708 state via 6758, and the hard interrupt 6730 state via 6782; the built-in-test 6712 state is able to transition from: diagnostics 6710 state via 6752. The update 6714 state is able to transition to: the configure 6722 state via 6770, and the hard interrupt 6730 state via 6790; the update 6714 state is able to transition from: the diagnostics 6710 state via 6740. The soft interrupt 6716 state is able to transition to: the resume interrupt 6720 state via 6776; the soft interrupt 6716 state is able to transition from the: the ready 6704 state via 6742, and the diagnostics 6710 state via 6762. The report metrics 6718 state is able to transition to and from the diagnostics 6710 state via 6764. The resume interrupt 6720 state is able to transition to: the diagnostics 6710 state via 6766, and the ready 6704 state via 6756; the resume interrupt 6720 state is able to transition from: soft interrupt 6716 state via 6776, and the hard interrupt 6730 state via 6788. The configure 6722 state is able to transition to: the hard interrupt 6730 state via 6772, and the diagnostics 6710 state via 6760; the configure 6722 state is able to transition from: the update 6714 state via 6770. The power off 6724 state is able to transition to: power on 6700 state via 6774; the power off 6724 state is able to transition from: shutdown process 6732 state via 6784. The reset 6726 state is able to transition to: the shutdown process 6732 state via 6792; the reset 6726 state is able to transition from: the diagnostics 6710 state via 6768. The restore 6728 state is able to transition to: the shutdown process 6732 state via 6780; the restore 6728 state is able to transition from: the diagnostics 6710 state via 6778. The hard interrupt 6730 state is able to transition to: the resume interrupt 6720 state via 6788; the hard interrupt 6730 state is able to transition from: the configure 6722 state via 6772, the update 6714 state via 6790, and the built-in-test 6712 state via 6782. The shutdown process 6732 state is able to transition to: the power off 6724 state via 6784; the shutdown process 6732 state is able to transition from: the reset 6726 state via 6792, the ready 6704 state via 6786, and the restore 6728 state via 6780.

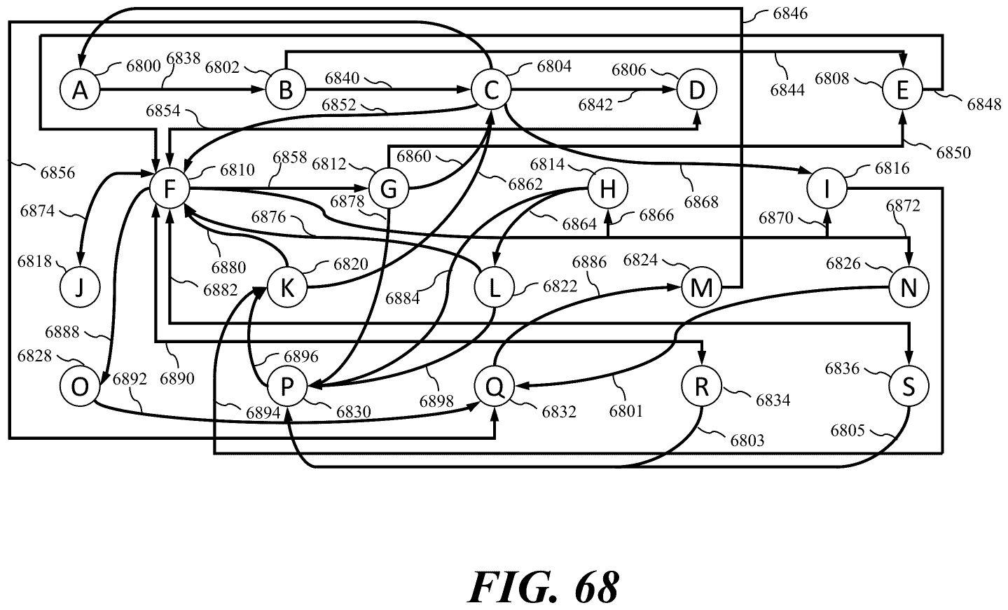

FIG. 68 illustrates, at a lower-level, the differing states of operation within the Maintenance system state and the transition paths between them. The maintenance state 6504 consists of the following states: power on 6800, initialization 6802, ready 6804, stand by 6806, error 6808, diagnostics 6810, built-in-test 6812, update 6814, soft interrupt 6816, report metrics 6818, resume interrupt 6820, configure 6822, power off 6824, reset 6826, restore 6828, hard interrupt 6830, shutdown process 6832, auxiliary 6834, and calibration 6836. The power on 6800 state allows the apparatus in maintenance state 6504 to energize the device. The initialization 6802 state allows the apparatus in maintenance state 6504 to load and boot the main devices embedded processing operating system. The ready 6804 state allows the apparatus in maintenance state 6504 to place the device is a ready to perform execution operations mode but is awaiting assignment. The stand by 6806 state allows the apparatus in maintenance state 6504 to power down into a working, but unused dormant mode. The error 6808 state allows the apparatus in maintenance state 6504 to flag the device as non-functioning, requiring maintenance, FDFI operations, diagnostics, or repair. The diagnostics 6810 state allows the apparatus in maintenance state 6504 to execute internal built-in-tests and other useful FDFI tools. The built-in-test 6812 state allows the apparatus in maintenance state 6504 to test individual parts of the devices subsystem in an attempt to isolate the faulty system or part. The update 6814 state allows the apparatus in maintenance state 6504 to update the devices software, firmware, or other rewritable code execution instructions. The soft interrupt 6816 state allows the apparatus in maintenance state 6504 to cease its current tasking when it is able to instead of hard aborting all tasking immediately. The report metrics 6818 state allows the apparatus in maintenance state 6504 to run and collect measures and metrics about various parts of the device, its subsystems, and potentially other external supporting features. The resume interrupt 6820 state allows the apparatus in maintenance state 6504 to resume its prior or new tasking after the interruption tasking has completed. The configure 6822 state allows the apparatus in maintenance state 6504 to modify, tweak, or completely change fundamental or minor aspects of the devices logic, operation, or function. The power off 6824 state allows the apparatus in maintenance state 6504 to de-energize the device. The reset 6826 state allows the apparatus in maintenance state 6504 to factory reset the device, de-energize and re-energize the device as needed. The restore 6828 state allows the apparatus in maintenance state 6504 to roll back the devices previous configuration and loaded memory to a prior state. The hard interrupt 6830 state allows the apparatus in maintenance state 6504 to immediately abort its current task to be re-tasked as needed. The shutdown process 6832 state allows the apparatus in maintenance state 6504 to safely and properly prepare the device to be de-energized. The auxiliary 6834 state allows the apparatus in maintenance state 6504 to conduct full control of maintenance activities for auxiliary payloads interfaced with the device. The calibration 6836 state allows the apparatus in maintenance state 6504 to conduct calibration activities in an effort to baseline the device performance and error tolerances or uncertainties. The power on 6800 state is able to transition to: the initialization 6802 state via 6838; the power on 6800 state is able to transition from: the power off 6824 state via 6846. The initialization 6802 state is able to transition to: the ready 6804 state via 6840, the error 6808 state via 6844; the initialization 6802 state is able to transition from: the power on 6800 state via 6838. The ready 6804 state is able to transition to: the stand by 6806 state via 6842, the soft interrupt 6816 state via 6868, the diagnostics 6810 state via 6852, and the shutdown process 6832 state via 6856; the ready 6804 state is able to transition from: the initialization 6802 state via 6840, the built-in-test 6812 state via 6860, and the resume interrupt 6820 state via 6862. The stand by 6806 state is able to transition to: the diagnostics 6810 state via 6854; the stand by 6806 state is able to transition from: the diagnostics 6810 state via 6854, and the ready 6804 state via 6842. The error 6808 state is able to transition to: the diagnostics 6810 state via 6848; the error 6808 state is able to transition from: the initialization 6802 state via 6844, and the built-in-test 6812 state via 6850. The diagnostics 6810 state is able to transition to: the report metrics 6818 state via 6874, the restore 6828 state via 6888, the auxiliary 6834 state via 6890, the calibration 6836 state via 6890, the reset 6826 state via 6872, the soft interrupt 6816 state via 6870, the update 6814 state via 6866, the built-in-test 6812 state via 6858, and the stand by 6806 state via 6854; the diagnostics 6810 state is able to transition from: the report metrics 6818 state via 6874, the auxiliary 6834 state via 6890, the calibration 6836 state via 6890, the resume interrupt 6820 state via 6880, the configure 6822 state via 6876, the ready 6804 state via 6852, the stand by 6806 state via 6854, and the error 6808 state via 6848. The built-in-test 6812 state is able to transition to: the ready 6804 state via 6860, the error 6808 state via 6850, and the hard interrupt 6830 state via 6878; the built-in-test 6812 state is able to transition from: diagnostics 6810 state via 6858. The update 6814 state is able to transition to: the configure 6822 state via 6864, and the hard interrupt 6830 state via 6884; the update 6814 state is able to transition from: the diagnostics 6810 state via 6866. The soft interrupt 6816 state is able to transition to: the resume interrupt 6820 state via 6894; the soft interrupt 6816 state is able to transition from the: the ready 6804 state via 6868, and the diagnostics 6810 state via 6870. The report metrics 6818 state is able to transition to and from the diagnostics 6810 state via 6874. The resume interrupt 6820 state is able to transition to: the diagnostics 6810 state via 6880, and the ready 6804 state via 6862; the resume interrupt 6820 state is able to transition from: soft interrupt 6816 state via 6894, and the hard interrupt 6830 state via 6896. The configure 6822 state is able to transition to: the hard interrupt 6830 state via 6898, and the diagnostics 6810 state via 6876; the configure 6822 state is able to transition from: the update 6814 state via 6864. The power off 6824 state is able to transition to: power on 6800 state via 6846; the power off 6824 state is able to transition from: shutdown process 6832 state via 6886. The reset 6826 state is able to transition to: the shutdown process 6832 state via 6801; the reset 6826 state is able to transition from: the diagnostics 6810 state via 6872. The restore 6828 state is able to transition to: the shutdown process 6832 state via 6892; the restore 6828 state is able to transition from: the diagnostics 6810 state via 6888. The hard interrupt 6830 state is able to transition to: the resume interrupt 6820 state via 6896; the hard interrupt 6830 state is able to transition from: the configure 6822 state via 6898, the update 6814 state via 6884, the built-in-test 6812 state via 6878, auxiliary 6834 state via 6803, and the calibration 6836 state via 6805. The shutdown process 6832 state is able to transition to: the power off 6824 state via 6886; the shutdown process 6832 state is able to transition from: the reset 6826 state via 6801, the ready 6804 state via 6856, and the restore 6828 state via 6892. The auxiliary 6834 state is able to transition to: the hard interrupt 6830 state via 6803, and the diagnostics 6810 state via 6890; the auxiliary 6834 state is able to transition from: the diagnostics 6810 state via 6890. The calibration 6836 state is able to transition to: the hard interrupt 6830 state via 6805, and the diagnostics 6810 state via 6882; the auxiliary 6834 state is able to transition from: the diagnostics 6810 state via 6882.

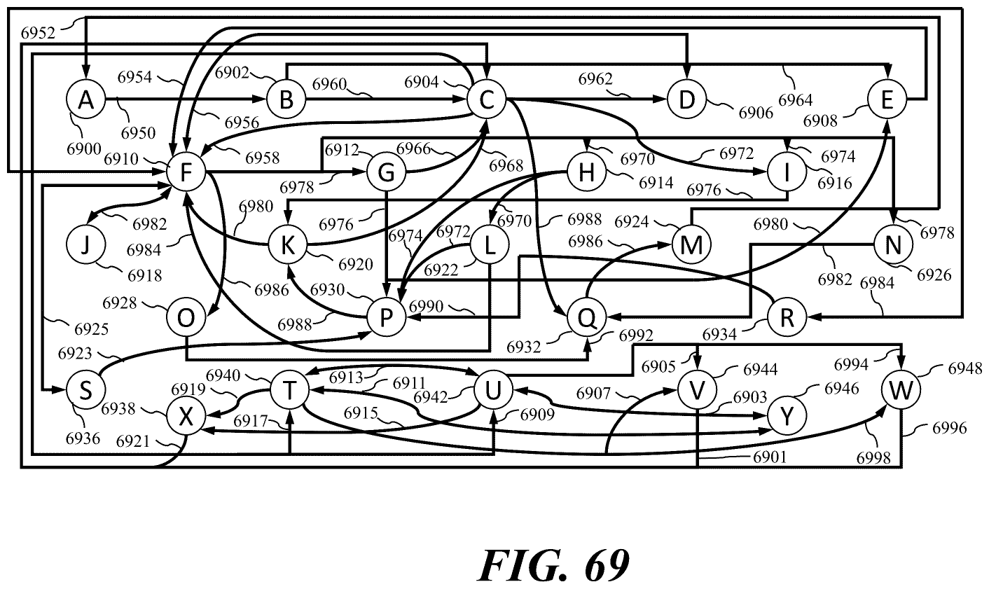

FIG. 69 illustrates, at a lower-level, the differing states of operation within the Developer system state and the transition paths between them. The developer state 6502 consists of the following states: power on 6900, initialization 6902, ready 6904, stand by 6906, error 6908, diagnostics 6910, built-in-test 6912, update 6914, soft interrupt 6916, report metrics 6918, resume interrupt 6920, configure 6922, power off 6924, reset 6926, restore 6928, hard interrupt 6930, shutdown process 6932, auxiliary 6934, calibration 6936, virtual sandbox 6940, physical sandbox 6942, access group local 6944, access group subset 6948, access group enterprise 6938, and command model task 6946. The power on 6900 state allows the apparatus in developer state 6502 to energize the device. The initialization 6902 state allows the apparatus in developer state 6502 to load and boot the main devices embedded processing operating system. The ready 6904 state allows the apparatus in developer state 6502 to place the device is a ready to perform execution operations mode but is awaiting assignment. The stand by 6906 state allows the apparatus in developer state 6502 to power down into a working, but unused dormant mode. The error 6908 state allows the apparatus in developer state 6502 to flag the device as non-functioning, requiring maintenance, FDFI operations, diagnostics, or repair. The diagnostics 6910 state allows the apparatus in developer state 6502 to execute internal built-in-tests and other useful FDFI tools. The built-in-test 6912 state allows the apparatus in developer state 6502 to test individual parts of the devices subsystem in an attempt to isolate the faulty system or part. The update 6914 state allows the apparatus in developer state 6502 to update the devices software, firmware, or other rewritable code execution instructions. The soft interrupt 6916 state allows the apparatus in developer state 6502 to cease its current tasking when it is able to instead of hard aborting all tasking immediately. The report metrics 6918 state allows the apparatus in developer state 6502 to run and collect measures and metrics about various parts of the device, its subsystems, and potentially other external supporting features. The resume interrupt 6920 state allows the apparatus in developer state 6502 to resume its prior or new tasking after the interruption tasking has completed. The configure 6922 state allows the apparatus in developer state 6502 to modify, tweak, or completely change fundamental or minor aspects of the devices logic, operation, or function. The power off 6924 state allows the apparatus in developer state 6502 to de-energize the device. The reset 6926 state allows the apparatus in developer state 6502 to factory reset the device, de-energize and re-energize the device as needed. The restore 6928 state allows the apparatus in developer state 6502 to roll back the devices previous configuration and loaded memory to a prior state. The hard interrupt 6930 state allows the apparatus in developer state 6502 to immediately abort its current task to be re-tasked as needed. The shutdown process 6932 state allows the apparatus in developer state 6502 to safely and properly prepare the device to be de-energized. The auxiliary 6934 state allows the apparatus in developer state 6502 to conduct full control of maintenance activities for auxiliary payloads interfaced with the device. The calibration 6936 state allows the apparatus in developer state 6502 to conduct calibration activities in an effort to baseline the performance and error tolerances or uncertainties of the device. The virtual sandbox 6940 state allows the apparatus in developer state 6502 to try out new software modifications to the device with causing damage to it, unless overridden; it also allows for experimental software builds to be investigated for viability. The physical sandbox 6942 state allows the apparatus in developer state 6502 to try out new hardware modifications to the device with causing damage to it, unless overridden; it also allows for experimental hardware builds to be investigated for viability. The access group local 6944 state allows the apparatus in developer state 6502 to modify permissions, like that of pushing over-the-air updates, to a single device. The access group subset 6948 state allows the apparatus in developer state 6502 to modify permissions, like that of pushing over-the-air updates, to a collection of devices within a virtual or physical area. The access group enterprise 6938 state allows the apparatus in developer state 6502 to modify permissions, like that of pushing over-the-air updates, to all devices within a virtual or physical area. The command model task 6946 state allows the apparatus in developer state 6502 to change its command hierarchy; different hierarchies include: centralized primary and secondary control, decentralized democratic control, and hybrid forms. The power on 6900 state is able to transition to: the initialization 6902 state via 6950; the power on 6900 state is able to transition from: the power off 6924 state via 6952. The initialization 6902 state is able to transition to: the ready 6904 state via 6960, the error 6908 state via 6964; the initialization 6902 state is able to transition from: the power on 6900 state via 6950. The ready 6904 state is able to transition to: the stand by 6906 state via 6962, the soft interrupt 6916 state via 6972, the diagnostics 6910 state via 6958, the shutdown process 6932 state via 6988, the physical sandbox 6942 state via 6909, and the virtual sandbox 6940 state via 6917; the ready 6904 state is able to transition from: the initialization 6902 state via 6960, the built-in-test 6912 state via 6966, the resume interrupt 6920 state via 6968, the access group enterprise 6938 state via 6921, the access group local 6944 state via 6901, and the access group subset 6948 state via 6996. The stand by 6906 state is able to transition to: the diagnostics 6910 state via 6956; the stand by 6906 state is able to transition from: the diagnostics 6910 state via 6956, and the ready 6904 state via 6962. The error 6908 state is able to transition to: the diagnostics 6910 state via 6954; the error 6908 state is able to transition from: the initialization 6902 state via 6964, and the built-in-test 6912 state via 6980. The diagnostics 6910 state is able to transition to: the report metrics 6918 state via 6982, the restore 6928 state via 6986, the auxiliary 6934 state via 6984, the calibration 6936 state via 6925, the reset 6926 state via 6978, the soft interrupt 6916 state via 6974, the update 6914 state via 6970, the built-in-test 6912 state via 6978, and the stand by 6906 state via 6956; the diagnostics 6910 state is able to transition from: the report metrics 6918 state via 6982, the auxiliary 6934 state via 6984, the calibration 6936 state via 6925, the resume interrupt 6920 state via 6980, the configure 6922 state via 6984, the ready 6904 state via 6958, the stand by 6906 state via 6956, and the error 6908 state via 6954. The built-in-test 6912 state is able to transition to: the ready 6904 state via 6966, the error 6908 state via 6980, and the hard interrupt 6930 state via 6976; the built-in-test 6912 state is able to transition from: diagnostics 6910 state via 6978. The update 6914 state is able to transition to: the configure 6922 state via 6970, and the hard interrupt 6930 state via 6974; the update 6914 state is able to transition from: the diagnostics 6910 state via 6970. The soft interrupt 6916 state is able to transition to: the resume interrupt 6920 state via 6976; the soft interrupt 6916 state is able to transition from the: the ready 6904 state via 6972, and the diagnostics 6910 state via 6974. The report metrics 6918 state is able to transition to and from the diagnostics 6910 state via 6982. The resume interrupt 6920 state is able to transition to: the diagnostics 6910 state via 6980, and the ready 6904 state via 6968; the resume interrupt 6920 state is able to transition from: soft interrupt 6916 state via 6976, and the hard interrupt 6930 state via 6988. The configure 6922 state is able to transition to: the hard interrupt 6930 state via 6972, and the diagnostics 6910 state via 6984; the configure 6922 state is able to transition from: the update 6914 state via 6970. The power off 6924 state is able to transition to: power on 6900 state via 6952; the power off 6924 state is able to transition from: shutdown process 6932 state via 6986. The reset 6926 state is able to transition to: the shutdown process 6932 state via 6982; the reset 6926 state is able to transition from: the diagnostics 6910 state via 6978. The restore 6928 state is able to transition to: the shutdown process 6932 state via 6992; the restore 6928 state is able to transition from: the diagnostics 6910 state via 6986. The hard interrupt 6930 state is able to transition to: the resume interrupt 6920 state via 6988; the hard interrupt 6930 state is able to transition from: the configure 6922 state via 6972, the update 6914 state via 6974, the built-in-test 6912 state via 6976, auxiliary 6934 state via 6990, and the calibration 6936 state via 6923. The shutdown process 6932 state is able to transition to: the power off 6924 state via 6986; the shutdown process 6932 state is able to transition from: the reset 6926 state via 6982, the ready 6904 state via 6988, and the restore 6928 state via 6992. The auxiliary 6934 state is able to transition to: the hard interrupt 6930 state via 6990, and the diagnostics 6910 state via 6984; the auxiliary 6934 state is able to transition from: the diagnostics 6910 state via 6984. The calibration 6936 state is able to transition to: the hard interrupt 6930 state via 6923, and the diagnostics 6910 state via 6925; the auxiliary 6934 state is able to transition from: the diagnostics 6910 state via 6925. The virtual sandbox 6940 state is able to transition to: the access group enterprise 6938 state via 6919, the ready 6904 state via 6917, the access group subset 6948 state via 6998, the access group local 6944 state via 6907, the command model task 6946 state via 6911, and the physical sandbox 6942 state via 6913; the virtual sandbox 6940 state is able to transition from: the ready 6904 state via 6917, the command model task 6946 state via 6911, and the physical sandbox 6942 state via 6913. The physical sandbox 6942 state is able to transition to: the access group enterprise 6938 state via 6915, the ready 6904 state via 6909, the command model task 6946 state via 6903, the access group local 6944 state via 6905, the access group subset 6948 state via 6994, and the virtual sandbox 6940 state via 6913; the physical sandbox 6942 state is able to transition from: the ready 6904 state via 6909, the command model task 6946 state via 6903, and the virtual sandbox 6940 state via 6913. The access group local 6944 state is able to transition to: the ready 6904 state via 6901; the access group local 6944 state is able to transition from: the physical sandbox 6942 state via 6905, and the virtual sandbox 6940 state via 6907. The access group subset 6948 state is able to transition to: the ready 6904 state via 6996; the access group subset 6948 state is able to transition from: the physical sandbox 6942 state via 6994, and the virtual sandbox 6940 state via 6998. The access group enterprise 6938 state is able to transition to: the ready 6904 state via 6921; the access group enterprise 6938 state is able to transition from: the virtual sandbox 6940 state via 6919, and the physical sandbox 6942 state via 6915. The command model task 6946 state is able to transition to: the physical sandbox 6942 state via 6903, and the virtual sandbox 6940 state via 6911; the command model task 6946 state is able to transition from: the physical sandbox 6942 state via 6903, and the virtual sandbox 6940 state via 6911.

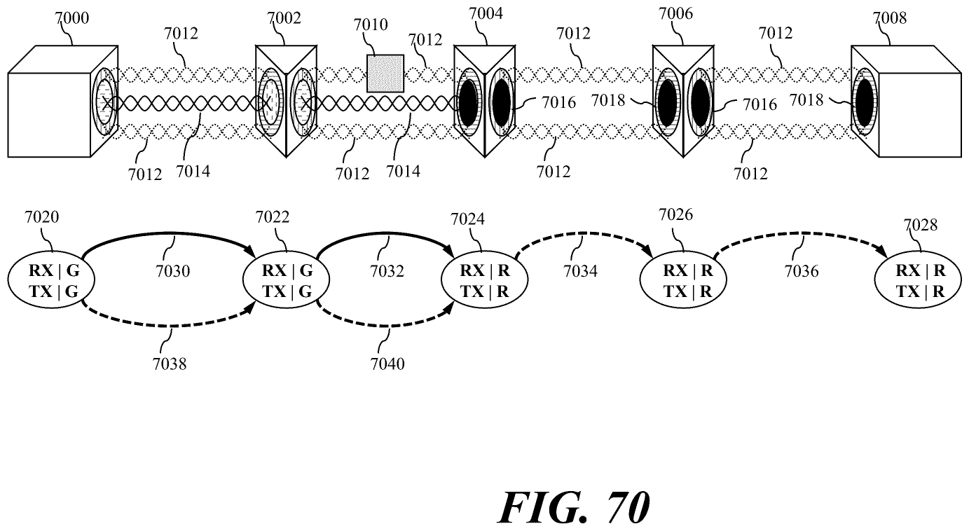

FIG. 70 illustrates a mode of operation if the outer shielding signals-of-protection are obstructed for a unidirectional signal-of-interest and unidirectional signals-of-protection. In the upper-half of FIG. 70, a linear network is shown consisting of: a unidirectional signal-of-interest with a unidirectional signals-of-protection transmit-only apparatus configuration 7000; a unidirectional signal-of-interest with a unidirectional signals-of-protection receive-only apparatus configuration 7008; and three sets of unidirectional signal-of-interest with a unidirectional signals-of-protection transmit-only apparatus configurations paired with three sets of unidirectional signal-of-interest with a unidirectional signals-of-protection receive-only apparatus configurations creating signal-of-interest and signals-of-protection repeaters 7002, 7004, and 7006. At some instant in time, a foreign object 7010 crosses the unidirectional signals-of-protection 7012. Node 7004 detects the change is the signals-of-protection 7012 and turns off its receive-only aperture 7018 and transmit-only aperture 7016 while forwarding the same instructions for the other nodes 7006 and 7008 to follow suite via 7012. The lower-half of FIG. 70 depicts a simple state diagram example of how this linear network's logic works for this apparatus' configuration. Node 7000's state diagram is denoted as 7020. Node 7002's state diagram is denoted as 7022. Node 7004's state diagram is denoted as 7024. Node 7006's state diagram is denoted as 7026. Node 7008's state diagram is denoted as 7028. As the foreign object 7010 crosses the unidirectional signals-of-protection 7012, node 7004 detects this change and updates its state 7024 to be RED (R) for transmit (TX) and receive (RX) operations. This state information is forwarded to the other nodes 7006 and 7008 to update their state diagrams 7026 and 7028 via 7034 and 7036 encoded within 7012. Due to the unidirectional nature of 7012, nodes 7000 and 7002 “in front” of the foreign object 7010 have their state diagrams 7020 and 7022 to be GREEN (G) for transmit (TX) and receive (RX) operations and will forward this state information via 7030 and 7032 encoded within 7012.

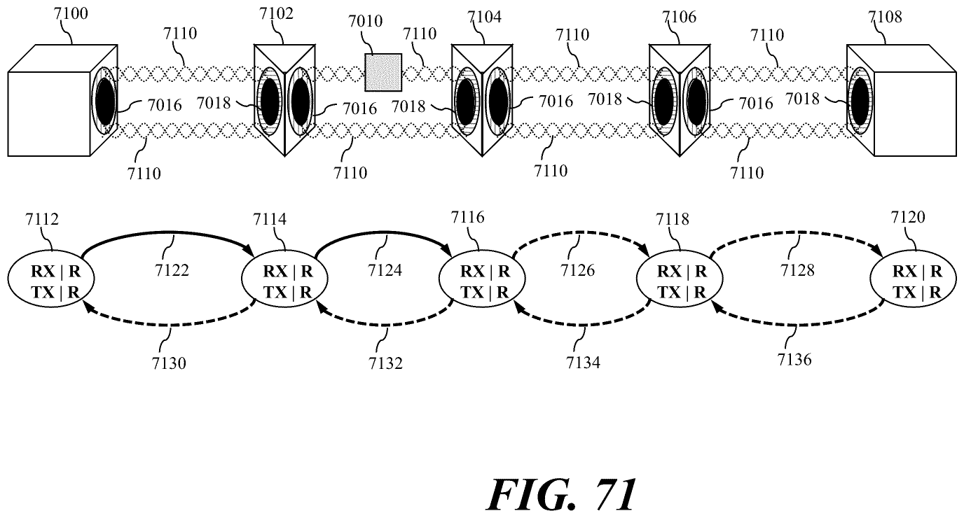

FIG. 71 illustrates a mode of operation if the outer shielding signals-of-protection are obstructed for a unidirectional signal-of-interest and there are two opposing unidirectional signals-of-protection. In the upper-half of FIG. 71, a linear network is shown consisting of: a unidirectional signal-of-interest with transmit-only capabilities combined with opposing unidirectional signals-of-protection transmit-only and receive-only apparatus configuration 7100; a unidirectional signal-of-interest with receive-only capabilities combined with opposing unidirectional signals-of-protection transmit-only and receive-only apparatus configuration 7108; and three sets of unidirectional signal-of-interest with transmit-only capabilities combined with opposing unidirectional signals-of-protection transmit-only and receive-only apparatus configurations paired with three sets of unidirectional signal-of-interest with receive-only capabilities combined with opposing unidirectional signals-of-protection transmit-only and receive-only apparatus configurations creating signal-of-interest and signals-of-protection repeaters with signals-of-protection feedback loops 7102, 7104, and 7106. At some instant in time, a foreign object 7010 crosses the opposing unidirectional signals-of-protection 7110. Node 7104 detects the change is the signals-of-protection 7110 and turns off its receive-only aperture 7018 and transmit-only aperture 7016 while forwarding the same instructions for the other nodes 7100, 7102, 7106, and 7108 to follow suite via 7110. The lower-half of FIG. 71 depicts a simple state diagram example of how this linear network's logic works for this apparatus' configuration. Node 7100's state diagram is denoted as 7112. Node 7102's state diagram is denoted as 7114. Node 7104's state diagram is denoted as 7116. Node 7106's state diagram is denoted as 7118. Node 7108's state diagram is denoted as 7120. As the foreign object 7010 crosses the opposing unidirectional signals-of-protection 7110, node 7104 detects this change and updates its state 7116 to be RED (R) for transmit (TX) and receive (RX) operations. This state information is forwarded to the other nodes 7106, 7108, 7102, and 7100 to update their state diagrams 7118, 7120, 7114, and 7112 via 7126, 7128, 7132, and 7130 encoded within 7110. Due to the opposing unidirectional nature of 7110, all node nodes regardless of location to the foreign object 7010 have their state diagrams updated immediately allowing for the entire linear network posture to stop transmitting. This type of bidirectional communication between nodes and their states creates feedback loops for added security. Node 7100 and node 7102 form a feedback loop with their states 7112 and 7114 being in communication through 7122 and 7130. Node 7102 and node 7104 form a feedback loop with their states 7114 and 7116 being in communication through 7124 and 7132. Node 7104 and node 7106 form a feedback loop with their states 7116 and 7118 being in communication through 7126 and 7134. Node 7106 and node 7108 form a feedback loop with their states 7118 and 7120 being in communication through 7128 and 7136.

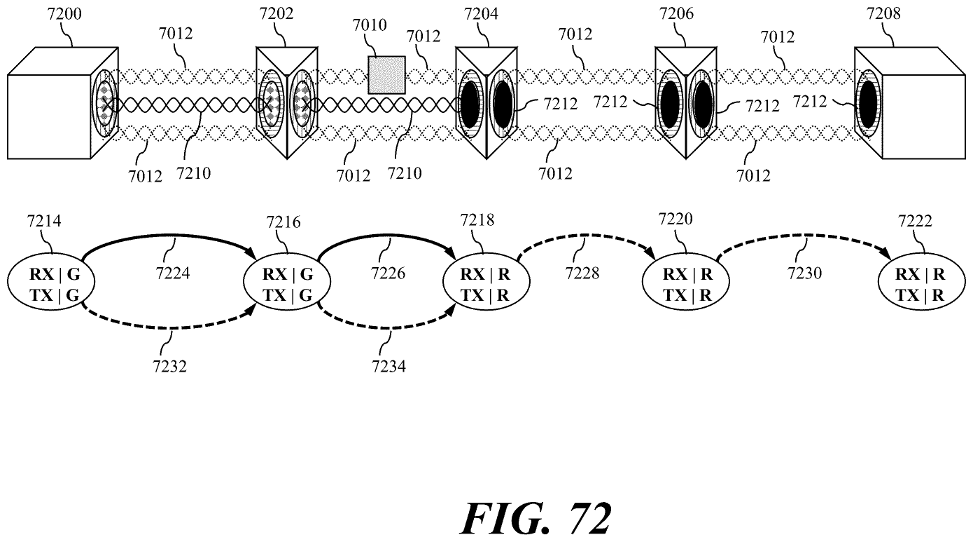

FIG. 72 illustrates a mode of operation if the outer shielding signals-of-protection are obstructed for a bidirectional signal-of-interest and unidirectional signals-of-protection. In the upper-half of FIG. 72, a linear network is shown consisting of: a bidirectional signal-of-interest with a unidirectional signals-of-protection transmit-only apparatus configuration 7200; a bidirectional signal-of-interest with a unidirectional signals-of-protection receive-only apparatus configuration 7208; and three sets of bidirectional signal-of-interest with a unidirectional signals-of-protection transmit-only apparatus configurations paired with three sets of bidirectional signal-of-interest with a unidirectional signals-of-protection receive-only apparatus configurations creating signal-of-interest and signals-of-protection repeaters 7202, 7204, and 7206. At some instant in time, a foreign object 7010 crosses the unidirectional signals-of-protection 7012. Node 7204 detects the change in the signals-of-protection 7012 and turns off transmit-receive aperture 7212 while forwarding the same instructions for the other nodes 7206 and 7208 to follow suite via 7012. The lower-half of FIG. 72 depicts a simple state diagram example of how this linear network's logic works for this apparatus' configuration. Node 7200's state diagram is denoted as 7214. Node 7202's state diagram is denoted as 7216. Node 7204's state diagram is denoted as 7218. Node 7206's state diagram is denoted as 7220. Node 7208's state diagram is denoted as 7222. As the foreign object 7010 crosses the unidirectional signals-of-protection 7012, node 7204 detects this change and updates its state 7218 to be RED (R) for transmit (TX) and receive (RX) operations. This state information is forwarded to the other node 7206 and 7208 to update their state diagrams 7220 and 7222 via 7228 and 7230 encoded within 7012. Due to the unidirectional nature of 7012, nodes 7200 and 7202 “in front” of the foreign object 7010 have their state diagrams 7214 and 7216 to be GREEN (G) for transmit (TX) and receive (RX) operations and will forward this state information via 7224 and 7226 encoded within 7012.

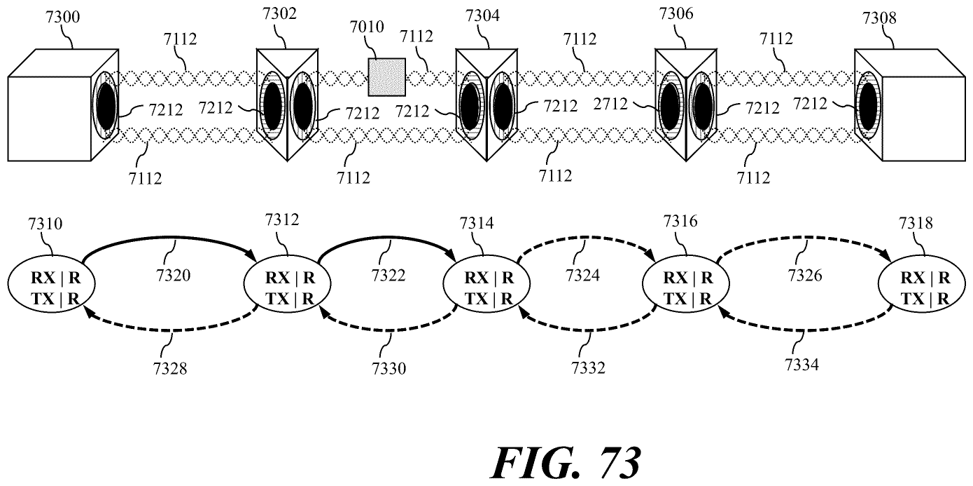

FIG. 73 illustrates a mode of operation if the outer shielding signals-of-protection are obstructed for a bidirectional signal-of-interest and there are two opposing unidirectional signals-of-protection. In the upper-half of FIG. 73, a linear network is shown consisting of: a bidirectional signal-of-interest with transmit-only capabilities combined with opposing unidirectional signals-of-protection transmit-only and receive-only apparatus configuration 7300; a bidirectional signal-of-interest with receive-only capabilities combined with opposing unidirectional signals-of-protection transmit-only and receive-only apparatus configuration 7308; and three sets of bidirectional signal-of-interest with transmit-only capabilities combined with opposing unidirectional signals-of-protection transmit-only and receive-only apparatus configurations paired with three sets of bidirectional signal-of-interest with receive-only capabilities combined with opposing unidirectional signals-of-protection transmit-only and receive-only apparatus configurations creating signal-of-interest and signals-of-protection repeaters with signals-of-protection feedback loops 7302, 7304, and 7306. At some instant in time, a foreign object 7010 crosses the opposing unidirectional signals-of-protection 7112. Node 7304 detects the change is the signals-of-protection 7112 and turns off its transmit-receive-only aperture 7212 while forwarding the same instructions for the other nodes 7300, 7302, 7306, and 7308 to follow suite via 7112. The lower-half of FIG. 73 depicts a simple state diagram example of how this linear network's logic works for this apparatus' configuration. Node 7300's state diagram is denoted as 7310. Node 7302's state diagram is denoted as 7312. Node 7304's state diagram is denoted as 7314. Node 7306's state diagram is denoted as 7316. Node 7308's state diagram is denoted as 7318. As the foreign object 7010 crosses the opposing unidirectional signals-of-protection 7112, node 7304 detects this change and updates its state 7314 to be RED (R) for transmit (TX) and receive (RX) operations. This state information is forwarded to the other nodes 7306, 7308, 7302, and 7300 to update their state diagrams 7316, 7318, 7312, and 7310 via 7324, 7326, 7330, and 7328 encoded within 7112. Due to the opposing unidirectional nature of 7112, all node nodes regardless of location to the foreign object 7010 have their state diagrams updated immediately allowing for the entire linear network posture to stop transmitting. This type of bidirectional communication between nodes and their states creates feedback loops for added security. Node 7300 and node 7302 form a feedback loop with their states 7310 and 7312 being in communication through 7320 and 7328. Node 7302 and node 7304 form a feedback loop with their states 7312 and 7314 being in communication through 7322 and 7330. Node 7304 and node 7306 form a feedback loop with their states 7314 and 7316 being in communication through 7324 and 7332. Node 7306 and node 7308 form a feedback loop with their states 7316 and 7318 being in communication through 7326 and 7334.

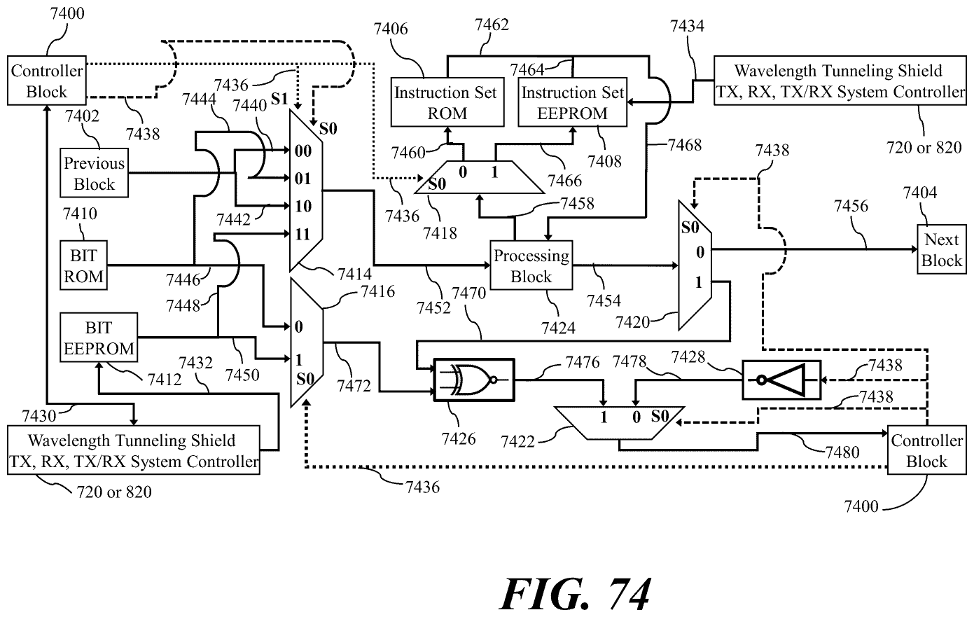

FIG. 74 illustrates, at a generic subsystem level, an exemplary fault-detection and fault-isolation (FDFI) configuration that may be implemented with the presently disclosed apparatus, and which can be further modified or adapted to a particular FDFI logic control as needed. As examples, the previously described subsystems may employ this FDFI logic including power source protection and conditioner 706, power destination protection and conditioner 806, signal source protection and conditioner 714, signal destination protection and conditioner 814, cooling and thermal management 722, coherent source power rectifier 724, coherent source 726, signal encoder 728, channel encoder 730, modulator 732, transmit protection and conditioner 742, beam train director transmit 744, housing transmit 752, housing receive 848, beam train director receive 840, receiver protection and conditioner 838, matching and rectifier network 834, blocking diode network 830, demodulator 826, channel decoder 824, and signal decoder 822. This generalized example shows a controller block 7400, which would be the controller for any of the aforementioned subsystems, a main controller for the TX-only, RX-only, or TX-RX configurations 720 or 820, the previous subsystem block 7402 feeding into the controller for any of the aforementioned subsystems, the next subsystem block 7404 fed from the controller for any of the aforementioned subsystems, the subsystem instruction set ROM 7406 for any of the aforementioned subsystems, the subsystem instruction set EEPROM 7408 for any of the aforementioned subsystems, the subsystem BIT ROM 7410 for any of the aforementioned subsystems; the subsystem BIT EEPROM 7412 for any of the aforementioned subsystems, the subsystem processing block 7424 where computational action takes place; a four-to-one multiplexer 7414 for setting the information read input, a two-to-one multiplexer 7416 for setting the BIT comparison, a one-to-two multiplexer 7418 for setting the instruction set execution type, a one-to-two multiplexer 7420 for setting the output information flow, or a two-to-one multiplexer 7422 for setting the BIT results reporting. The FDFI circuit logic shown in FIG. 74 reports a state of ‘1’ if a subsystem is functioning as intended; a ‘0’ if a subsystems is not functioning as intended. There are four primary FDFI control states: (1) for normal operations with no FDFI logic being executed and using original instruction set ROM 7406, a ‘0’ FDFI signal will be sent on 7438 and 7436 from the controller block 7400; (2) for FDFI logic being executed and using original instruction set ROM 7406, a ‘1’ FDFI signal will be sent on 7438 and a ‘0’ FDFI signal will be sent on 7436 from the controller block 7400; (3) for normal operations with no FDFI logic being executed and using instruction set EEPROM 7408, a ‘0’ FDFI signal will be sent on 7438 and a ‘1’ FDFI signal will be sent on 7436 from the controller block 7400; and (4) for FDFI logic being executed and using instruction set EEPROM 7408, a ‘1’ FDFI signal will be sent on 7438 and a ‘1’ FDFI signal will be sent on 7436 from the controller block 7400. For FDFI control state (1): a ‘0’ FDFI signal is present on 7436 and a ‘0’ FDFI signal is present on 7438; the signal-of-interest enters the FDFI circuit logic from the previous block 7402 and is routed to 7414 via 7440 and 7442; since the FDFI signal is ‘00’, the signal-of-interest is taken from the 7440 input into 7414; the signal-of-interest is then routed to the processing block 7424 via 7452; the processing block retrieves the proper instructions on how to process the signal-of-interest by accessing the instruction set via 7458; since the FDFI signal is ‘00’, the instruction set retrieve request is routed to the instruction set ROM 7406 via 7460; the instructions are routed back to the processing block 7424 via 7462 and then 7468; the signal-of-interest is processed according to the retrieved instruction set and then sent to 7420 via 7454; since the FDFI signal is ‘00’ the signal-of-interest routed via 7456 to the next block 7404 exiting the FDFI circuit logic; since the FDFI signal is ‘00’ the 7478 signal path contain a ‘1’ after being inverted by a logical NOT gate 7428 and 7422 selects this resultant ‘1’ signal to be forwarded to the controller block 7400 via 7480 reporting out the apparatus is functioning as intended. For FDFI control state (2): a ‘0’ FDFI signal is present on 7436 and a ‘1’ FDFI signal is present on 7438; the signal-of-interest enters the FDFI circuit logic from the previous block 7402 and is routed to 7414 via 7440 and 7442; since the FDFI signal is ‘01’, the BIT ROM 7410 signal is taken from the 7444 input into 7414; the BIT ROM 7410 signal is then routed to the processing block 7424 via 7452; the processing block retrieves the proper instructions on how to process the BIT ROM 7410 signal by accessing the instruction set via 7458; since the FDFI signal is ‘01’, the instruction set retrieve request is routed to the instruction set ROM 7406 via 7460; the instructions are routed back to the processing block 7424 via 7462 and then 7468; the BIT ROM 7410 signal is processed according to the retrieved instruction set and then sent to 7420 via 7454; since the FDFI signal is ‘01’ the BIT ROM 7410 signal routed via 7470 into a logical XNOR gate 7426 where it is compared with the BIT ROM 7410 signal routed from 7446 through 7416 via 7472; if the BIT ROM 7410 signal was processed correctly, the logical XNOR gate 7426 will send a ‘1’ on 7476 to 7422 which selects this resultant ‘1’ signal path to be forwarded to the controller block 7400 via 7480 reporting out the apparatus is functioning as intended; if the BIT ROM 7410 signal was not processed correctly, the logical XNOR gate 7426 will send a ‘0’ on 7476 to 7422 which selects this resultant ‘1’ signal path to be forwarded to the controller block 7400 via 7480 reporting out the apparatus is not functioning as intended. For FDFI control state (3): a ‘1’ FDFI signal is present on 7436 and a ‘0’ FDFI signal is present on 7438; the signal-of-interest enters the FDFI circuit logic from the previous block 7402 and is routed to 7414 via 7440 and 7442; since the FDFI signal is ‘10’, the signal-of-interest is taken from the 7442 input into 7414; the signal-of-interest is then routed to the processing block 7424 via 7452; the processing block retrieves the proper instructions on how to process the signal-of-interest by accessing the instruction set via 7458; since the FDFI signal is ‘10’, the instruction set retrieve request is routed to the instruction set EEPROM 7408 via 7466; the instructions are routed back to the processing block 7424 via 7464 and then 7468; the signal-of-interest is processed according to the retrieved instruction set and then sent to 7420 via 7454; since the FDFI signal is ‘10’ the signal-of-interest routed via 7456 to the next block 7404 exiting the FDFI circuit logic; since the FDFI signal is ‘10’ the 7478 signal path contain a ‘1’ after being inverted by a logical NOT gate 7428 and 7422 selects this resultant ‘1’ signal to be forwarded to the controller block 7400 via 7480 reporting out the apparatus is functioning as intended. For FDFI control state (4): a ‘1’ FDFI signal is present on 7436 and a ‘1’ FDFI signal is present on 7438; the signal-of-interest enters the FDFI circuit logic from the previous block 7402 and is routed to 7414 via 7440 and 7442; since the FDFI signal is ‘11’, the BIT EEPROM 7412 signal is taken from the 7448 input into 7414; the BIT EEPROM 7412 signal is then routed to the processing block 7424 via 7452; the processing block retrieves the proper instructions on how to process the BIT EEPROM 7412 signal by accessing the instruction set via 7458; since the FDFI signal is ‘11’, the instruction set retrieve request is routed to the instruction set EEPROM 7408 via 7466; the instructions are routed back to the processing block 7424 via 7464 and then 7468; the BIT EEPROM 7412 signal is processed according to the retrieved instruction set and then sent to 7420 via 7454; since the FDFI signal is ‘11’ the BIT EEPROM 7412 signal routed via 7470 into a logical XNOR gate 7426 where it is compared with the BIT EEPROM 7412 signal routed from 7450 through 7416 via 7472; if the BIT EEPROM 7412 signal was processed correctly, the logical XNOR gate 7426 will send a ‘1’ on 7476 to 7422 which selects this resultant ‘1’ signal path to be forwarded to the controller block 7400 via 7480 reporting out the apparatus is functioning as intended; if the BIT EEPROM 7412 signal was not processed correctly, the logical XNOR gate 7426 will send a ‘0’ on 7476 to 7422 which selects this resultant ‘1’ signal path to be forwarded to the controller block 7400 via 7480 reporting out the apparatus is not functioning as intended.

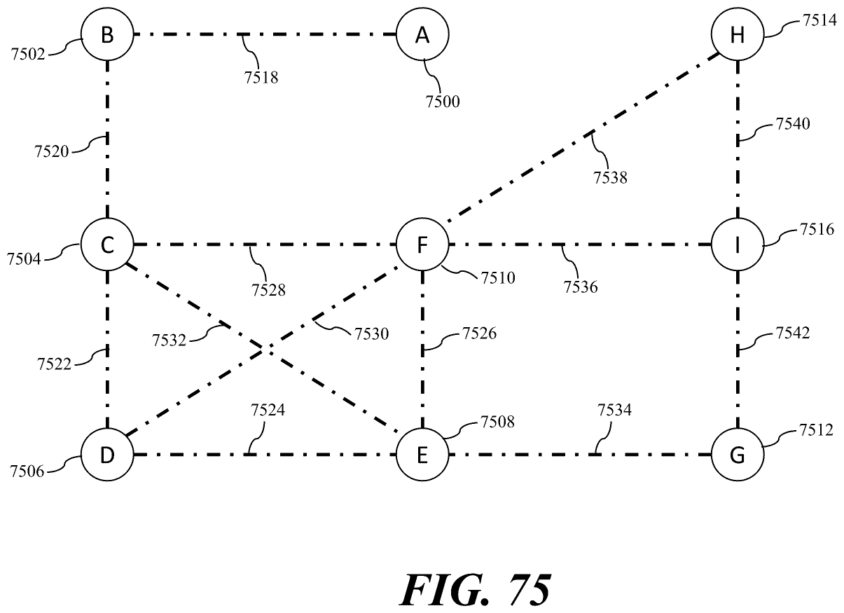

FIG. 75 illustrates possible employments of the apparatus by domain and the connections between each domain if a wireless connection medium is deployed. The domains are as follows: far-space 7500, near-space 7502, exo-atmospheric 7504, endo-atmospheric 7506, terrestrial-ground 7508, terrestrial-sea surface 7510, subterranean 7512, sub-sea surface 7514, and seabed 7516. A wireless connection 7518 is possible between far-space domain 7500 and near-space domain 7502. A wireless connection 7520 is possible between near-space domain 7502 and exo-atmospheric domain 7504. A wireless connection 7522 is possible between exo-atmospheric domain 7504 and endo-atmospheric domain 7506. A wireless connection 7524 is possible between endo-atmospheric domain 7506 and terrestrial-ground domain 7508. A wireless connection 7526 is possible between terrestrial-ground domain 7508 and terrestrial-sea surface domain 7510. A wireless connection 7528 is possible between exo-atmospheric domain 7504 and terrestrial-sea surface domain 7510. A wireless connection 7530 is possible between endo-atmospheric domain 7506 and terrestrial-sea surface domain 7510. A wireless connection 7532 is possible between exo-atmospheric domain 7504 and terrestrial-ground domain 7508. A wireless connection 7534 is possible between terrestrial-ground domain 7508 and subterranean domain 7512. A wireless connection 7536 is possible between terrestrial-sea surface domain 7510 and seabed domain 7516. A wireless connection 7538 is possible between terrestrial-sea surface domain 7510 and sub-sea surface domain 7514. A wireless connection 7540 is possible between sub-sea surface domain 7514 and seabed domain 7516. A wireless connection 7542 is possible between seabed domain 7516 and subterranean domain 7512.

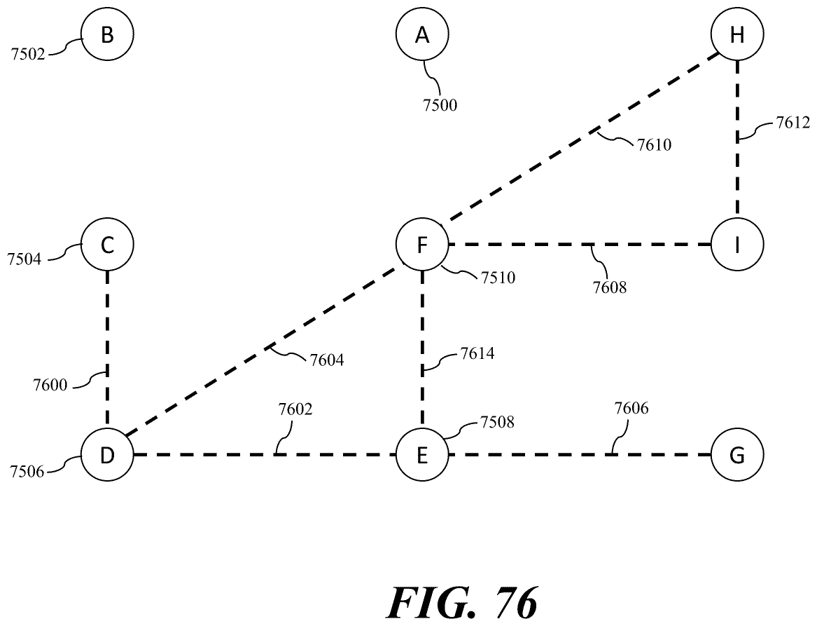

FIG. 76 illustrates possible employments of the apparatus by domain and the connections between each domain if a wired connection medium is deployed. A wired connection 7600 is possible between exo-atmospheric domain 7504 and endo-atmospheric domain 7506. A wired connection 7602 is possible between endo-atmospheric domain 7506 and terrestrial-ground domain 7508. A wired connection 7604 is possible between endo-atmospheric domain 7506 and terrestrial-sea surface domain 7510. A wired connection 7606 is possible between terrestrial-ground domain 7508 and subterranean domain 7512. A wired connection 7608 is possible between terrestrial-sea surface domain 7510 and seabed domain 7516. A wired connection 7610 is possible between terrestrial-sea surface domain 7510 and sub-sea surface domain 7514. A wired connection 7612 is possible between sub-sea surface domain 7514 and seabed domain 7516. A wired connection 7614 is possible between terrestrial-sea surface domain 7510 and terrestrial-ground domain 7508.

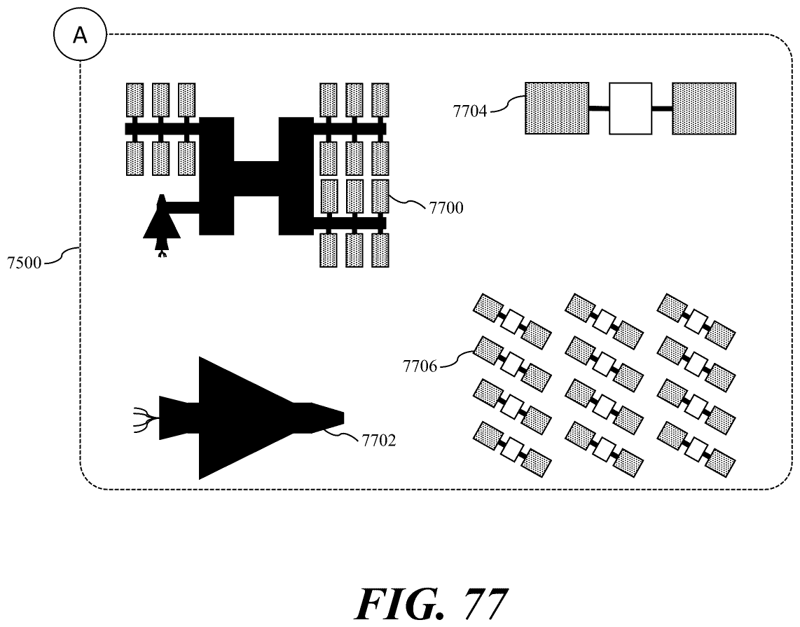

FIG. 77 illustrates possible end-item systems within the far-space domain 7500 the apparatus may be installed upon or integrated into: a space station 7700, a space ship 7702, and satellite 7704, and constellation of satellites 7706.

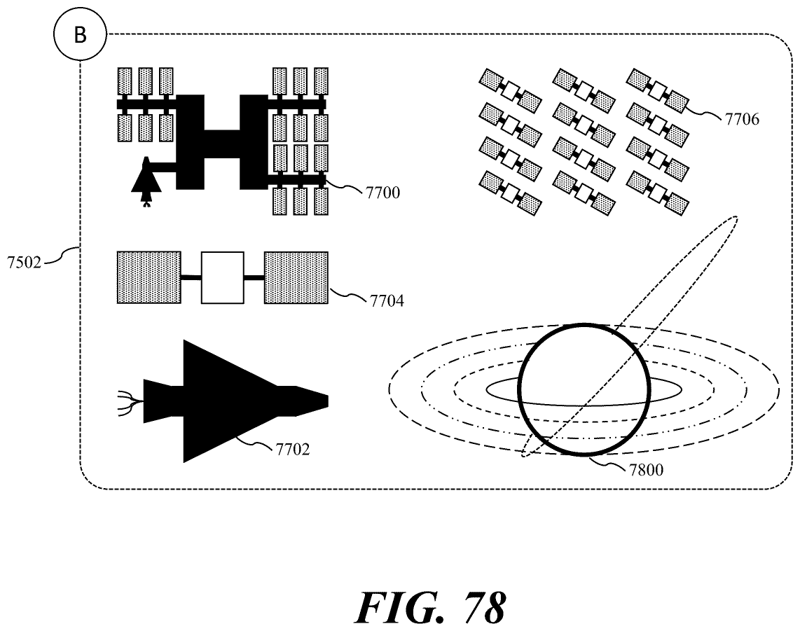

FIG. 78 illustrates possible end-item systems within the near-space domain 7502 the apparatus may be installed upon or integrated into a space station 7700, a space ship 7702, and satellite 7704, and constellation of satellites 7706 while all being in the vicinity of an orbital body 7800.

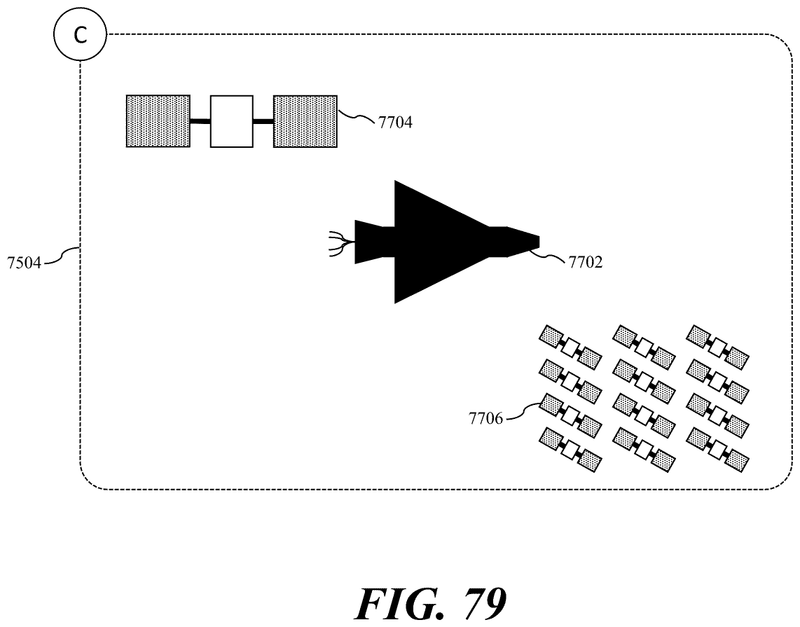

FIG. 79 illustrates possible end-item systems within the exo-atmospheric domain 7504 the apparatus may be installed upon or integrated into: a space ship 7702, and satellite 7704, and constellation of satellites 7706.

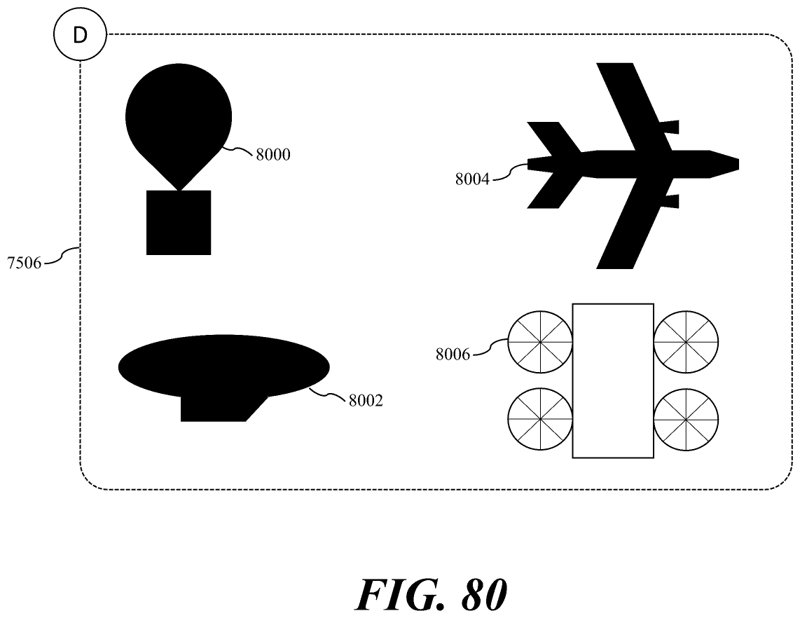

FIG. 80 illustrates possible end-item systems within the endo-atmospheric domain 7506 the apparatus may be installed upon or integrated into: a high altitude balloon 8000, a rigid airship 8002, a plane 8004, and unmanned aerial vehicle 8006.

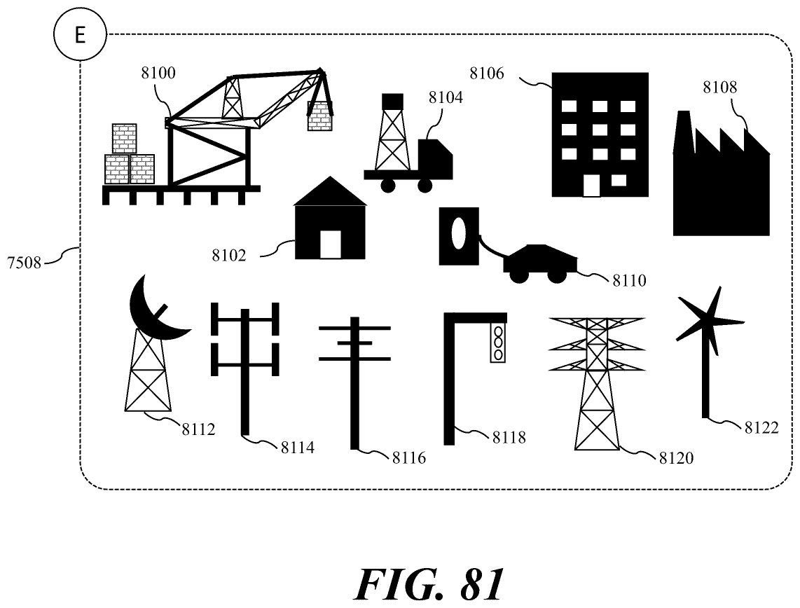

FIG. 81 illustrates possible end-item systems within the terrestrial-ground domain 7508 the apparatus may be installed upon or integrated into: industrial equipment 8100, residential buildings 8102, mobile platforms 8104, commercial buildings 8106, industrial buildings 8108, vehicle infrastructure 8110, ground stations 8112, mobile phone towers 8114, small power lines 8116, stop lights 8118, large power lines 8120, and wind farms 8112.

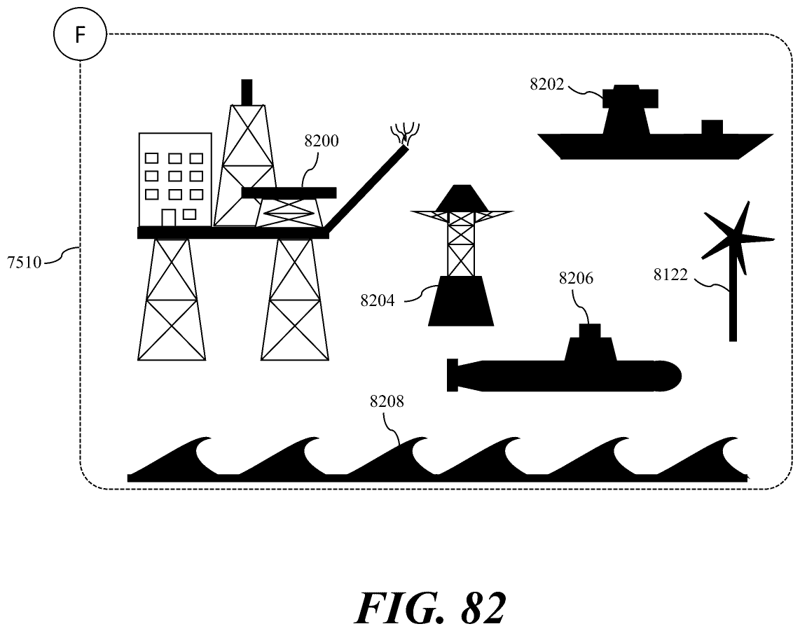

FIG. 82 illustrates possible end-item systems within the terrestrial-sea surface domain 7510 the apparatus may be installed upon or integrated into above the surface of water 8208: oil infrastructure 8200, buoys 8204, ships 8202, submarines above the water 8206, and ocean wind farms 8122.

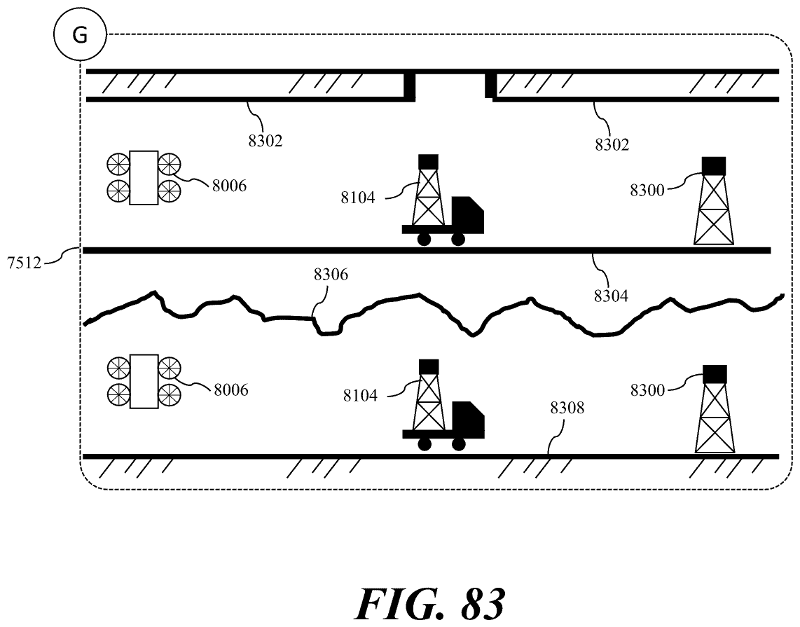

FIG. 83 illustrates possible end-item systems within the subterranean domain 7512 the apparatus may be installed upon or integrated into below man-made tunnels 8302 and 8304 as well as natural caves 8306 and 8308: unmanned aerial vehicles 8006, mobile platforms 8104, and towers 8300.

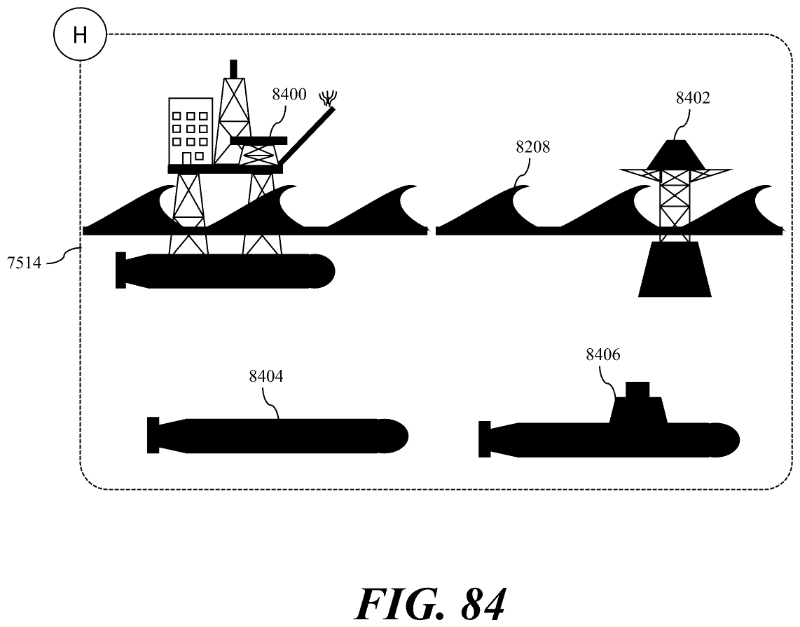

FIG. 84 illustrates possible end-item systems within the sub-sea surface domain 7514 the apparatus may be installed upon or integrated into below the surface of water 8208: submerged oil infrastructure 8400, buoys 8402, unmanned submersibles 8404, and submarines 8406.

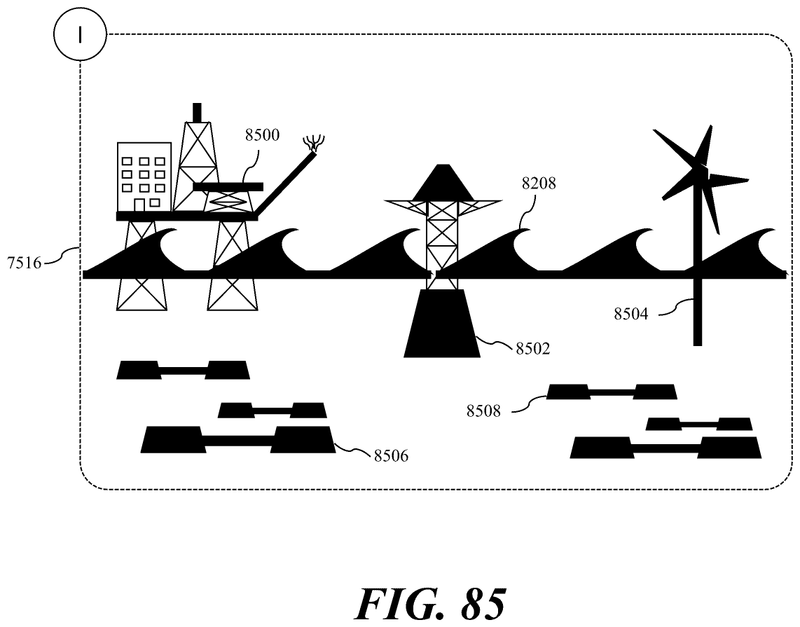

FIG. 85 illustrates possible end-item systems within the seabed domain 7516 the apparatus may be installed upon or integrated into deep below the surface of the water 8208: off-shore free standing or tethered oil infrastructure 8500, buoys 8502, off-shore wind farms 8504, deep ocean seabed infrastructure installations 8506.

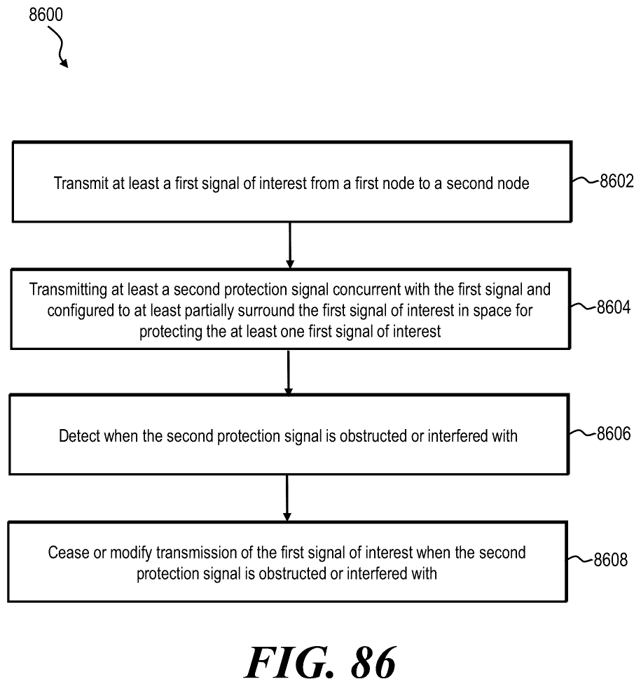

FIG. 86 illustrates an exemplary method 8600 for network security for transmitted signals. Method 8600 includes transmitting at least a first signal of interest from a first node to a second node as shown at block 8602. Additionally, method 8600 includes transmitting at least a second protection signal concurrent with the first signal and configured to at least partially surround the first signal of interest in space for protecting the at least one first signal of interest as shown in block 8604.

In further aspects, method 8600 may also include detecting when the second protection signal is interfered with or obstructed as illustrated by block 8606. Moreover, method 8600 includes ceasing or modifying transmission of the first signal of interest when the second protection signal is interfered with or obstructed as shown in block 8608.

Although the invention has been described in detail with reference to certain preferred embodiments, variations and modifications exist within the spirit and scope of the invention as described and defined in the following claims.

The embodiments of the invention described herein are not intended to be exhaustive or to limit the invention to precise forms disclosed. Rather, the embodiments selected for description have been chosen to enable one skilled in the art to practice the invention.

What is claimed is:

1. An apparatus for network security for transmitted signals, the apparatus comprising:
at least a first transmitter configured to transmit:
at least one first signal containing information or a signal of interest to be transmitted; and
at least one second signal that at least partially surrounds the first signal and is configured to protect the at least one first signal.

2. The apparatus of claim 1, wherein the at least a first transmitter is configured to transmit the at least one first signal and at least one second signal as coherent wireless signals that are transmitted in free space.

3. The apparatus of claim 2, wherein the coherent wireless signals comprise at least one of light signals or radio frequency signals.

4. The apparatus of claim 2, wherein the at least a first transmitter comprises one of a laser or a maser.

5. The apparatus of claim 1, wherein the at least a first transmitter is configured to transmit the at least one first signal and at least one second signal within a physical transmission medium including one of a coaxial cable or a fiber optic cable.

6. The apparatus of claim 1, further comprising:
at least a first receiver configured to receive both the at one first signal and the at least one second signal;
wherein at least one of the at least a first transmitter and the at least a first receiver are configured to detect interruption of the at least one second signal and to discontinue transmission of the at least one first signal by the at least a first transmitter when interruption or impingement of the at least one second signal is detected.

7. The apparatus of claim 1, wherein the at least one first signal comprises one of a bidirectional or unidirectional signal.

8. The apparatus of claim 1, wherein the at least one second signal comprises two opposing unidirectional protection signals transmitted between first and second transmit/receive nodes, such that when either of the two opposing unidirectional protection signals are interrupted, transmit or receive operations in at least one of the first or second transmit/receive nodes are modified or ceased.

9. An apparatus for network security and power transfer for transmitted signals, the apparatus comprising:
at least a first transmit/receive node configured to transmit:
at least one portion of a first signal containing first information or power in coordination with one or more other first signal transmitters also transmitting respective portions of the first signal containing the first information or power information;
at least one portion of a second signal configured to surround the at least one portion of the first signal and protect the at least one portion of the first signal; and
at least a second transmit/receive node configured to receive the at least one portion of a first signal and the at least one portion of the second signal.

10. The apparatus of claim 9, further comprising:
at least one of the at least a first transmit/receive node and the at least a second transmit/receive node configured to:
detect when the at least one portion of the second signal is obstructed;
cease transmission of the at least one portion of the first signal by the first transmit/receive node when at least one of the first transmit/receive node or the at least a second transmit/receive node detects that the at least one portion of the second signal is obstructed.

11. The apparatus of claim 10, further comprising:
the second transmit/receive node configured to signal to the first transmit/receive node that the second transmit/receive node detected that the at least one portion of the second signal is obstructed.

12. The apparatus of claim 9, further comprising:
the at least one portion of a second signal including at least two opposing unidirectional protection signals transmitted between first and second transmit/receive nodes, such that when either of the at least two opposing unidirectional protection signals are obstructed, transmit or receive operations in at least one of the first or second transmit/receive nodes are ceased or modified.

13. The apparatus of claim 9, wherein at least one of the at least one portion of the first signal or the at least one portion of the second signal is configured to transmit according to specific signal emission characteristics including one or more of frequency, phase, spot size, shop shape, polarization, communication protocol, encoding, pulse train type, and encryption type.

14. The apparatus of claim 9, wherein at least one of the first and second transmit/receive nodes includes at least one fault detection/fault isolation subsystem logic circuit configured to tune and initialize a transmit chain for facilitating signal transmission as well as to detect and isolate transmit chain subsystem errors.

15. The apparatus of claim 9, wherein at least one of the first and second transmit/receive nodes includes at least one subsystem configured for modulating transmit chain subsystems to ensure one or more of signal frequency, phase, spot size, shop shape, polarization, communication protocol, encoding, pulse train type, encryption type, or external housing vibrating lens/array face for signal transmission.

16. The apparatus of claim 9, wherein the first transmit/receive node is configured to transmit the at least one portion of the first signal and the at least one portion of the second signal as coherent light or radio frequency wireless signals that are transmitted in free space.

17. The apparatus of claim 16, where the first transmit/receive node includes one of a laser or a maser.

18. The apparatus of claim 9, wherein the first transmit/receive node is configured to transmit the at least one portion of the first signal and the at least one portion of the second signal within a physical transmission medium including one of a coaxial cable or a fiber optic cable.

19. A method for network security for transmitted signals, the method comprising:
transmitting at least a first signal of interest from a first node to a second node; and
transmitting at least a second protection signal concurrent with the first signal and configured to at least partially surround the first signal of interest in space for protecting the at least one first signal of interest.

20. The method of claim 19, further comprising:
detecting when the second protection signal is interfered with; and
ceasing or modifying transmission of the first signal of interest when the second protection signal is interfered with.
